(19) United States
(12) Patent Application Publication
(10) Pub. No.: US 2024/0132808 A1
(43) Pub. Date: Apr. 25, 2024

(54) Storage-Stable Hydrolase Containing Liquids

(71) Applicant: BASF SE, Ludwigshafen am Rhein (DE)

(72) Inventors: Stephan HUEFFER, Budd Lake, NJ (US); Grit J BAIER, Budd Lake, NJ (US); Katrin-Stephanie TUECKING; Stefan FISCHER, Budd Lake, NJ (US)

(21) Appl. No.: 17/754,845

(22) PCT Filed: Oct. 16, 2020
(86) PCT No.: PCT/EP2020/079282

§ 371 Date: Apr. 13, 2022

(30) Foreign Application Priority Data
Oct. 18, 2019 (EP) 19204167.1
Dec. 19, 2019 (EP) 19218174.1

(51) Int. Cl. C11D 3/386; C11D 3/20; C11D 3/32

(52) U.S. Cl. CPC C11D 3/38663; C11D 3/2044; C11D 3/2093; C11D 3/32; C11D 3/38636

(57) ABSTRACT

Disclosed herein is a homogenous, storage-stable liquid enzyme preparation, including
component (a): at least one enzyme selected from the group of hydrolases (EC 3);
component (b): an enzyme-stabilizing system including
   (bi) at least one compound according to general formula (A)

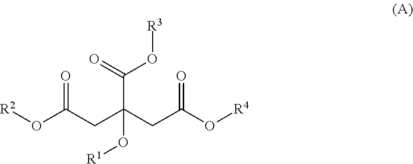

where the variables in formula (A) are as follows:
R¹ is selected from H and C₁-C₁₀ alkylcarbonyl,
R², R³, R⁴ are independently from each other selected from H, linear C₁-C₅ alkyl, branched C₃-C₁₀ alkyl, C₆-C₁₀-aryl, non-substituted or substituted with one or more carboxylate or hydroxyl groups, and C₆-C₁₀-aryl-alkyl, where alkyl of the latter is selected from linear C₁-C₈ alkyl or branched C₃-C₈ alkyl, where at least one of R², R³, and R⁴ is not H;
and
(bii) at least one compound selected from boron containing compound and peptide stabilizer,
and
component (c): at least one diol.

Enzymes are usually produced commercially as a liquid concentrate, frequently derived from a fermentation broth. The enzyme tends to lose enzymatic activity if it is stored in an aqueous environment. Hence it is conventional practice to convert it to an anhydrous form: aqueous concentrates may be lyophilized or spray-dried e.g. in the presence of a carrier material to form aggregates. However, usually solid enzyme products need to be “dissolved” prior to use.

Enzyme inhibitors are usually employed to stabilize enzymes in liquid products. To inhibit enzyme activity temporarily, reversible enzyme inhibitors may be used, which are released in final application of an enzyme but are kept bound to the enzyme under storage conditions.

As there is a continuous request for liquid enzyme containing products, a need arises for providing compositions or formulations allowing storage of such liquids without losing to much of the activity of a certain enzyme. Specifically, there is a need to provide liquid enzyme preparations comprising at least one hydrolase, preferably a hydrolase effective in washing and/or cleaning processes, and components to improve stability of one or more enzymes comprised and the liquid product itself. The liquid product itself may need to be prevented from microbial contamination or in changes of its physical appearance.

Enzyme preparations usually comprise relatively high amounts of hydrolase which need to be stabilized by relatively high amounts of enzyme stabilizers. Different solubilization characteristics of the components may result in non-homogeneous liquids. Non-homogeneous liquids often do not provide the optimal product performance and are therefore preferably to be avoided.

The objective of the current invention was to provide a homogenous, storage-stable enzyme preparation comprising at least one hydrolase and an enzyme stabilizer system, which may be flexibly formulated into a final product such as a detergent formulation.

The current invention provides a homogenous, storage-stable liquid enzyme preparation, comprising
component (a): at least one enzyme selected from the group of hydrolases (EC 3); and
component (b): an enzyme-stabilizing system comprising
   (bi) at least one compound according to general formula (A)

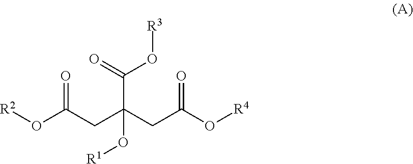

wherein the variables in formula (A) are as follows:
R¹ is selected from H and C₁-C₁₀ alkylcarbonyl, wherein alkyl may be linear or branched and may bear one or more hydroxyl groups,
R², R³, R⁴ are independently from each other selected from H, linear C₁-C₅ alkyl, and branched C₃-C₁₀ alkyl, C₆-C₁₀-aryl, non-substituted or substituted with one or more carboxylate or hydroxyl groups, and C₆-C₁₀-aryl-alkyl, wherein alkyl of the latter is selected from linear C₁-C₈ alkyl or branched C₃-C₈ alkyl, wherein at least one of R², R³, and R⁴ is not H;
and
(bii) at least one compound selected from boron containing compound and peptide stabilizer,
and
component (c): at least one diol,
and optionally
component (d): at least one compound selected from (i) solvents, and (ii) compounds stabilizing the liquid enzyme preparation as such.

Enzyme names are known to those skilled in the art based on the recommendations of the Nomenclature Committee of the International Union of Biochemistry and Molecular Biology (IUBMB). Enzyme names include: an EC (Enzyme Commission) number, recommended name, alternative names (if any), catalytic activity, and other factors.; see http://www.sbcs.qmul.ac.uk/iubmb/enzyme/EC3/ in the version last updated on 4 Oct. 2019.

The enzyme preparations of the invention are liquid at 20° C. and 101.3 kPa. Liquids include solutions, emulsions and dispersions, gels etc. as long as the liquid is fluid and pourable. In one embodiment of the present invention, liquid detergent formulations according to the present invention have a dynamic viscosity in the range of about 500 to about 20,000 mPa*s, determined at 25° C. according to Brookfield, for example spindle 3 at 20 rpm with a Brookfield viscosimeter LVT-II.

The enzyme preparations of the invention are homogenous at a temperature of about 8° C., about 20° C. or about 37° C., and normal pressure of about 101.3 kPa. Homogenous means that the enzyme preparation does not show visible precipitate formation or turbidity. Visible precipitate herein preferably means any kind of visible particles.

The enzyme preparations of the invention are storage-stable at a temperature of about 8° C., about 20° C. or about 37° C. for up to 6 weeks. Storage-stable in this context means that the liquid enzyme preparation does not show visible precipitate formation or turbidity after storage of the liquid enzyme preparation, preferably after up to 6 or 8 weeks of storage at 8° C. or 37° C. Preferably, the liquid enzyme preparation is storage-stable at storage between 8° C. and 37° C. for up to 6 months. The enzyme preparations of the invention are preferably formulated into detergent formulations to provide storage-stable enzyme containing detergent formulations. Storage-stable in this context means that at least one enzyme comprised in the enzyme containing detergent formulation shows reduced loss of enzyme activity after storage at 37° C. for up to 42 days when compared to a control detergent formulation. The control detergent formulation comprises at least one enzyme, at least one peptide stabilizer but lacks (i) a compound according to formula (A) as disclosed being part of the enzyme stabilizing system disclosed as component (b) herein and (ii) component (c).

“Formulated into” preferably means that the enzyme preparations are combined with one or more detergent components in one or more steps in any order.

Component (a)

At least one enzyme comprised in component (a) is selected from hydrolases (EC 3), hereinafter also referred to as enzyme (component (a)). Preferred enzymes are selected from the group of enzymes acting on ester bond (E.C. 3.1), glycosylases (E.C. 3.2), and peptidases (E.C. 3.4). Enzymes acting on ester bond (E.C. 3.1), are hereinafter also referred to as lipases, and DNAses. Glycosylases (E.C. 3.2) are hereinafter also referred to as either amylases, cellulases, or mannanases. Peptidases (E.C. 3.4) are hereinafter also referred to as proteases.

Hydrolases comprised in component (a) are identified by polypeptide sequences (also called amino acid sequences herein). The polypeptide sequence specifies the three-dimensional structure Including the “active site” of an enzyme which In turn determines the catalytic activity of the same. Polypeptide sequences may be identified by a SEQ ID NO. According to the World Intellectual Property Office (WIPO) Standard ST.25 (1998) the amino acids herein are represented using three-letter code with the first letter as a capital or the corresponding one letter.

Any enzyme comprised in component (a) according to the invention relates to parent enzymes and/or variant enzymes, both having enzymatic activity. Enzymes having enzymatic activity are enzymatically active or exert enzymatic conversion, meaning that enzymes act on substrates and convert these into products. The term “enzyme” herein excludes inactive variants of an enzyme.

A “parent” sequence (of a parent protein or enzyme, also called “parent enzyme”) Is the starting sequence for introduction of changes (e.g. by introducing one or more amino acid substitutions, insertions, deletions, or a combination thereof) to the sequence, resulting In “variants” of the parent sequences. The term parent enzyme (or parent sequence) includes wild-type enzymes (sequences) and synthetically generated sequences (enzymes) which are used as starting sequences for introduction of (further) changes.

The term “enzyme variant” or “sequence variant” or “variant enzyme” refers to an enzyme that differs from its parent enzyme in its amino acid sequence to a certain extent. If not indicated otherwise, variant enzyme “having enzymatic activity” means that this variant enzyme has the same type of enzymatic activity as the respective parent enzyme.

In describing the variants of the present invention, the nomenclature described as follows is used:

Amino acid substitutions are described by providing the original amino acid of the parent enzyme followed by the number of the position within the amino acid sequence, followed by the substituted amino acid.

Amino acid deletions are described by providing the original amino acid of the parent enzyme followed by the number of the position within the amino acid sequence, followed by *.

Amino acid insertions are described by providing the original amino acid of the parent enzyme followed by the number of the position within the amino acid sequence, followed by the original amino acid and the additional amino acid. For example, an insertion at position 180 of lysine next to glycine is designated as “Gly180GlyLys” or “G180GK”. In cases where a substitution and an insertion occur at the same position, this may be indicated as S99SD+S99A or in short S99AD. In cases where an amino acid residue identical to the existing amino acid residue is inserted, it is clear that degeneracy in the nomenclature arises. If for example a glycine is inserted after the glycine in the above example this would be indicated by G180GG. Where different alterations can be introduced at a position, the different alterations are separated by a comma, e.g. “Arg170Tyr, Glu” represents a substitution of arginine at position 170 with tyrosine or glutamic acid. Alternatively different alterations or optional substitutions may be indicated in brackets e.g. Arg170[Tyr, Gly] or Arg170{Tyr, Gly}; or in short R170 [Y,G] or R170 {Y, G}; or in long R170Y, R170G.

Enzyme variants may be defined by their sequence identity when compared to a parent enzyme. Sequence identity usually is provided as “% sequence identity” or “% Identity”. For calculation of sequence identities, in a first step a sequence alignment has to be produced. According to this invention, a pairwise global alignment has to be produced, meaning that two sequences have to be aligned over their complete length, which is usually produced by using a mathematical approach, called alignment algorithm.

According to the invention, the alignment is generated by using the algorithm of Needleman and Wunsch (J. Mol. Biol. (1979) 48, p. 443-453). Preferably, the program “NEEDLE” (The European Molecular Biology Open Software Suite (EMBOSS)) is used for the purposes of the current invention, with using the programs default parameter (gap open=10.0, gap extend=0.5 and matix=EBLOSUM62).

According to this invention, the following calculation of %-identity applies: %-identity=(identical residues/length of the alignment region which is showing the respective sequence of this invention over its complete length)*100.

In one embodiment of this invention, enzyme variants are described as an amino acid sequence which is at least n % identical to the amino acid sequence of the respective parent enzyme with “n” being an integer between 10 and 100. In one embodiment, variant enzymes are at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, or at least 99% identical when compared to the full-length amino acid sequence of the parent enzyme, wherein the enzyme variant has enzymatic activity.

Enzyme variants may be defined by their sequence similarity when compared to a parent enzyme. Sequence similarity usually is provided as “% sequence similarity” or “%-similarity”. % sequence similarity takes into account that defined sets of amino acids share similar properties, e.g by their size, by their hydrophobicity, by their charge, or by other characteristics. Herein, the exchange of one amino acid with a similar amino acid may be called “conservative mutation”.

For determination of %-similarity according to this invention the following applies: amino acid A is similar to amino acids S; amino acid D is similar to amino acids E and N; amino acid E is similar to amino acids D and K and Q; amino acid F is similar to amino acids W and Y; amino acid H is similar to amino acids N and Y; amino acid I is similar to amino acids L and M and V; amino acid K is similar to amino acids E and Q and R; amino acid L is similar to amino acids I and M and V; amino acid M is similar to amino acids I and L and V; amino acid N is similar to amino acids D and H and S; amino acid Q is similar to amino acids E and K and R; amino acid R is similar to amino acids K and Q; amino acid S is similar to amino acids A and N and T; amino acid T is similar to amino acids S; amino acid V is similar to amino acids I and L and M; amino acid W is similar to amino acids F and Y; amino acid Y is similar to amino acids F and H and W.

Conservative amino acid substitutions may occur over the full-length of the sequence of a polypeptide sequence of a functional protein such as an enzyme. In one embodiment, such mutations are not pertaining the functional domains of an enzyme. In one embodiment, conservative mutations are not pertaining the catalytic centers of an enzyme.

To take conservative mutations into account, a value for sequence similarity of two amino acid sequences may be calculated from the same alignment, which is used to calculate %-identity.

According to this invention, the following calculation of %-similarity applies: %-similarity=[(identical residues+similar residues)/length of the alignment region which is showing the respective sequence(s) of this invention over its complete length]*100.

According to this invention, enzyme variants may be described as an amino acid sequence which is at least m % similar to the respective parent sequences with “m” being an integer between 10 and 100. In one embodiment, variant enzymes are at least 70%, at least 75%, at least 80%, at least 85%, at least 90%, at least 91%, at least 92%, at least 93%, at least 94%, at least 95%, at least 96%, at least 97%, at least 98%, or at least 99% similar when compared to the full-length polypeptide sequence of the parent enzyme, wherein the variant enzyme has enzymatic activity.

“Enzymatic activity” means the catalytic effect exerted by an enzyme, which usually is expressed as units per milligram of enzyme (specific activity) which relates to molecules of substrate transformed per minute per molecule of enzyme (molecular activity).

Variant enzymes have enzymatic activity according to the present invention when said enzyme variants exhibit at least 20%, at least 25%, at least 30%, at least 35%, at least 40%, at least 45%, at 10 least 50%, at least 55%, at least 60%, at least 65%, at least 70%, at least 75%, at least 80%, at least 85%, at least 90%, at least 95%, or 100% of the enzymatic activity of the respective parent enzyme.

In one aspect of the invention, at least one enzyme comprised in component (a) is part of a liquid enzyme concentrate. “Liquid enzyme concentrate” herein means any liquid enzyme-comprising product comprising at least one enzyme. “Liquid” In the context of enzyme concentrate is related to the physical appearance at 20° C. and 101.3 kPa.

The liquid enzyme concentrate may result from dissolution of solid enzyme in solvent. The solvent may be selected from water and an organic solvent. A liquid enzyme concentrate resulting from dissolution of solid enzyme in solvent may comprise amounts of enzyme up to the saturation concentration. Dissolution herein means, that solid compounds are liquified by contact with at least one solvent. Dissolution means complete dissolution of a solid compound until the saturation concentration is achieved in a specified solvent, wherein no phase-separation occurs.

In one aspect of the invention, component (a) of the resulting enzyme concentrate is free of water, meaning that no significant amounts of water are present. Non-significant amounts of water herein means, that the enzyme concentrate comprises less than 25%, less than 20%, less than 15%, less than 10%, less than 7%, less than 5%, less than 4%, less than 3%, less than 2% by weight water, all relative to the total weight of the enzyme concentrate, or no water. In one embodiment, enzyme concentrate free of water means that the enzyme concentrate does not comprise significant amounts of water but does comprise organic solvents in amounts of 30-80% by weight, relative to the total weight of the enzyme concentrate.

In one embodiment, liquid enzyme concentrates comprise water in amounts of at least 25% by weight relative to the total weight of the enzyme concentrate may be called “aqueous enzyme concentrates”. Aqueous enzyme concentrates may be enzyme-comprising solutions, wherein solid enzyme product has been dissolved in water. In one embodiment “aqueous enzyme concentrate” means enzyme-comprising products resulting from enzyme production by fermentation.

Fermentation means the process of cultivating recombinant cells which express the desired enzyme in a suitable nutrient medium allowing the recombinant host cells to grow and express the desired protein. At the end of the fermentation, fermentation broth usually is collected and further processed, wherein the fermentation broth comprises a liquid fraction and a solid fraction. Depending on whether the enzyme has been secreted into the liquid fraction or not, the desired protein or enzyme may be recovered from the liquid fraction of the fermentation broth or from cell lysates. Recovery of the desired enzyme uses methods known to those skilled in the art. Suitable methods for recovery of proteins or enzymes from fermentation broth include but are not limited to collection, centrifugation, filtration, extraction, and precipitation.

Liquid enzyme concentrates, usually comprise amounts of enzyme in the range of 0.1% to 40% by weight, or 0.5% to 30% by weight, or 1% to 25% by weight, or 3% to 25% by weight, or 5% to 25% by weight, all relative to the total weight of the enzyme concentrate. In a preferred embodiment, liquid enzyme concentrates are resulting from fermentation and are aqueous.

Aqueous enzyme concentrates resulting from fermentation usually comprise water in amounts of more than about 50% by weight, more than about 60% by weight, more than about 70% by weight, or more than about 80% by weight, all relative to the total weight of the enzyme concentrate. Aqueous enzyme concentrates which result from fermentation, may comprise residual components such as salts originating from the fermentation medium, cell debris originating from the production host cells, metabolites produced by the production host cells during fermentation. In one embodiment, residual components may be comprised in liquid enzyme concentrates in amounts less than 30% by weight, less than 20% by weight less, than 10% by weight, or less than 5% by weight, all relative to the total weight of the aqueous enzyme concentrate.

In one embodiment, the enzyme preparations of the invention comprise at least one enzyme in amounts of about 0.1-10% by weight relative to the total weight of the enzyme preparation. More preferably, the enzyme preparations comprise at least one enzyme in amounts of about 2-8%, or about 5% by weight relative to the total weight of the enzyme preparation, wherein at least one enzyme is selected from hydrolases, preferably from proteases, amylases, lipases, cellulases, and mannanases.

Protease

In one embodiment, the enzyme preparations comprise at least one protease in amounts ranging from about 4% to 6.5% by weight, or of about 5% by weight relative to the total weight of the enzyme preparation, wherein at least one protease is preferably selected from the group of serine endopeptidases (EC 3.4.21), most preferably selected from the group of subtilisin type proteases (EC 3.4.21.62).

Serine proteases or serine peptidases are characterized by having a serine in the catalytically active site, which forms a covalent adduct with the substrate during the catalytic reaction. A serine protease in the context of the present invention may be selected from the group consisting of chymotrypsin (e.g., EC 3.4.21.1), elastase (e.g., EC 3.4.21.36), elastase (e.g., EC 3.4.21.37 or EC 3.4.21.71), granzyme (e.g., EC 3.4.21.78 or EC 3.4.21.79), kallikrein (e.g., EC 3.4.21.34, EC 3.4.21.35, EC 3.4.21.118, or EC 3.4.21.119) plasmin (e.g., EC 3.4.21.7), trypsin (e.g., EC 3.4.21.4), thrombin (e.g., EC 3.4.21.5), and subtilisin. Subtilisin is also known as subtilopeptidase, e.g., EC 3.4.21.62, the latter hereinafter also being referred to as “subtilisin”.

A sub-group of the serine proteases tentatively designated as subtilases has been proposed by Siezen et al. (1991), Protein Eng. 4:719-737 and Siezen et al. (1997), Protein Science 6:501-523. Subtilases includes the subtilisin family, thermitase family, the proteinase K family, the lantibiotic peptidase family, the kexin family and the pyrolysin family.

A subgroup of the subtilases are the subtilisins which are serine proteases from the family S8 as defined by the MEROPS database (http://merops.sanger.ac.uk). Peptidase family S8 comprises the serine endopeptidase subtilisin and its homologues.

The subtilisin related class of serine proteases shares a common amino acid sequence defining a catalytic triad which distinguishes them from the chymotrypsin related class of serine proteases. Subtilisins and chymotrypsin related serine proteases both have a catalytic triad comprising aspartate, histidine and serine.

Examples include the subtilisins as described in WO 89/06276 and EP 0283075, WO 89/06279, WO 89/09830, WO 89/09819, WO 91/06637 and WO 91/02792.

Proteases are active proteins exerting “protease activity” or “proteolytic activity”. Proteolytic activity is related to the rate of degradation of protein by a protease or proteolytic enzyme in a defined course of time.

The methods for analyzing proteolytic activity are well-known in the literature (see e.g. Gupta et al. (2002), Appl. Microbiol. Biotechnol. 60: 381-395). Proteolytic activity may be determined by using Succinyl-Ala-Ala-Pro-Phe-p-nitroanilide (Suc-AAPF-pNA, short AAPF; see e.g. DelMar et al. (1979), Analytical Biochem 99, 316-320) as substrate. pNA is cleaved from the substrate molecule by proteolytic cleavage, resulting in release of yellow color of free pNA which can be quantified by measuring OD₄₀₅.

Proteolytic activity may be provided in units per gram enzyme. For example, 1 U protease may correspond to the amount of protease which sets free 1 μmol folin-positive amino acids and peptides (as tyrosine) per minute at pH 8.0 and 37° C. (casein as substrate).

Proteases of the subtilisin type (EC 3.4.21.62) may be bacterial proteases originating from a microorganism selected from Bacillus, Clostridium, Enterococcus, Geobacillus, Lactobacillus, Lactococcus, Oceanobacillus, Staphylococcus, Streptococcus, or Streptomyces protease, or a Gram-negative bacterial polypeptide such as a Campylobacter, E. coli, Flavobacterium, Fusobacterium, Helicobacter, Ilyobacter, Neisseria, Pseudomonas, Salmonella, and Ureaplasma.

In one aspect of the invention, at least one protease is selected from Bacillus alcalophilus, Bacillus amyloliquefaciens, Bacillus brevis, Bacillus circulans, Bacillus clausii, Bacillus coagulans, Bacillus firmus, Bacillus gibsonii, Bacillus lautus, Bacillus lentus, Bacillus licheniformis, Bacillus megaterium, Bacillus pumilus, Bacillus sphaericus, Bacillus stearothermophilus, Bacillus subtilis, or Bacillus thuringiensis protease.

In one embodiment of the present invention, component (a) comprises at least one protease selected from the following: subtilisin from Bacillus amyloliquefaciens BPN′ (described by Vasantha et al. (1984) J. Bacteriol. Volume 159, p. 811-819 and JA Wells et al. (1983) in Nucleic Acids Research, Volume 11, p. 7911-7925); subtilisin from Bacillus licheniformis (subtilisin Carlsberg; disclosed in EL Smith et al. (1968) in J. Biol Chem, Volume 243, pp. 2184-2191, and Jacobs et al. (1985) in Nucl. Acids Res, Vol 13, p. 8913-8926); subtilisin PB92 (original sequence of the alkaline protease PB92 is described in EP 283075 A2); subtilisin 147 and/or 309 (Esperase®, Savinase®, respectively) as disclosed in WO 89/06279; subtilisin from Bacillus lentus as disclosed in WO 91/02792, such as from Bacillus lentus DSM 5483 or the variants of Bacillus lentus DSM 5483 as described in WO 95/23221; subtilisin from Bacillus alcalophilus (DSM 11233) disclosed in DE 10064983; subtilisin from Bacillus gibsonii (DSM 14391) as disclosed in WO 2003/054184; subtilisin from Bacillus sp. (DSM 14390) disclosed in WO 2003/056017; subtilisin from Bacillus sp. (DSM 14392) disclosed in WO 2003/055974; subtilisin from Bacillus gibsonii (DSM 14393) disclosed in WO 2003/054184; subtilisin having SEQ ID NO: 4 as described in WO 2005/063974; subtilisin having SEQ ID NO: 4 as described in WO 2005/103244; subtilisin having SEQ ID NO: 7 as described in WO 2005/103244; and subtilisin having SEQ ID NO: 2 as described in application DE 102005028295.4.

In one embodiment, component (a) comprises at least subtilisin 309 (which might be called Savinase herein) as disclosed as sequence a) in Table I of WO 89/06279 or a variant thereof which is at least 80% similar and/or identical thereto and has proteolytic activity.

Examples of useful proteases in accordance with the present invention comprise the variants described in: WO 92/19729, WO 95/23221, WO 96/34946, WO 98/20115, WO 98/20116, WO 99/11768, WO 01/44452, WO 02/088340, WO 03/006602, WO 2004/03186, WO 2004/041979, WO 2007/006305, WO 2011/036263, WO 2011/036264, and WO 2011/072099. Suitable examples comprise especially variants of subtilisin protease derived from SEQ ID NO:22 as described in EP 1921147 (which is the sequence of mature alkaline protease from Bacillus lentus DSM 5483) with amino acid substitutions in one or more of the following positions: 3, 4, 9, 15, 24, 27, 33, 36, 57, 68, 76, 77, 87, 95, 96, 97, 98, 99, 100, 101, 102, 103, 104, 106, 118, 120, 123, 128, 129, 130, 131, 154, 160, 167, 170, 194, 195, 199, 205, 206, 217, 218, 222, 224, 232, 235, 236, 245, 248, 252 and 274 (according to the BPN′ numbering), which have proteolytic activity. In one embodiment, such a protease is not mutated at positions Asp32, His64 and Ser221 (according to BPN′ numbering).

In one embodiment, component (a) comprises at least one protease variant having proteolytic activity which are at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98% or at least 99% similar and/or identical when compared to the full-length polypeptide sequence of the parent enzyme as disclosed above.

In one embodiment, at least one protease comprised in component (a) has SEQ ID NO:22 as described in EP 1921147, or a protease which is at least 80% similar and/or identical thereto and has proteolytic activity. A protease having SEQ ID NO:22 as described in EP1921147 means a protease having an amino acid sequence according to SEQ ID NO:22 as disclosed in EP 1921147. In one embodiment, said protease is characterized by having amino acid glutamic acid (E), or aspartic acid (D), or asparagine (N), or glutamine (Q), or alanine (A), or glycine (G), or serine (S) at position 101 (according to BPN′ numbering) and has proteolytic activity. In one embodiment, said protease comprises one or more further substitutions: (a) threonine at position 3 (3T), (b) isoleucine at position 4 (4I), (c) alanine, threonine or arginine at position 63 (63A, 63T, or 63R), (d) aspartic acid or glutamic acid at position 156 (156D or 156E), (e) proline at position 194 (194P), (f) methionine at position 199 (199M), (g) isoleucine at position 205 (205I), (h) aspartic acid, glutamic acid or glycine at position 217 (217D, 217E or 217G), (i) combinations of two or more amino acids according to (a) to (h). At least one protease may be at least 80% similar and/or identical to SEQ ID NO:22 as described in EP 1921147 and is characterized by comprising one amino acid (according to (a)-(h)) or combinations according to (i) together with the amino acid 101E, 101D, 101N, 101Q, 101A, 101G, or 101S (according to BPN′ numbering) and having proteolytic activity. In one embodiment, said protease is characterized by comprising the mutation (according to BPN′ numbering) R101E, or S3T+V4I+V205I, or R101E and S3T, V4I, and V205I, or S3T+V4I+V199M+V205I+L217D, and having proteolytic activity.

In one embodiment, the protease having an amino acid sequence according to SEQ ID NO:22 as described in EP 1921147 is characterized by comprising the mutation (according to BPN′ numbering) S3T+V4I+S9R+A15T+V68A+D99S+R101S+A103S+I104V+N218D, and having proteolytic activity.

In one embodiment of the present invention, component (a) comprises a combination of at least two proteases, preferably selected from the group of serine endopeptidases (EC 3.4.21), more preferably selected from the group of subtilisin type proteases (EC 3.4.21.62)—all as disclosed above.

In one embodiment, component (a) comprises at least one protease selected from proteases according to SEQ ID NO:22 as described in EP 1921147 or variants thereof having proteolytic activity, as disclosed above. At least one protease variant thereof preferably is a protease 80% similar and/or identical to SEQ ID NO:22 as described in EP 1921147 having R101E.

In one embodiment, component (a) comprises at least one protease selected from subtilisin 309 as disclosed in Table I a) of WO 89/06279 or variants thereof having proteolytic activity, as disclosed above.

In one embodiment, component (a) comprises at least one protease as disclosed above, preferably selected from
proteases according to SEQ ID NO:22 as described in EP 1921147 or variants thereof having proteolytic activity, preferably a protease 80% similar and/or identical to SEQ ID NO:22 as described in EP 1921147 having R101E and
subtilisin 309 as disclosed in Table I a) of WO 89/06279 or variants thereof having proteolytic activity
and at least one further enzyme preferably selected from amylase, lipase, cellulase, mannanase, and DNAse—all es disclosed herein.

Amylase

At least one enzyme comprised in component (a) in one embodiment is selected from the group of amylases. “Amylases” according to the invention (alpha and/or beta) include those of bacterial or fungal origin (EC 3.2.1.1 and 3.2.1.2, respectively). Preferably, component (a) comprises at least one alpha-amylase (EC 3.2.1.1). Chemically modified or protein engineered mutants are included.

Amylases comprised in component (a) according to the invention have “amylolytic activity” or “amylase activity” Involving (endo)hydrolysis of glucosidic linkages in polysaccharides. alpha-amylase activity may be determined by assays for measurement of alpha-amylase activity which are known to those skilled in the art. Examples for assays measuring alpha-amylase activity are:
alpha-amylase activity can be determined by a method employing Phadebas tablets as substrate (Phadebas Amylase Test, supplied by Magle Life Science). Starch is hydrolyzed by the alpha-amylase giving soluble blue fragments. The absorbance of the resulting blue solution, measured spectrophotometrically at 620 nm, is a function of the alpha-amylase activity. The measured absorbance is directly proportional to the specific activity (activity/mg of pure alpha-amylase protein) of the alpha-amylase in question under the given set of conditions
alpha-amylase activity can also be determined by a method employing the Ethyliden-4-nitro-phenyl-alpha-D-maltoheptaosid (EPS). D-maltoheptaoside is a blocked oligosaccharide which can be cleaved by an endo-amylase. Following the cleavage, the alpha-glucosidase included in the kit to digest the substrate to liberate a free PNP molecule which has a yellow color and thus can be measured by visible spectrophotometry at 405 nm. Kits containing EPS substrate and alpha-glucosidase is manufactured by Roche Costum Biotech (cat. No. 10880078103). The slope of the time dependent absorption-curve is directly proportional to the specific activity (activity per mg enzyme) of the alpha-amylase in question under the given set of conditions.

Amylolytic activity may be provided in units per gram enzyme. For example, 1 unit alpha-amylase may liberate 1.0 mg of maltose from starch in 3 min at pH 6.9 at 20° C.

At least one amylase comprised in component (a) may be selected from the following:
amylases from Bacillus licheniformis having SEQ ID NO:2 as described in WO 95/10603. Suitable variants are described in WO 95/10603 comprising one or more substitutions in the following positions: 15, 23, 105, 106, 124, 128, 133, 154, 156, 178, 179, 181, 188, 190, 197, 201, 202, 207, 208, 209, 211, 243, 264, 304, 305, 391, 408, and 444 which have amylolytic activity. Variants are described in WO 94/02597, WO 94/018314, WO 97/043424 and SEQ ID NO:4 of WO 99/019467;
amylases from B. stearothermophilus having SEQ ID NO:6 as disclosed in WO 02/10355 or an amylase with optionally having a C-terminal truncation over the wildtype sequence. Suitable variants of SEQ ID NO:6 include those comprising a deletion in positions 181 and/or 182 and/or a substitution in position 193;
amylases from Bacillus sp. 707 having SEQ ID NO:6 as disclosed in WO 99/19467. Preferred variants of SEQ NO: 6 are those having a substitution, a deletion or an insertion in one or more of the following positions: R181, G182, H183, G184, N195, I206, E212, E216 and K269;
amylases from Bacillus halmapalus having SEQ ID NO:2 or SEQ ID NO:7 as described in WO 96/23872, also described herein as SP-722. Preferred variants are described in WO 97/3296, WO 99/194671 and WO 2013/001078;
amylases from Bacillus sp. DSM 12649 having SEQ ID NO:4 as disclosed in WO 00/22103;
amylases from Bacillus strain TS-23 having SEQ ID NO:2 as disclosed in WO 2009/061380;
amylases from Cytophaga sp. having SEQ ID NO:1 as disclosed in WO 2013/184577;
amylases from Bacillus megaterium DSM 90 having SEQ ID NO:1 as disclosed in WO 2010/104675;
amylases from Bacillus sp. comprising amino acids 1 to 485 of SEQ ID NO:2 as described in WO 00/60060;
amylases from Bacillus amyloliquefaciens or variants thereof, preferably selected from amylases according to SEQ ID NO: 3 as described in WO 2016/092009;
amylases having SEQ ID NO:12 as described in WO 2006/002643 or amylase variants comprising the substitutions Y295F and M202LITV within said SEQ ID NO:12;
amylases having SEQ ID NO:6 as described in WO 2011/098531 or amylase variants comprising a substitution at one or more positions selected from the group consisting of 193 [G,A,S,T or M], 195 [F,W,Y,L,I or V], 197 [F,W,Y,L,I or V], 198 [Q or N], 200 [F,W,Y,L,I or V], 203 [F,W,Y,L,I or V], 206 [F,W,Y,N,L,I,V,H,Q,D or E], 210 [F,W,Y,L,I or V], 212 [F,W,Y,L,I or V], 213 [G,A,S,T or M] and 243 [F,W,Y,L,I or V] within said SEQ ID NO:6;
amylases having SEQ ID NO:1 as described in WO 2013/001078 or amylase variants comprising an alteration at two or more (several) positions corresponding to positions G304, W140, W189, D134, E260, F262, W284, W347, W439, W469, G476, and G477 within said SEQ ID NO:1;
amylases having SEQ ID NO:2 as described in WO 2013/001087 or amylase variants comprising a deletion of positions 181+182, or 182+183, or 183+184, within said SEQ ID NO:2, optionally comprising one or two or more modifications in any of positions corresponding to W140, W159, W167, Q169, W189, E194, N260, F262, W284, F289, G304, G305, R320, W347, W439, W469, G476 and G477 within said SEQ ID NO:2;
amylases which are hybrid alpha-amylases from above mentioned amylases as for example as described in WO 2006/066594;
hybrid amylases according to WO 2014/183920 with A and B domains having at least 90% similarity and/or identity to SEQ ID NO:2 of WO 2014/183920 and a C domain having at least 90% similarity and/or identity to SEQ ID NO:6 of WO 2014/183920, wherein the hybrid amylase has amylolytic activity; preferably the hybrid alpha-amylase is at least 95% similar and/or identical to SEQ ID NO: 23 of WO 2014/183920 and having amylolytic activity;
hybrid amylase according to WO 2014/183921 with A and B domains having at least 75% similarity and/or identity to SEQ ID NO: 2, SEQ ID NO: 15, SEQ ID NO: 20, SEQ ID NO: 23, SEQ ID NO: 29, SEQ ID NO: 26, SEQ ID NO: 32, and SEQ ID NO: 39 as disclosed in WO 2014/183921 and a C domain having at least 90% similarity and/or identity to SEQ ID NO: 6 of WO 2014/183921, wherein the hybrid amylase has amylolytic activity; preferably, the hybrid alpha-amylase is at least 95% similar and/or identical to SEQ ID NO: 30 as disclosed in WO 2014/183921 and having amylolytic activity.

Suitable amylases comprised in component (a) include amylase variants of the amylases disclosed herein having amylase activity which are at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98% or at least 99% similar and/or identical when compared to the full-length polypeptide sequence of the parent enzyme as disclosed above.

In one embodiment of the present invention, component (a) may comprise a combination of at least two amylases as disclosed above.

In one embodiment, component (a) comprises a combination of at least one amylase, preferably selected from
amylase from Bacillus sp. 707 or variants thereof having amylolytic activity, preferably selected from amylases having SEQ ID NO:6 as disclosed in WO 99/19467 and variants thereof having amylolytic activity;
amylase selected from those comprising amino acids 1 to 485 of SEQ ID NO:2 as described in WO 00/60060 those having SEQ ID NO: 12 as described in WO 2006/002643, and variants thereof having amylolytic activity;
amylase from Bacillus halmapalus or variants thereof having amylolytic activity, preferably selected from amylases having SEQ ID NO: 1 and 2 as disclosed in WO 2013/001078; having SEQ ID NO:6 as described in WO 2011/098531; and variants thereof having amylolytic activity;
amylase from Bacillus amyloliquefaciens or variants thereof having amylolytic activity, preferably selected from amylases according to SEQ ID NO: 3 of WO 2016/092009;
hybrid amylases according to WO 2014/183920 with A and B domains having at least 90% similarity and/or identity to SEQ ID NO:2 of WO 2014/183920 and a C domain having at least 90% similarity and/or identity to SEQ ID NO:6 of WO 2014/183920, wherein the hybrid amylase has amylolytic activity; preferably the hybrid alpha-amylase is at least 95% similar and/or identical to SEQ ID NO: 23 of WO 2014/183920 and having amylolytic activity;
hybrid amylase according to WO 2014/183921 with A and B domains having at least 75% similarity and/or identity to SEQ ID NO: 2, SEQ ID NO: 15, SEQ ID NO: 20, SEQ ID NO: 23, SEQ ID NO: 29, SEQ ID NO: 26, SEQ ID NO: 32, and SEQ ID NO: 39 as disclosed in WO 2014/183921 and a C domain having at least 90% similarity and/or identity to SEQ ID NO: 6 of WO 2014/183921, wherein the hybrid amylase has amylolytic activity; preferably, the hybrid alpha-amylase is at least 95% similar and/or identical to SEQ ID NO: 30 as disclosed in WO 2014/183921 and having amylolytic activity.
   and at least one further enzyme preferably selected from proteases, lipases, cellulases, mannanases, and DNAses—all as disclosed herein. Preferably, one further enzyme is selected from subtilisin proteases (EC 3.4.21.62). More preferably, said subtilisin protease is selected from
proteases according to SEQ ID NO:22 as described in EP 1921147 or variants thereof having proteolytic activity, preferably a protease 80% identical to SEQ ID NO:22 as described in EP 1921147 having R101E, and
subtilisin 309 as disclosed in Table I a) of WO 89/06279 or variants thereof having proteolytic activity.

Lipase

At least one enzyme comprised in component (a) in one embodiment is selected from the group of lipases. “Lipases”, “lipolytic enzyme”, “lipid esterase”, all refer to an enzyme of EC class 3.1.1 (“carboxylic ester hydrolase”). Lipase means active protein having lipase activity (or lipolytic activity; triacylglycerol lipase, EC 3.1.1.3), cutinase activity (EC 3.1.1.74; enzymes having cutinase activity may be called cutinase herein), sterol esterase activity (EC 3.1.1.13) and/or wax-ester hydrolase activity (EC 3.1.1.50).

The methods for determining lipolytic activity are well-known in the literature (see e.g. Gupta et al. (2003), Biotechnol. Appl. Biochem. 37, p. 63-71). E.g. the lipase activity may be measured by ester bond hydrolysis in the substrate para-nitrophenyl palmitate (pNP-Palmitate, C:16) and releases pNP which is yellow and can be detected at 405 nm.

“Lipolytic activity” means the catalytic effect exerted by a lipase, which may be provided in lipolytic units (LU). For example, 1LU may correspond to the amount of lipase which produces 1 μmol of titratable fatty acid per minute in a pH stat. under the following conditions: temperature 30° C.; pH=9.0; substrate may be an emulsion of 3.3 wt. % of olive oil and 3.3% gum arabic, in the presence of 13 mmol/l Ca²⁺ and 20 mmol/l NaCl in 5 mmol/I Tris-buffer.

Lipases preferably comprised in component (a) include those of bacterial or fungal origin. In one aspect of the invention, a suitable lipase (component (a)) is selected from the following: lipases from Humicola (synonym Thermomyces), e.g. from H. lanuginosa (T. lanuginosus) as described in EP 258068, EP 305216, WO 92/05249 and WO 2009/109500 or from H. insolens as described in WO 96/13580; lipases derived from Rhizomucor miehei as described in WO 92/05249; lipase from strains of Pseudomonas (some of these now renamed to Burkholderia), e.g. from P. alcaligenes or P. pseudoalcaligenes (EP 218272, WO 94/25578, WO 95/30744, WO 95/35381, WO 96/00292), P. cepacia (EP 331376), P. stutzeri (GB 1372034), P. fluorescens, Pseudomonas sp. strain SD705 (WO 95/06720 and WO 96/27002), P. wisconsinensis (WO 96/12012), Pseudomonas mendocina (WO 95/14783), P. glumae (WO 95/35381, WO 96/00292); lipase from Streptomyces griseus (WO 2011/150157) and S. pristinaespiralis (WO 2012/137147), GDSL-type Streptomyces lipases (WO 2010/065455); lipase from Thermobifida fusca as disclosed in WO 2011/084412; lipase from Geobacillus stearothermophilus as disclosed in WO 2011/084417; Bacillus lipases, e.g. as disclosed in WO 00/60063, lipases from B. subtilis as disclosed in Dartois et al. (1992), Biochemica et Biophysica Acta, 1131, 253-360 or WO 2011/084599, B. stearothermophilus (JP S64-074992) or B. pumilus (WO 91/16422); lipase from Candida antarctica as disclosed in WO 94/01541; cutinase from Pseudomonas mendocina (U.S. Pat. No. 5,389,536, WO 88/09367); cutinase from Magnaporthe grisea (WO 2010/107560); cutinase from Fusarum solani pisi as disclosed in WO 90/09446, WO 00/34450 and WO 01/92502; and cutinase from Humicola lanuginosa as disclosed in WO 00/34450 and WO 01/92502.

Suitable lipases also include those referred to as acyltransferases or perhydrolases, e.g. acyltransferases with homology to Candida antarctica lipase A (WO 2010/111143), acyltransferase from Mycobacterium smegmatis (WO 2005/056782), perhydrolases from the CE7 family (WO 2009/67279), and variants of the M. smegmatis perhydrolase in particular the S54V variant (WO 2010/100028).

Component (a) in one embodiment comprises at least one lipase variant of the above described lipases which have lipolytic activity. Such suitable lipase variants are e.g. those which are developed by methods as disclosed in WO 95/22615, WO 97/04079, WO 97/07202, WO 00/60063, WO 2007/087508, EP 407225 and EP 260105.

Component (a) in one embodiment comprise at least one lipase variant having lipolytic activity which are at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98% or at least 99% similar and/or identical when compared to the full-length polypeptide sequence of the parent enzyme as disclosed above.

In one embodiment, component (a) comprises at least one lipase selected from fungal triacylglycerol lipase (EC class 3.1.1.3). Fungal triacylglycerol lipase may be selected from Thermomyces lanuginosus lipase. In one embodiment, Thermomyces lanuginosus lipase is selected from triacylglycerol lipase according to amino acids 1-269 of SEQ ID NO:2 of U.S. Pat. No. 5,869,438 and variants thereof having lipolytic activity. Triacylglycerol lipase according to amino acids 1-269 of SEQ ID NO:2 of U.S. Pat. No. 5,869,438 means a lipase having an amino acid sequence according to amino acids 1-269 of SEQ ID NO:2 as disclosed in U.S. Pat. No. 5,869,438 and may be called Lipolase herein.

Thermomyces lanuginosus lipase in one embodiment is selected from variants having lipolytic activity which are at least 90%, at least 91%, at least 92%, at least 93%, at least 94%, at least 95%, at least 96%, at least 97%, at least 98% or at least 99% similar and/or identical when compared to the full-length polypeptide sequence of amino acids 1-269 of SEQ ID NO:2 of U.S. Pat. No. 5,869,438.

Thermomyces lanuginosus lipase may be selected from variants having lipolytic activity comprising conservative mutations only, which do however not pertain the functional domain of amino acids 1-269 of SEQ ID NO:2 of U.S. Pat. No. 5,869,438. Thermomyces lanuginosus lipase variant preferably is at least 80% similar and/or identical to SEQ ID NO:2 of U.S. Pat. No. 5,869,438 characterized by having amino acid T231R and N233R. Said Thermomyces lanuginosus lipase may further comprise one or more of the following amino acid exchanges: Q4V, V60S, A150G, L227G, P256K.

According to the present invention, component (a) in one embodiment comprises a combination of at least two lipases, preferably selected from triacylglycerol lipase according to amino acids 1-269 of SEQ ID NO:2 of U.S. Pat. No. 5,869,438 and variants thereof having lipolytic activity as disclosed above.

In one embodiment, component (a) comprises at least one lipase as disclosed above, preferably selected from selected from triacylglycerol lipase according to amino acids 1-269 of SEQ ID NO:2 of U.S. Pat. No. 5,869,438 and variants thereof having lipolytic activity, and at least one further enzyme preferably selected from protease, amylase, cellulase, mannanase, and DNAse—all as disclosed herein.

Cellulase

At least one enzyme comprised in component (a) in one embodiment is selected from the group of cellulases. At least one cellulase is selected from cellobiohydrolase (1,4-P-D-glucan cellobiohydrolase, EC 3.2.1.91), endo-ss-1,4-glucanase (endo-1,4-P-D-glucan 4-glucanohydrolase, EC 3.2.1.4) and ss-glucosidase (EC 3.2.1.21). Preferably, component (a) comprises at least one cellulase of the glycosyl hydrolase family 7 (GH7, pfam00840), preferably selected from endoglucanases (EC 3.2.1.4).

“Cellulases”, “cellulase enzymes” or “cellulolytic enzymes” (component (a)) are enzymes involved in hydrolysis of cellulose. Assays for measurement of “cellulase activity” or “cellulolytic activity” are known to those skilled in the art. For example, cellulolytic activity may be determined by virtue of the fact that cellulase hydrolyses carboxymethyl cellulose to reducing carbohydrates, the reducing ability of which is determined colorimetrically by means of the ferricyanide reaction, according to Hoffman, W. S., J. Biol. Chem. 120, 51 (1937).

Cellulolytic activity may be provided in units per gram enzyme. For example, 1 unit may liberate 1.0 μmole of glucose from cellulose in one hour at pH 5.0 at 37C (2 hour incubation time).

In one embodiment, component (a) comprises at least one cellulase selected of the glycosyl hydrolase family 7 (GH7, pfam00840), preferably selected from endoglucanases (EC 3.2.1.4).

Cellulases according to the invention include those of bacterial or fungal origin. In one embodiment, at least one cellulase is selected from cellulases comprising a cellulose binding domain. In one embodiment, a least one cellulase is selected from cellulases comprising a catalytic domain only, meaning that the cellulase lacks cellulose binding domain.

In one embodiment, component (a) comprises at least one cellulase originating from Humicola insolens DSM 1800, Bacillus sp, Thielavia terrestris, Fusarium oxysporum, and Trichoderma reesei.

Suitable cellulases include also those, which are variants of the above described cellulases which have cellulolytic activity. In one embodiment cellulase variants include variants with at least 40 to 100% identity when compared to the full length polypeptide sequence of the parent enzyme as disclosed above. In one embodiment cellulase variants having cellulolytic activity are at least 70%, at least 75%, at least 80%, at least 85%, at least 90%, at least 91%, at least 92%, at least 93%, at least 94%, at least 95%, at least 96%, at least 97%, at least 98% or at least 99% similar and/or identical to the full length polypeptide sequence of the parent enzyme as disclosed above.

In one embodiment, component (a) comprises at least one Humicola insolens DSM 1800 endoglucanase (EC 3.2.1.4) having the amino acid sequence disclosed in FIG. 14A-E of WO 91/17244, preferably amino acids 20-434 according said sequence, more preferably having one or more substitutions at positions selected from 182, 223, and 231, most preferably selected from P182S, A223V, and A231V. In one embodiment, the endoglucanase is at least 80% similar and/or identical to a polypeptide according to SEQ ID NO: 2 of WO 95/02675.

In one embodiment, component (a) comprises at least a Bacillus sp. cellulase (EC 3.2.1.4) selected from a polypeptide at least 80% similar and/or identical to the amino acid sequence of position 1 to position 773 of SEQ ID NO: 2 of WO 2004/053039 or a catalytically active fragment thereof.

In one embodiment, component (a) comprises at least a Thielavia terrestris cellulase (EC 3.2.1.4) having a polypeptide at least 80% similar and/or identical to the amino acid sequence of position 1 to position 299 of SEQ ID NO: 4 of WO 2004/053039 or a catalytically active fragment thereof.

According to the present invention, component (a) in one embodiment comprises a combination of at least two cellulases, preferably selected from endoglucanases (EC 3.2.1.4) as disclosed above.

In one embodiment, component (a) comprises at least one cellulase of the GH7 family, preferably selected from endoglucanases (EC 3.2.1.4) and at least one further enzyme preferably selected from proteases, amylases, lipases, mannanases, and DNAses—all as disclosed herein.

Mannanase

At least one enzyme comprised in component (a) in one embodiment is selected from the group of mannan degrading enzymes. At least one mannan degrading enzyme is selected from β-mannosidase (EC 3.2.1.25), endo-1,4-β-mannosidase (EC 3.2.1.78), and 1,4-β-mannobiosidase (EC 3.2.1.100). Preferably, at least one mannan degrading enzyme is selected from the group of endo-1,4-β-mannosidase (EC 3.2.1.78), a group of enzymes which may be called endo-β-1,4-D-mannanase, β-mannanase, or mannanase herein.

A polypeptide having mannanase activity may be tested for mannanase activity according to standard test procedures known in the art, such as by applying a solution to be tested to 4 mm diameter holes punched out in agar plates containing 0.2% AZCL galactomannan (carob), i. e. substrate for the assay of endo-1,4-beta-D-mannanase available as Cat No. I-AZGMA from the company Megazyme (Megazyme's Internet address:
http://www.megazyme.com/Purchase/index. html).

Mannan degrading activity may be tested in a liquid assay using carob galactomannan dyed with Remazol Brilliant Bue as described in McCleary, B. V. (1978). Carbohydrate Research, 67(1), 213-221. Another method for testing mannan degrading activity uses detection of reducing sugars when incubated with substrate such as guar gum or locust bean gut—for reference see Miller, G. L. Use of Dinitrosalicylic Acid Reagent for Determination of Reducing Sugars. Analytical Chemistry 1959; 31: 426-428.

Component (a) in one embodiment comprises at least one mannanase selected from alkaline mannanase of Family 5 or 26. The term “alkaline mannanase” is meant to encompass mannanases having an enzymatic activity of at least 40% of its maximum activity at a given pH ranging from 7 to 12, preferably 7.5 to 10.5.

At least one mannanase comprised in component (a) in one embodiment is selected from mannanases originating from Bacillus organisms, such as described in JP-0304706 [beta-mannanase from Bacillus sp.], JP-63056289 [alkaline, thermostable beta-mannanase], JP63036774 [Bacillus microorganism FERM P-8856 producing beta-mannanase and beta-mannosidase at an alkaline pH], JP-08051975 [alkaline beta-mannanases from alkalophilic Bacillus sp. AM-001], WO 97/11164 [mannanase from Bacillus amyloliquefaciens], WO 91/18974 [mannanase active at an extreme pH and temperature], WO 97/11164 [mannanase from Bacillus amyloliquefaciens], WO 2014/100018 [endo-(3-mannanase1 cloned from a Bacillus circulans or Bacillus lentus strain CMG1240 (Bleman1; see U.S. Pat. No. 5,476,775)]. Suitable mannanases are described in WO 99/064619.

At least one mannanase comprised in component (a) in one embodiment is selected from mannanases originating from Trichoderma organisms, such as disclosed in WO 93/24622 and WO 2008/009673.

Component (a) in one embodiment comprises mannanase variants having mannanase activity which are at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98% or at least 99% similar and/or identical when compared to the full-length polypeptide sequence of the corresponding parent enzyme as disclosed above.

Component (a) may comprise a commercially available mannanase such as Mannaway® (Novozymes AIS).

In one embodiment, at least one mannanase comprised in component (a) is selected from mannanases having a sequence according to positions 31-490 of SEQ ID NO:388 of WO 2005/003319 and variants which are preferably at least 90% identical thereto.

According to the present invention, component (a) in one embodiment comprise a combination of at least two mannanases, preferably one of them being an alkaline mannanase; at least one mannanase is selected from the group of endo-1,4-β-mannosidase (EC 3.2.1.78) as disclosed above.

In one embodiment, component (a) comprises at least one alkaline mannanase, preferably selected from the group of endo-1,4-β-mannosidase (EC 3.2.1.78) as disclosed above, and at least one further enzyme preferably selected from protease, amylase, lipase, cellulase, and DNAse—all as disclosed herein.

DNAse

At least one enzyme comprised in component (a) in one embodiment is selected from the group of DNA degrading enzymes. Said enzymes usually catalyzes the hydrolytic cleavage of phosphodiester linkages in DNA. The DNAses are classified e.g. in E.C. 3.1.11, E.C. 3.1.12, E.C. 3.1.15, E.C. 3.1.16, E.C. 3.1.21, E.C 3.1.22, E.C 3.1.23, E.C 3.1.24 and E.C.3.1.25 as well as EC 3.1.21.X, where X=1, 2, 3, 4, 5, 6, 7, 8 or 9.

DNAse activity may be determined on DNAse Test Agar with Methyl Green (BD, Franklin Lakes, NJ, USA), which should be prepared according to the manual from supplier. Briefly, 21 g of agar is dissolved in 500 ml water and then autoclaved for 15 min at 121° C. Autoclaved agar is temperated 10 to 48° C. in water bath, and 20 ml of agar is to be poured into petridishes with and allowed to solidify by incubation o/n at room temperature. On solidified agar plates, 5 μl of enzyme solution is added and DNAse activity is observed as colorless zones around the spotted enzyme solutions.

DNAse activity may be determined by using the DNAseAlert™ Kit (11-02-01-04, IDT Intergrated DNA Technologies) according to the supplier's manual. Briefly, 95 μl DNase sample is mixed with 5 μl substrate in a microtiter plate, and fluorescence is immediately measured using e.g. a Clariostar microtiter reader from BMG Labtech (536 nm excitation, 556 nm emission). At least one DNAse comprised in component (a) may be selected from DNAses originating from Bacillus such as from Bacillus cibi, Bacillus horikoshii, Bacillus homeckiae, Bacillus idriensis, Bacillus algicola, Bacillus vietnamensis, Bacillus hwajinpoensis, Paenibacillus mucilanginosus, Bacillus indicus, Bacillus luciferensis, Bacillus marisflavi; and variants thereof. In one embodiment, at least one DNAse in component (a) is selected from polypeptides 80% identical to SEQ ID NO: 1 of WO 2019/081724. Said polypeptide may comprise one or more substitutions at positions selected from T1, G4, S7, K8, S9, S13, N16, T22, S25, S27, D32, L33, S39, G41, S42, D45, Q48, S57, S59, N61, T65, S66, V76, F78, P91, S101, S106, Q109, A112, S116, T127, S130, T138, Q140, S144, A147, C148, W154, T157, Y159, G162, S167, Q174, G175, L177, S179, and C180—all as disclosed in Wo2019/081724 and WO 2019/081721.

Component (a) in one embodiment comprises DNAse variants having DNA degrading activity which are at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98% or at least 99% similar and/or identical when compared to the full-length polypeptide sequence of the corresponding parent enzyme as disclosed above.

According to the present invention, component (a) in one embodiment comprises a combination of at least two DNAses.

Component (b)

The enzyme preparations of the invention comprise an enzyme stabilizing system (component (b)). Said enzyme stabilizing system (component (b)) comprises
(bi) a compound of general formula (A)—(component bi); and
(bii) at least one compound selected from boron containing compound and peptide stabilizer—(component bii).

Component (bi)

The enzyme stabilizing system according to the invention comprises component (bi). Component (bi) comprises at least one compound according to formula (A):

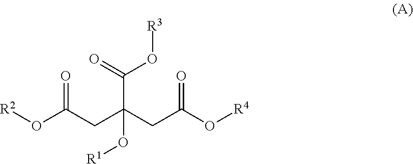

wherein the variables in formula (A) are defined as follows:
R¹ is selected from H and C₁-C₁₀ alkylcarbonyl, wherein alkyl may be linear or branched and may bear one or more hydroxyl groups,
R², R³, R⁴ are independently from each other selected from H, linear C₁-C₈ alkyl, and branched C₃-C₈ alkyl, C₆-C₁₀-aryl, non-substituted or substituted with one or more carboxylate or hydroxyl groups, and C₆-C₁₀-aryl-alkyl, wherein alkyl of the latter is selected from linear C₁-C₈ alkyl or branched C₃-C₈ alkyl, wherein at least one of R², R³, and R⁴ is not H. Examples of linear C₁-C₈ alkyl are methyl, ethyl, n-propyl, n-butyl, n-pentyl, etc. Examples of branched C₃-C₈ alkyl are 2-propyl, 2-butyl, sec.-butyl, tert.-butyl, 2-pentyl, 3-pentyl, iso-pentyl, etc. Examples of C₆-C₁₀-aryl, non-substituted or substituted with one or more carboxylate or hydroxyl groups, are phenyl, 1-naphthyl, 2-naphthyl, ortho-phenylcarboxylic acid group, meta-phenylcarboxylic acid group, para-phenylcarboxylic acid group, ortho-hydroxyphenyl, para-hydroxyphenyl, etc.

In one embodiment, R¹ in the compound according to formula (A) is selected from H, acetyl and propionyl. In one embodiment, R¹ in the compound according to formula (A) is H. In one embodiment, R¹ in the compound according to formula (A) is acetyl. In one embodiment, R¹ in the compound according to formula (A) is propionyl.

In one embodiment, R² in the compound according to formula (A) is H, and R³, R⁴ are independently from each other selected from linear C₁-C₈ alkyl, and branched C₃-C₈ alkyl, C₆-C₁₀-aryl, non-substituted or substituted with one or more carboxylate or hydroxyl groups, and C₆-C₁₀-aryl-alkyl, wherein alkyl of the latter is selected from linear C₁-C₈ alkyl or branched C₃-C₈ alkyl.

In one embodiment, R², R³, R⁴ in the compound according to formula (A) are the same, wherein R², R³, R⁴ are selected from linear C₁-C₈ alkyl, and branched C₃-C₈ alkyl, C₆-C₁₀-aryl, non-substituted or substituted with one or more carboxylate or hydroxyl groups, and C₆-C₁₀-aryl-alkyl, wherein alkyl of the latter is selected from linear C₁-C₈ alkyl or branched C₃-C₈ alkyl. Preferably, R², R³, R⁴ are selected from linear C₂-C₄ alkyl, preferably C₂ and C₄ alkyl.

In one embodiment, R¹ in the compound according to formula (A) is H, and R², R³, R⁴ are selected from linear C₂-C₄ alkyl, phenylmethyl, and ortho-phenylcarboxylic acid group (salicyl).

In one embodiment, R¹, R² and R³ in the compound according to formula (A) are H, and R⁴ is selected from linear C₂-C₄ alkyl, preferably C₂ alkyl. In one embodiment, R¹, and R² in the compound according to formula (A) are H, and R³ and R⁴ are selected from linear C₂-C₄ alkyl, preferably C₂ alkyl.

In one embodiment, R¹ in the compound according to formula (A) is H, and R², R³, R⁴ are selected from linear C₂-C₄ alkyl, preferably C₂ and C₄ alkyl.

In one embodiment, R¹ in the compound according to formula (A) is acetyl, and R², R³, R⁴ are selected from linear C₂-C₄ alkyl, preferably C₂ and C₄ alkyl.

Component (bi) includes salts of the compound according to formula (A). Salts include alkali metal and ammonium salts e.g those of mono- and triethanolamine. Preference is given to potassium salts and sodium salts.

In one embodiment of the present invention, enzyme preparations, preferably liquid enzyme preparations, comprise component (bi) in amounts in the range of 1% to 50% by weight, relative to the total weight of the enzyme preparation. The enzyme preparations preferably comprise component (bi) in amounts in the range of 5% to 45% by weight, 8% to 30% by weight, 10% to 35% by weight, 12% to 30% by weight, or 15% to 25% by weight, all relative to the total weight of the enzyme preparation.

In one embodiment of the present invention, component (bi) comprises at least one at least partially hydrolyzed derivative of compound (bi) as impurity. In one embodiment of the present invention, component (bi) comprises as an impurity of a fully hydrolyzed compound (bi′) which is as follows:

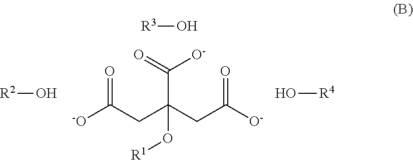

wherein the variables R¹, R², R³, and R⁴ are the same as described for component (bi) above.

Such impurity may amount to up to 50 mol-%, preferably 0.1 to 20 mol-%, even more preferably 1 to 10 mol-% of component (bi). Although the impurities may originate from the synthesis of component (bi) and may be removed by purification methods it is not preferred to remove it.

Component (bii)

The enzyme stabilizing system according to the invention comprises component (bii), wherein component (bii) comprises at least one compound selected from boron containing compound, and peptide stabilizer. In one embodiment, component (bii) comprises at least one compound selected from 4-FPBA and tripeptide stabilizers, wherein tripeptide stabilizers are preferably compounds according to formula (Da).

Component (bii) in one embodiment comprises at least one boron-containing compound:

Boron-containing compounds are selected from boric acid or its derivatives and from boronic acid or its derivatives such as aryl boronic acids or its derivatives, from salts thereof, and from mixtures thereof. Boric acid herein may be called orthoboric acid.

In one embodiment, boron-containing compound is selected from the group consisting of aryl boronic acids and its derivatives. In one embodiment, boron-containing compound is selected from the group consisting of benzene boronic acid (BBA) which is also called phenyl boronic acid (PBA), derivatives thereof, and mixtures thereof. In one embodiment, phenyl boronic acid derivatives are selected from the group consisting of the derivatives of formula (Ca) and (Cb) formula:

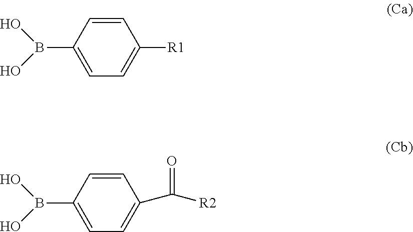

wherein
R1 is selected from the group consisting of hydrogen, hydroxy, non-substituted or substituted C₁-C₈ alkyl, and non-substituted or substituted C₁-C₈ alkenyl; in a preferred embodiment, R is selected from the group consisting of hydroxy, and non-substituted C₁ alkyl;
R2 is selected from the group consisting of hydrogen, hydroxy, non-substituted or substituted C₁-C₈ alkyl, and non-substituted or substituted C₁-C₈ alkenyl; in a preferred embodiment, R is selected from the group consisting of H, hydroxy, and substituted C₁ alkyl.

In one embodiment phenyl-boronic acid derivatives are selected from the group consisting of 4-formyl phenyl boronic acid (4-FPBA), 4-carboxy phenyl boronic acid (4-CPBA), 4-(hydroxymethyl) phenyl boronic acid (4-HMPBA), and p-tolylboronic acid (p-TBA).

Other suitable derivatives include: 2-thienyl boronic acid, 3-thienyl boronic acid, (2-acetamidophenyl) boronic acid, 2-benzofuranyl boronic acid, 1-naphthyl boronic acid, 2-naphthyl boronic acid, 2-FPBA, 3-FBPA, 1-thianthrenyl boronic acid, 4-dibenzofuran boronic acid, 5-methyl-2-thienyl boronic acid, 1-benzothiophene-2 boronic acid, 2-furanyl boronic acid, 3-furanyl boronic acid, 4,4 biphenyl-diboronic acid, 6-hydroxy-2-naphthaleneboronic acid, 4-(methylthio) phenyl boronic acid, 4-(timethylsilyl) phenyl boronic acid, 3-bromothiophene boronic acid, 4-methylthiophene boronic acid, 2-naphthyl boronic acid, 5-bromothiophene boronic acid, 5-chlorothiophene boronic acid, dimethylthiophene boronic acid, 2-bromophenyl boronic acid, 3-chlorophenyl boronic acid, 3-methoxy-2-thiophene boronic acid, p-methyl-phenylethyl boronic acid, 2-thianthrenyl boronic acid, di-benzothiophene boronic acid, 9-anthracene boronic acid, 3,5 dichlorophenyl boronic, acid, diphenyl boronic acid anhydride, o-chlorophenyl boronic acid, p-chlorophenyl boronic acid, m-bromophenyl boronic acid, p-bromophenyl boronic acid, p-fluorophenyl boronic acid, octyl boronic acid, 1,3,5 trimethylphenyl boronic acid, 3-chloro-4-fluorophenyl boronic acid, 3-aminophenyl boronic acid, 3,5-bis-(trifluoromethyl) phenyl boronic acid, 2,4 dichlorophenyl boronic acid, 4-methoxyphenyl boronic acid, and mixtures thereof.

In one embodiment, the enzyme preparations comprise about 0.1-2% by weight relative to the total weight of the enzyme preparation of at least one boron-containing compound. Preferably, the enzyme preparations comprise about 0.15-1%, or 0.2-0.5%, or about 0.3% by weight relative to the total weight of the enzyme preparation of at least one boron-containing compound. More preferably, the enzyme preparations comprises about 0.3% by weight relative to the total weight of the enzyme preparation of 4-FPBA.

Component (bii) preferably comprises at least one peptide stabilizer. Peptide stabilizers are selected from di-, tri- or tetrapeptide aldehydes and aldehyde analogues (either of the form B1-BO—R wherein, R is H, CH₃, CX₃, CHX₂, or CH₂X (X=halogen), BO is a single amino acid residue (in one embodiment with an optionally substituted aliphatic or aromatic side chain); and B1 consists of one or more amino acid residues (in one embodiment one, two or three), optionally comprising an N-terminal protection group, or as described in WO 09/118375 and WO 98/13459, or a protease inhibitor of the protein type such as RASI, BASI, WASI (bifunctional alpha-amylase/subtilisin inhibitors of rice, barley and wheat) or Cl₂ or SSI.

At least one peptide stabilizer in one embodiment is selected from a compound of formula (Da) or a salt thereof or from a compound of formula (Db):

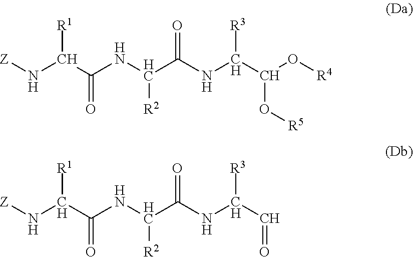

wherein R¹, R², R³, R⁴, R⁵ and Z within formulae (Da) and (Db) are defined as follows:
R¹, R² and R³are each independently selected from the group consisting of hydrogen, optionally substituted C₁₋₈ alkyl, optionally substituted C₂₋₄ alkenyl, optionally substituted C₁₋₈ alkoxy, optionally substituted 3- to 12-membered cycloalkyl, and optionally substituted 6- to 10-membered aryl; or wherein each R¹, R² and R³ is independently selected as —(CH₂)₃— which is also attached to the nitrogen atom of —NH—C(H)— so that —N—C(H)R^{1, 2 or 3}-forms a 5-membered heterocyclic ring;
R⁴ and R⁵ are each independently selected from the group consisting of hydrogen, optionally substituted C₁₋₈ alkyl, optionally substituted C₂₋₆ alkenyl, optionally substituted C₁₋₈ alkoxy, optionally substituted C₁₋₄ acyl, optionally substituted C₁₋₈ alkyl phenyl (e.g. benzyl), and optionally substituted 6- to 10-membered aryl; or wherein R⁴ and R⁵ are joined to form an optionally substituted 5- or 6-membered ring;
Z is selected from hydrogen, an N-terminal protection group, and one or more amino acid residues optionally comprising an N-terminal protection group.

Preferably, R¹ is a group such that NH—CHR¹—CO is an L or D-amino acid residue of Gly, Ala, Val, Leu, lie, Met, Pro, Phe, Trp, Ser, Thr, Asp, Gln, Tyr, Cys, Lys, Arg, His, Asn, Glu, m-tyrosine, 3,4-dihydroxyphenylalanine, Nva, or Nle. More preferably, R¹ is a group such that NH—CHR¹—CO is an L or D-amino acid residue of Ala, Val, Gly, Arg, Leu, Phe, lie, His or Thr. Even more preferably, R¹ is a group such that NH—CHR¹—CO is an L or D-amino acid residue of Ala, Val, Gly, Arg, Leu, Ile or His.

Preferably, R² is a group such that NH—CHR²—CO is an L or D-amino acid residue of Gly, Ala, Val, Leu, lie, Met, Pro, Phe, Trp, Ser, Thr, Asp, Gln, Tyr, Cys, Lys, Arg, His, Asn, Glu, m-tyrosine, 3,4-dihydroxyphenylalanine, Nva, or Nle. More preferably, R² is a group such that NH—CHR²—CO is an L or D-amino acid residue of Ala, Cys, Gly, Pro, Ser, Thr, Val, Nva or Nle. Even more preferably, R² is a group such that NH—CHR²—CO is an L or D-amino acid residue of Ala, Gly, Pro or Val.

In one embodiment R¹ is a group such that NH—CHR¹—CO is an L or D-amino acid residue of Ala, Val, Gly, Arg, Leu, Ile or His and R² is a group such that NH—CHR²—CO is an L or D-amino acid residue of Ala. In one embodiment R¹ is a group such that NH—CHR¹—CO is an L or D-amino acid residue of Ala, Val, Gly, Arg, Leu, Ile or His and R² is a group such that NH—CHR²—CO is an L or D-amino acid residue of Gly. In one embodiment R¹ is a group such that NH—CHR¹—CO is an L or D-amino acid residue of Ala, Val, Gly, Arg, Leu, Ile or His and R² is a group such that NH—CHR²—CO is an L or D-amino acid residue of Pro. In one embodiment R¹ is a group such that NH—CHR¹—CO is an L or D-amino acid residue of Ala, Val, Gly, Arg, Leu, Ile or His and R² is a group such that NH—CHR²—CO is an L or D-amino acid residue of Val.

In one embodiment R¹ is a group such that NH—CHR¹—CO is an L or D-amino acid residue of Ala and R² is a group such that NH—CHR²—CO is an L or D-amino acid residue of Ala, Gly, Pro or Val. In one embodiment R¹ is a group such that NH—CHR¹—CO is an L or D-amino acid residue of Val and R² is a group such that NH—CHR²—CO is an L or D-amino acid residue of Ala, Gly, Pro or Val. In one embodiment R¹ is a group such that NH—CHR¹—CO is an L or D-amino acid residue of Gly and R² is a group such that NH—CHR²—CO is an L or D-amino acid residue of Ala, Gly, Pro or Val. In one embodiment R¹ is a group such that NH—CHR¹—CO is an L or D-amino acid residue of Arg and R² is a group such that NH—CHR²—CO is an L or D-amino acid residue of Ala, Gly, Pro or Val. In one embodiment R¹ is a group such that NH—CHR¹—CO is an L or D-amino acid residue of Leu and R² is a group such that NH—CHR²—CO is an L or D-amino acid residue of Ala, Gly, Pro or Val. In one embodiment R¹ is a group such that NH—CHR¹—CO is an L or D-amino acid residue of Ile and R² is a group such that NH—CHR²—CO is an L or D-amino acid residue of Ala, Gly, Pro or Val. In one embodiment R¹ is a group such that NH—CHR¹—CO is an L or D-amino acid residue of His and R² is a group such that NH—CHR²—CO is an L or D-amino acid residue of Ala, Gly, Pro or Val.

In one embodiment, R³ is a group selected from optionally substituted C₁₋₈ alkyl, such as CH₂Si(CH₃)₃, C₁₋₄ alkylphosphates such as (CH₂)ₙPO(OR)₂, C₁₋₄ alkylnitriles such as CH₂CN, C₁₋₄ alkylsulfones such as CH₂SO₂R, C₁₋₄ alkylethers such as (CH₂)ₙOR, C₁₋₈ alkylesters such as CH₂CO₂R, and C₁₋₈ alkylamides; optionally substituted C₁.e alkoxy, optionally substituted 3- to 12-membered cycloalkyl, such as cyclohexylmethyl; and optionally substituted 6- to 10-membered aryl, wherein R is independently selected from the group consisting of hydrogen, optionally substituted C₁₋₈ alkyl, optionally substituted C₁₋₈ alkoxy, optionally substituted 3- to 12-membered cycloalkyl, optionally substituted 6- to 10-membered aryl, and optionally substituted 6- to 10-membered heteroaryl and n is an integer from 1 to 8, i.e. 1, 2, 3, 4, 5, 6, 7 or 8.

Preferably, R³ is a group such that NH—CHR³—CO is an L or D-amino acid residue of Tyr, m-tyrosine, 3,4-dihydroxyphenylalanine, Phe, Val, Ala, Met, Nva, Leu, Ile or Nle or other non-natural amino acids carrying alkyl groups. More preferably, R³ is a group such that NH—CHR³—CO is an L or D-amino acid residue of Tyr, Phe, Val, Ala or Leu.

In one embodiment, R¹, R² and R³ is a group such that NH—CHR¹—CO, NH—CHR²—CO and NH—CHR³—CO each is an L or D-amino acid residue of Gly, Ala, Val, Leu, lie, Met, Pro, Phe, Trp, Ser, Thr, Asp, Gln, Tyr, Cys, Lys, Arg, His, Asn, Glu, m-tyrosine, 3,4-dihydroxyphenylalanine, Nva or Nle.

In one embodiment, R¹ and R² is a group such that NH—CHR¹—CO and NH—CHR²—CO each is an L or D-amino acid residue of Ala, Cys, Gly, Pro, Ser, Thr, Val, Nva or Nle, and R³ is a group such that NH—CHR³—CO is an L or D-amino acid residue of Tyr, m-tyrosine, 3,4-dihydroxyphenylalanine, Phe, Val, Ala, Met, Nva, Leu, Ile or Nle.

In one embodiment, R¹ is a group such that NH—CHR¹—CO is an L or D-amino acid residue of Gly or Val, R² is a group such that NH—CHR²—CO is an L or D-amino acid residue of Ala, and R³ is a group such that NH—CHR³—CO is an L or D-amino acid residue of Tyr, Ala, or Leu.

In one embodiment, R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Leu.

In one embodiment, R¹ is a group such that NH—CHR¹—CO is an L or D-amino acid residue of Gly, R² is a group such that NH—CHR²—CO is an L or D-amino acid residue of Ala, and R³ is a group such that NH—CHR³—CO is an L or D-amino acid residue of Tyr.

In one embodiment, R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Ala.

In one embodiment, R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Norleucine.

In one embodiment, R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Norvaline.

In one embodiment, R⁴ and R⁵ are each independently selected from hydrogen, methyl, ethyl, i-propyl, n-propyl, i-butyl, s-butyl, n-butyl, i-pentyl, 2-pentyl, 3-pentyl, neopentyl, cyclopentyl, cyclohexyl, and benzyl.

R⁴ and R⁵ may each independently be selected from methyl, ethyl, isopropyl, 2-butyl or 3-pentyl. More preferably, R⁴ and R⁵ are both methyl, ethyl, isopropyl, 2-butyl or 3-pentyl.

Z is selected from hydrogen, an N-terminal protection group, and one or more amino acid residues optionally comprising an N-terminal protection group. Preferably, Z is an N-terminal protection group.

The N-terminal protection group may be selected from formyl, acetyl (Ac), benzoyl (Bz), trifluoroacetyl, fluorenylmethyloxycarbonyl (Fmoc), methoxysuccinyl, aromatic and aliphatic urethane protecting groups, benzyloxycarbonyl (Cbz), tert-butyloxycarbonyl (Boc), adamantyloxycarbonyl, p-methoxybenzyl carbonyl (MOZ), benzyl (Bn), p-methoxybenzyl (PMB) or p-methoxyphenyl (PMP), methoxycarbonyl (Moc); methoxyacetyl (Mac); methyl carbamate, a methylamino carbonyl/methyl urea group, tityl (Trt), 3,5-dimethoxyphenylisoproxycarbonyl (Ddz), 2-(4-biphenyl)isopropoxycarbonyl (Bpoc), 2-nitrophenylsulfenyl (Nps), 2-(4-nitrophenylsulfonyl)ethoxycarbonyl (Nsc), 1,1-dioxobenzo[b]thiophene-2-ylmethyloxycarbonyl (Bsmoc), (1,1-dioxonaphtho[1,2-b]thiophene-2-yl)methyloxycarbonyl (α-Nsmoc), 1-(4,4-dimethyl-2,6-dioxo-cyclohex-1-ylidene)-3-methylbutyl (ivDde), 2,7-di-tert-butyl-Fmoc (Fmoc*), 2-fluoro-Fmoc (Fmoc(2F)), 2-monoisooctyl-Fmoc (mio-Fmoc) and 2,7-diisooctyl-Fmoc (dio-Fmoc), tetrachlorophthaloyl (TCP), 2-phenyl(methyl)sulfonio)ethyloxycarbonyl tetrafluoroborate (Pms), ethane-sulfonylethoxycarbonyl (Esc), 2-(4-sulfophenylsulfonyl)ethoxycarbonyl (Sps), allyloxycarbonyl (Alloc), o-nitrobenzenesulfonyl (oNBS), 2,4-dinitrobenzenesulfonyl (dNBS), Benzothiazole-2-sulfonyl (Bts), 2,2,2-trichloroethyloxycarbonyl (Troc), dithiasuccinoyl (Dts), p-nitrobenzyloxycarbonyl (pNZ), α-Azidoacids, Propargyloxycarbonyl (Poc), o-Nitrobenzyloxycarbonyl (oNZ), 4-Nitro-veratryloxycarbonyl (NVOC), 2-(2-Nitrophenyl)propyloxycarbonyl (NPPOC), 2-(3,4-Methylenedioxy-6-nitrophenyl)propyloxycarbonyl (MNPPOC), 9-(4-Bromophenyl)-9-fluorenyl (BrPhF), Azidomethyloxycarbonyl (Azoc), Hexafluoroacetone (HFA), 2-Chlorobenzyloxycarbonyl (CI-Z), Trifluoroacetyl (tfa), 2-(Methylsulfonyl)ethoxycarbonyl (Msc), Tetrachlorophthaloyl (TCP), Phenyldisulphanylethyloxycarbonyl (Phdec), 2-Pyridyldisulphanylethyloxycarbonyl (Pydec), or 4-Methyltrityl (Mtt).

If Z is one or more amino acid residue(s) comprising an N-terminal protection group, the N-terminal protection group is preferably a small aliphatic group, e.g., formyl, acetyl, fluorenylmethyloxycarbonyl (Fmoc), tert-butyloxycarbonyl (Boc), methoxycarbonyl (Moc); methoxyacetyl (Mac); methyl carbamate or a methylamino carbonyl/methyl urea group. In the case of a tripeptide, the N-terminal protection group is preferably a bulky aromatic group such as benzoyl (Bz), benzyloxycarbonyl (Cbz), p-methoxybenzyl carbonyl (MOZ), benzyl (Bn), p-methoxybenzyl (PMB) or p-methoxyphenyl (PMP).

Further suitable N-terminal protection groups are described in Greene's Protective Groups in Organic Synthesis, Fifth Edition by Peter G. M. Wuts, published in 2014 by John Wiley & Sons, Inc and in Isidro-Llobet et al., Amino Acid-Protecting Groups, Chem. Rev. 2009 109(6), 2455-2504.

Preferably, the N-terminal protection group is selected from benzyloxycarbonyl (Cbz), p-methoxybenzyl carbonyl (MOZ), benzyl (Bn), benzoyl (Bz), p-methoxybenzyl (PMB), p-methoxyphenyl (PMP), formyl, acetyl (Ac), methyloxy, alkoxycarbonyl, methoxycarbonyl, fluorenylmethyloxycarbonyl (Fmoc), or tert-butyloxycarbonyl (Boc). Most preferably, the N-terminal protection group is benzyloxycarbonyl (Cbz).

In a preferred embodiment, the peptide stabilizer is selected from compounds according to formula (Db), wherein
R¹ and R² is a group such that NH—CHR¹—CO and NH—CHR²—CO each is an L or D-amino acid residue selected from Ala, Cys, Gly, Pro, Ser, Thr, Val, Nva or Nle, and R³ is a group such that NH—CHR³—CO is an L or D-amino acid residue selected from Tyr, m-tyrosine, 3,4-dihydroxyphenylalanine, Phe, Val, Ala, Met, Nva, Leu, Ile or Nle;
and
the N-terminal protection group Z is selected from benzyloxycarbonyl (Cbz), p-methoxybenzyl carbonyl (MOZ), benzyl (Bn), benzoyl (Bz), p-methoxybenzyl (PMB), p-methoxyphenyl (PMP), formyl, acetyl (Ac), methyloxy, alkoxycarbonyl, methoxycarbonyl, fluorenylmethyloxycarbonyl (Fmoc), or tert-butyloxycarbonyl (Boc).

In a more preferred embodiment, the peptiptide stabilizer according to formula (Db) is characterized in
R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Leu;
and
the N-terminal protection group Z is selected from benzyloxycarbonyl (Cbz), p-methoxybenzyl carbonyl (MOZ), benzyl (Bn), benzoyl (Bz), p-methoxybenzyl (PMB), p-methoxyphenyl (PMP), formyl, acetyl (Ac), methyloxy, alkoxycarbonyl, methoxycarbonyl, fluorenylmethyloxycarbonyl (Fmoc), or tert-butyloxycarbonyl (Boc); preferably, the N-terminal protection group Z is benzyloxycarbonyl (Cbz).

In one embodiment, the enzyme preparations comprise about 0.1-2% by weight relative to the total weight of the enzyme preparation of at least one peptide stabilizer. Preferably, the enzyme preparations comprise about 0.15-1%, or 0.2-0.5%, or about 0.3% by weight relative to the total weight of the enzyme preparation of at least one peptide stabilizer. More preferably, the enzyme preparations comprise about 0.3% by weight relative to the total weight of the enzyme preparation of a peptide stabilizer according to formula (Db) characterized in
R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Leu;
and
the N-terminal protection group Z is benzyloxycarbonyl (Cbz).

Component (b) optionally comprises further compounds stabilizing enzymes such as
at least one polyol selected from sorbitol, mannitol, erythriol, glucose, fructose, and lactose;
at least one salt selected from NaCl, KCl, and alkali salts of lactic acid and formic acid;
at least one water-soluble source of zinc (II), calcium (II) and/or magnesium (II) ions that provide such ions to the enzymes, as well as other metal ions (e.g. barium (II), scandium (II), iron (II), manganese (II), aluminum (Ill), Tin (II), cobalt (II), copper (II), Nickel (II), and oxovanadium (IV)).

The enzyme preparations of the invention in one embodiment comprise a total amount of peptide stabilizer in the range from about 0.05% to 2%, in the range from about 0.08% to 1%, or in the range from 0.1 to 0.5% by weight, all relative to the total weight of the enzyme preparation. Preferably, the enzyme preparations comprise about 0.3% by weight relative to the total weight of the enzyme preparation of a peptide stabilizer as disclosed above.

Component (c)

The liquid enzyme preparations of the invention comprise at least one diol (component (c)). Component (c), in one embodiment, is comprised in a total amount of about 10% to 35% by weight, preferably 12% to 31% by weight, relative to the total weight of the enzyme preparation.

At least one diol (component (c)) is selected from diols containing from 4 to 10 C-atoms. In one aspect of the invention the —OH groups in the diols are vicinally positioned, as e.g. in 1,2-pentane diol. In another aspect of the invention, the —OH groups are localized terminally, as e.g. 1,6-hexane diol.

In one embodiment, the diols having vicinally positioned —OH groups contain 4 to 10 C-atoms, preferably 4 to 8 C-atoms, more preferably 4 to 6 C-atoms, most preferably 4 to 5 C-atoms. The diol may be selected from 1,2-butandiol and 1,2-pentandiol. The diol having vicinally positioned —OH groups may be comprised in the enzyme preparations in amounts in the range of 1% to 5% by weight, or in amounts of about 4% by weight, all relative to the total weight of the enzyme preparation.

In one embodiment, the diols having terminal —OH groups contain 3 to 10 C-atoms, preferably 4 to 8 C-atoms. The diol preferably is selected from 1,4-butanediol, 1,6-hexanediol and 1,8-octanediol. The diol having terminal —OH groups preferably is comprised in the enzyme preparations in amounts in the range of 10% to 30% by weight, or 12% to 27% by weight, all relative to the total weight of the enzyme preparation. In one embodiment, at least one diol having terminal —OH groups preferably is comprised in the enzyme preparations in amounts in the range of 25% to 30% by weight, of about 27% by weight, all relative to the total weight of the enzyme preparation.

In one embodiment, component (c) comprises a combination of at least two diols, wherein at least one of the diols is selected from diols having terminal —OH groups containing 3 to 10 C-atoms, preferably 4 to 8 C-atoms. More preferably, the diol having terminal —OH groups is selected from 1,4-butanediol, 1,6-hexanediol and 1,8-octanediol.

In one embodiment, component (c) comprises at least two diols, wherein
the first diol is selected from diols having vicinally positioned —OH groups containing 4 to 10 C-atoms, preferably 4 to 8 C-atoms, more preferably 4 to 6 C-atoms, most preferably 4 to 5 C-atoms; said diol may be selected from 1,2-butandiol and 1,2-pentandiol; and
the second diol is selected from diols having terminal —OH groups containing 3 to 10 C-atoms, preferably 4 to 8 C-atoms; said diol may be selected from 1,4-butanediol, 1,6-hexanediol and 1,8-octanediol.

In one embodiment, component (c) comprises a mixture of diols having vicinally positioned —OH groups containing 4 to 10 C-atoms and diols is selected from diols having terminal —OH groups containing 3 to 10 C-atoms in a mixing ratio of 1:10, 1:9, 1:8,1:7, or 1:6. In one embodiment, the mixing ratio is within the range of 1:6 to 1:8, more preferably within the range of 1:7 to 1:6. The mixing ratio is preferably 1:6.75. Mixing ratio preferably means weight ratio.

Component (c) may be comprised in the enzyme preparations in amounts of about 1-40% by weight relative to the total weight of the enzyme preparation. Component (c) may be comprised in the enzyme preparations in amounts of about 2-35%, 4-30%, or 10-27% by weight relative to the total weight of the enzyme preparation.

In one embodiment, the enzyme preparations comprise about 2-5% by weight 1,2-butandiol in combination with about 10-30% by weight of at least one diol selected from 1,4-butanediol, 1,6-hexanediol and 1,8-octanediol; % by weight relative to the total weight of the enzyme preparation.

In one embodiment, the enzyme preparations comprise about 2-5% by weight 1,2-pentandiol in combination with about 10-30% by weight of at least one diol selected from 1,4-butanediol, 1,6-hexanediol and 1,8-octanediol; % by weight relative to the total weight of the enzyme preparation.

In one embodiment, the weight ratio of component (bi) and component (c) comprised in the enzyme preparations of the invention is in the range of about 2.5:1 to about 0.8:1. In a preferred embodiment, the weight ratio of component (bi) to at least one diol having terminally positioned —OH containing 4-8 C-atoms is in the range of 2.1:1 to 0.9:1, preferably, the weight ratio is 0.9:1.

Component (d)

The liquid enzyme preparations of the invention optionally comprise component (d) which comprises at least one compound selected from
(di) solvents, (component (di)) and
(dii) compounds stabilizing the liquid enzyme preparation as such (component (dii)).

The inventive enzyme preparations comprise water in amounts in the range of 5% to 50% by weight, in the range of 5% to 30% by weight, in the range of 5% to 25% by weight, or in the range of 10% to 40% by weight, all relative to the total weight of the enzyme preparation.

Component (di): Organic Solvents

In one embodiment, the enzyme preparations of the invention comprise at least one organic solvent selected from ethanol, n-propanol, iso-propanol, n-butanol, iso-butanol, sec.-butanol, ethylene glycol, propylene glycol, 1,2-propane diol, 1,3-propane diol, 1,2-butane diol, glycerol (1,2,3-propanetriol), diglycol, propyl diglycol, butyl diglycol, hexylene glycol, (poly) ethylene glycol methyl ether (methoxy polyethylene glycol; MPEG), ethylene glycol ethyl ether, ethylene glycol propyl ether, and phenoxyethanol, preferred are ethanol, isopropanol or propylene glycol. Further, the enzyme preparations of the invention may comprise at least one organic solvent selected from compounds such as 2-butoxyethanol, isopropyl alcohol, and d-limonene.

In one embodiment, the enzyme preparations comprise about 1-40% by weight, preferably about 5-35% by weight, more preferably about 10-30% by weight, even more preferably 520% by weight with a lower limit of about 5-10% by weight of an organic solvent, preferably selected from ethylene glycol, propylene glycol, 1,2-propane diol (propylene glycol; MPG), 1,3-propane diol, 1,2-butane diol, glycerol, diglycol, propyl diglycol, butyl diglycol, hexylene glycol, (poly) ethylene glycol methyl ether, ethylene glycol ethyl ether, ethylene glycol propyl ether, and phenoxyethanol, preferred are ethanol, isopropanol, MPEG or propylene glycol (1,2-propane diol). In one embodiment, the enzyme preparations comprise about 10-30% by weight 1,2-propane diol.

In one embodiment, the enzyme preparations comprise about 10-30% by weight polyethylene glycol methyl ether. All % by weight are relative to the total weight of the enzyme preparation.

In one embodiment, the enzyme preparations comprise at least one organic solvent, preferably selected from 1,2-propane diol and polyethylene glycol methyl ether, and component (c) in a weight ratio of about 1:2 to about 1:3.3. In a preferred embodiment, component (c) comprises at least one diol selected from diols having terminal —OH groups containing 3 to 10 C-atoms, preferably 4 to 8 C-atoms; said diol may be selected from 1,4-butanediol, 1,6-hexanediol and 1,8-octanediol.

In a preferred embodiment, the enzyme preparations comprise at least one organic solvent, preferably selected from 1,2-propane diol and polyethylene glycol methyl ether, and component (c) in a weight ratio of about 1:2 to about 1:3.3, wherein component (c) comprises at least 1,6-hexanediol.

In one embodiment, the enzyme preparations comprise at least one organic solvent, preferably selected from 1,2-propane diol and polyethylene glycol methyl ether, and component (c) in a weight ratio of about 1:2 to about 1:3.3, wherein component (c) comprises a mixture of 1,6-hexanediol and at least one diols having vicinally positioned —OH as disclosed above, preferably selected from 1,2-butan diol and 1,2-pentandiol, wherein the weight ratio of 1,6-hexane diol to the diol having vicinally positioned —OH is 10:1, 9:1, 8:1, 7:1, or 6:1, preferably within the range of 6:1 to 8:1, more preferably within the range of 7:1 to 6:1, most preferably 6.75:1.

Component (dii): Compound Stabilizing the Liquid Enzyme Preparation as Such

The enzyme preparations of the invention preferably comprise at least one compound stabilizing the liquid enzyme preparation as such. Compounds stabilizing the liquid enzyme preparation as such means any compound except enzyme stabilizers needed to establish storage stability of a liquid preparation in amounts effective to ensure the storage stability.

Storage stability in the context of liquid preparations to those skilled in the art usually includes aspects of appearance of the product and uniformity of dosage.

Appearance of the product is influenced by the pH of the product and by the presence of compounds such as preservatives, antioxidants, viscosity modifiers, emulsifiers etc.

Uniformity of dosage is usually related to the homogeneity of a product.

Inventive enzyme preparations may be alkaline or exhibit a neutral or slightly acidic pH value, such as 5 to 14, 5.3 to 13, 5.5 to 9, or 5.5 to 8.5. In one embodiment, the enzyme preparations vea pH of 5-8.

The liquid enzyme preparations of the invention may comprise at least one preservative. Preservatives are added in amounts effective in preventing microbial growth in the liquid enzyme preparation, preferably the aqueous enzyme preparation. In one embodiment, at least one preservative is selected from:
Benzylhemiformal, synonym: (Benzyloxy)methanol (CAS No. 14548-60-8);
(Ethylenedioxy)dimethanol, synonyms: Dascocide 9; (ethylenedioxy)dimethanol (reaction products of ethylene glycol with paraformaldehyde (EGForm)) (CAS. No. 3586-55-8);
.alpha.,.alpha.′,.alpha.″-trimethyl-1,3,5-triazine-1,3,5(2H,4H,6H)-triethanol, synonyms: Tris(N-hydroxypropyl) hexahydrotriazine, hexahydro-1,3-5-tris(2-hydroxypropyl)-s-triazine (HPT, CAS No. 25254-50-6);
2,2-dibromo-2-cyanoacetamide (DBNPA, CAS No. 10222-01-2);
2,2′-dithiobis[N-methylbenzamide] (DTBMA, CAS No. 2527-58-4);
2-bromo-2-(bromomethyl)pentanedinitrile (DBDCB, CAS No. 35691-65-7);
2-Butanone, peroxide, synonym: 2-butanone-peroxide (CAS No. 1338-23-4);
2-butyl-benzo[d]isothiazol-3-one (BBIT, CAS No. 4299-07-4);
2-methyl-2H-isothiazol-3-one (MIT, CAS No 2682-20-4);
2-octyl-2H-isothiazol-3-one (OIT, CAS No. 26530-20-1);
5-Chloro-2-methyl-2H-isothiazol-3-one (CIT, CMIT, CAS No. 26172-55-4);
Mixture of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9);
1,2-benzisothiazol-3(2H)-one (BIT, CAS No. 2634-33-5);
3,3′-methylenebis[5-methyloxazolidine] (Oxazolidin/MBO, CAS No. 66204-44-2);
4,4-dimethyloxazolidine (CAS No. 51200-87-4);
7a-ethyldihydro-1H,3H,5H-oxazolo[3,4-c]oxazole (EDHO, CAS No. 7747-35-5);
Benzyl Alcohol (CAS No. 100-51-6);
Biphenyl-2-ol (CAS No. 90-43-7);
Biphenyl-2-ol, and its salts, o-phenylphenol, MEA-o-phenylphenate, potassium phenylphenate, sodium phenylphenate;
Sodium 2-biphenylate (CAS No. 132-27-4);
cis-1-(3-chloroallyl)-3,5,7-triaza-1-azoniaadamantane chloride (cis CTAC, CAS No. 51229-78-8);
Didecyldimethylammonium chloride (DDAC, CAS No. 68424-95-3 and CAS No. 7173-51-5);
Dodecylguanidine monohydrochloride (CAS No 13590-97-1);
Ethanol (CAS. No 64-17-5);
n-propanol (1-propanol, CAS No. 71-23-8)
Hexa-2,4-dienoic acid (Sorbic acid, CAS No. 110-44-1) and its salts, e.g. calcium sorbate, sodium sorbate
Potassium (E,E)-hexa-2,4-dienoate (Potassium Sorbate, CAS No. 24634-61-5);
Hydrogen peroxide (CAS No. 7722-84-1);
Lactic acid and its salts;
L-(+)-lactic acid (CAS No. 79-33-4);
2-methyl-1,2-benzothiazol-3(2H)-one (MBIT, CAS No. 2527-66-4);
Methenamine 3-chloroallylochloide (CTAC, CAS No. 4080-31-3);
Monochloramine generated from ammonium carbamate and a chlorine source
N,N′-methylenebismorpholine (MBM, CAS No. 5625-90-1);
N-(3-aminopropyl)-N-dodecylpropane-1,3-diamine (Diamine, CAS No. 2372-82-9);
N-(trichloromethylthio)phthalimide (Folpet, CAS No. 133-07-3);
p-[(diiodomethyl)sulphonyl]toluene (CAS No. 20018-09-1);
Peracetic acid (CAS No. 79-21-0);
polyhexamethylene biguanide hydrochloride (PHMB, CAS No 1802181-67-4), polyhexamethylene biguanide hydrochloride (PHMB, CAS No. 27083-27-8), e.g. poly(iminoimidocarbonyl)-iminohexamethylene hydrochloride, poly(iminocarbonimidoyliminocarbonimidoylimino-1,6-hexanediyl), polyaminopropyl biguanide;
Pyridine-2-thiol 1-oxide, sodium salt (Sodium pyrithione, CAS No. 3811-73-2);
Pyrithione zinc (Zinc pyrithione, CAS No. 13463-41-7);
Reaction mass of titanium dioxide and silver chloride, silver chloride (CAS No. 7783-90-6);
Sodium Azide (CAS No. 26628-22-8);
Tetrahydro-1,3,4,6-tetrakis(hydroxymethyl)imidazo[4,5-d]imidazole-2,5 (1H,3H)-dione (TMAD, CAS No 5395-50-6);
Tetrakis(hydroxymethyl)phosphonium sulphate (2:1) (THPS, CAS No. 55566-30-8);
Salts of benzoic acid e.g. ammonium benzoate, calcium benzoate, magnesium benzoate, MEA-benzoate, potassium benzoate;
Esters of benzoic acid, e.g. butyl benzoate, ethyl benzoate, isobutyl benzoate, isopropyl benzoate, methyl benzoate, phenyl benzoate, propyl benzoate;
Benzoic acid and its sodium salt (CAS No 65-85-0, CAS No. 532-32-1);
Propionic acid and its salts, e.g. ammonium propionate, calcium propionate, magnesium propionate, potassium propionate, sodium propionate;
Salicylic acid and its salts, e.g. calcium salicylate, magnesium salicylate, MEA salicylate, sodium salicylate, potassium salicylate, TEA salicylate;
Inorganic sulphites and hydrogensulphites, e.g. sodium sulfite, ammonium sulfite, ammonium bisulfite, potassium sulfite, potassium hydrogene sulfite, sodium bisulfite, sodium metasulfite, potassium metasulfite, potassium metabisulfite;
Chlorobutanol (CAS No 57-15-8);
Butyl 4-hydroxybenzoate and its salts e.g. butylparaben, sodium butyl paraben, potassium butyl paraben;
Propyl 4-hydroxybenzoate and its salts, e.g. propyl paraben, sodium propyl paraben, potassium propyl paraben;
Isopropyl-4-hydroxybenzoic acid and its salts and esters;
Isobutyl-4-hydroxybenzoic acid and its salts and esters;
Benzyl-4-hydroxybenzoic acid and its salts and esters;
Pentyl-4-hydroxybenzoic acid and its salts and esters;
4-Hydroxybenzoic acid and its salts and esters, e.g. methyl paraben, ethyl paraben, potassium ethyl paraben, potassium paraben, potassium methyl paraben, sodium methyl paraben, sodium ethyl paraben, sodium paraben, calcium paraben, calcium methyl paraben, calcium ethyl paraben;
3-Acetyl-6-methylpyran-2,4(3H)-dione and its salts, e.g. dehydroacetic acid, sodium dehydroacetic acid (Cas Nos 520-45-6, 4418-26-2, 16807-48-0);
3,3′-Dibromo-4,4′-hexamethylenedioxydibenzamidine and its salts (including isethionate), e.g. dibromohexamidine isethionate (CAS No. 93856-83-8);
Thiomersal (CAS No 54-64-8);
Phenylmercuric salts (including borate), e.g. phenyl mercuric acetate, phenyl mercuric benzoate (CAS Nos. 62-38-4 and 94-43-9);
Undec-10-enoic acid and its salts, e.g. undecylenic acid, potassium undecylenic acid, sodium undecylenic acid, calcium undecylenic acid, MEA-undecylenic acid, TEA-undecylenic acid;
5-Pyrimidinamine, 1,3-bis(2-ethylhexyl)hexahydro-5-methyl-, e.g. hexetidine (CAS No. 141-94-6);
1-(4-Chlorophenyl)-3-(3,4-dichlorophenyl)urea, e.g. triclocarban (CAS No 101-20-2);
Chlorocresol, e,g, p-chloro-m-cresol (CAS No. 59-50-7);
Chloroxylenol (CAS Nos 88-04-0, 1321-23-9);
N,N″-Methylenebis[N′-[3-(hydroxymethyl)-2,5-dioxoimidazolidin-4-yl]urea], synonym: imidazolidinyl urea (CAS No. 39236-46-9);
Methenamine (CAS No. 100-97-0);
Methenamine 3-chloroallylochloride, synonym: Quaternium 15 (CAS No 4080-31-3), 1-(4-Chlorophenoxy)-(imidazol-1-yl)-3,3-dimethylbutan-2-one, synonym: Climbazole (CAS No 38083-17-9);
1,3-Bis(hydroxymethyl)-5,5-dimethylimidazolidine-2,4-dione, synonym: DMDM hydantoin (CAS No 6440-58-0);
1-Hydroxy-4-methyl-6-(2,4,4-trimethylpentyl)-2 pyridon and its monoethanolamine salt, e.g. 1-hydroxy-4-methyl-6-(2,4,4-timethylpentenyl)-2-pyridon, piroctone olamine (CAS Nos 50650-76-5, 68890-66-4);
2,2′-Methylenebis(6-bromo-4-chlorophenol), synonym: bromochorophene (CAS No 15435-29-7);
4-Isopropyl-m-cresol, synonym: o-cymen-5-ol (CAS No 3228-02-2);
2-Benzyl-4-chlorophenol, synonym: chlorophene (CAS No 120-32-1);
2-Chloroacetamide (CAS No 79-07-2);
N,N′-bis(4-chlorophenyl)-3,12-diimino-2,4,11,13-tetraazatetradecanediamidine and its digluconate, diacetate and dihydrochloride, e.g. chlorohexidine, chlorhexidine digluconate, chlorohexidine diacetate, chlorhexidine dihydrochloride (CAS Nos 55-56-1, 56-95-1, 18472-51-0, 3697-42-5);
Alkyl (C₁₂-C₂₂) trimethyl ammonium bromide and chloride, e.g. behentrimonium chloriode, cetrimonium bromide, cetrimonium chloride, laurtrimonium bromide, laurtrimonium chloride, steartrimonium bromide, steartrimonium chloride (CAS Nos 17301-53-0, 57-09-0, 112-02-7, 1119-94-4, 112-00-5, 1120-02-1, 112-03-8);
4,4-Dimethyl-1,3-oxazolidine (CAS No 51200-87-4);
N-(Hydroxymethyl)-N-(dihydroxymethyl-1,3-dioxo-2,5-imidazolidinyl-4)-N′-(hydroxymethyl)urea, synonym: diazolidinyl urea (CAS No 78491-02-8);
Benzenecarboximidamide, 4,4′-(1,6-hexanediylbis(oxy))bis-, and its salts (including isothionate and p-hydroxybenzoate), e.g. hexamidine, hexamidine diisethionate, hexamidine paraben (CAS Nos 3811-75-4, 659-40-5, 93841-83-9);
5-Ethyl-3,7-dioxa-1-azabicyclo[3.3.0] octane, synonym: 7-ethylbicyclooxazolidine (CAS No 7747-35-5);
3-(p-Chlorophenoxy)-propane-1,2-diol, synonym: chlorophenesin (CAS No 104-29-0); Sodium hydroxymethylamino acetate, synonym: sodium N-(hydroxymethyl)glycinate, sodium hydroxymethylglycinate (CAS No 70161-44-3);
Benzenemethanaminium, N,N-dimethyl-N-[2-[2-[4-(1,1,3,3,-tetramethylbutyl)phenoxy]ethoxy]-ethyl]-, chloride, synonym: benzethonium chloride CAS No 121-54-0);
Benzalkonium chloride, bromide and saccharinate, e.g. benzalkonium chloride, benzalkonium bromide, benzalkonium saccharinate (CAS Nos 8001-54-5, 63449-41-2, 91080-29-4, 68989-01-5, 68424-85-1, 68391-01-5, 61789-71-7, 85409-22-9);
Methanol, (phenylmethoxy), synonym: benzylhemiformal (CAS No 14548-60-8);
3-Iodo-2-propynylbutylcarbamate (IPBC, CAS No 55406-53-6)
Ethyl Lauroyl Arginate HCl (CAS No 60372-77-2);
1,2,3-Propanetricarboxylic acid, 2-hydroxy-, monohydrate and 1,2,3-Propanetricarboxylic acid,
2-hydroxy-silver(1+) salt, monohydrate, INCI: citric acid (and) silver citrate;
Tetrahydro-3,5-dimethyl-1,3,5-thiadia-zine-2-thione (further names: 3,5-dimethyl-1,3-5-thiadiazinane-2-thione, Protectol® DZ, Protectol® DZ P, Dazomet, CAS No. 533-74-4);
2,4-dichlorobenzyl alcohol (CAS-No. 1777-82-8, further names: dichlorobenzyl alcohol, 2,4-dichloro-benzenemethanol, (2,4-dichloro-phenyl)-methanol, DCBA, Protectol® DA);
1-propanol (CAS-No. 71-23-8, further names: n-propanol, propan-1-ol, n-propyl alcohol, Protectol® NP S);
5-bromo-5-nitro-1,3-dioxane (CAS-No. 30007-47-7, further names: 5-bromo-5-nitro-m-dioxane, Bronidox®);
2-bromo-2-nitropropane-1,3-diol (CAS-No. 52-51-7, further names: 2-bromo-2-nitro-1,3-propanediol, Bronopol®, Protectol® BN, Myacide AS);
Glutaraldehyde (CAS-No. 111-30-8, further names: 1-5-pentandial, pentane-1,5-dial, glutaral, glutardialdehyde, Protectol® GA, Protectol GA 50, Myacide® GA);
Glyoxal (CAS No. 107-22-2; further names: ethandial, oxylaldehyde, 1,2-ethandial, Protectol® GL);
2,4,4′-trichloro-2′-hydroxydiphenyl ether (CAS No. 3380-34-5, further names: triciosan, Irgasan® DP 300, Irgacare® MP, TCS);
4,4′-dichloro 2-hydroxydiphenyl ether (CAS-No. 3380-30-1), further names: 5-chloro-2-(4-chlorophenoxy) phenol, Diclosan, DCPP, which is commercially available as a solution of 30 wt % of 4,4′-dichloro 2-hydroxydiphenyl ether in 1,2 propyleneglycol under the trade name Tinosan® HP 100;
2-Phenoxyethanol (CAS-no. 122-99-6, further names: Phenoxyethanol, Methylphenylglycol, Phenoxetol, ethylene glycol phenyl ether, Ethylene glycol monophenyl ether, Protectol® PE);
Phenoxypropanol (CAS-No. 770-35-4, CAS No 4169-04-4, propylene glycol phenyl ether, phenoxyisopropanol 1-phenoxy-2-propanol, 2-phenoxy-1-propanol);
Glucoprotamine (CAS-No. 164907-72-6, chemical description: reaction product of glutamic acid and alkylpropylenediamine, further names: Glucoprotamine 50);
Cyclohexyl hydroxyl diazenium-1-oxide, potassium salt (CAS No. 66603-10-9, further names: N-cyclohexyl-diazenium dioxide, Potassium HDO, Xyligene, Protectol® KD);
Formic acid (CAS-No. 64-18-6, further names: methanoic acid, Protectol® FM, Protectol FM 75, Protectol® FM 85, Protectol FM 99, Lutensol® FM) and its salts, e.g. sodium formiate (CAS No 141-53-7);
Performic acid and its salts;
anorganic silver complexes such as silver zeolites and silver glass compounds (e.g. Irgaguard® B5000, Irgaguard® B6000, Irgaguard® B7000) and others described in WO-A-99/18790, EP1041879B1;
1,3,5-Tris-(2-hydroxyethyl)-hexahydro-1,3,5-triazin (CAS-No. 4719-04-4, further names: Hexyhydrotriazine, Tis(hydroethyl)-hexyhydrotrazin, hexyhydro-1,3-5-tris(2-hydroxyethyl)-s-triazine, 2,2′,2″-(hexahydro-1,3,5-triazine-1,3,5-triyl)triethanol, Protectol® HT);

In one embodiment, an enzyme preparations of the invention comprise at least one preservative selected from the group consisting of 2-phenoxyethanol, glutaraldehyde, 2-bromo-2-nitropropane-1,3-diol, and formic acid in acid form or as its salt, and 4,4′-dichloro 2-hydroxydiphenylether.

The enzyme preparations of the invention in one embodiment comprise at least one preservative in amounts ranging from 2 ppm to 5% by weight relative to the total weight of the enzyme preparation.

The enzyme preparations of the invention may comprise phenoxyethanol in amounts ranging from 0.1% to 2% by weight relative to the total weight of the enzyme preparation. The enzyme preparations of the invention may comprise 2-bromo-2-nitropropane-1,3-diol in amounts ranging from 20 ppm to 1000 ppm. The enzyme preparations of the invention may comprise glutaraldehyde in amounts ranging from 10 ppm to 2000 ppm. The enzyme preparations of the invention may comprise formic acid and/or formic acid salt in amounts ranging from 0.05% to 0.5% by weight relative to the total weight of the enzyme preparation. The enzyme preparations of the invention may comprise 4,4′-dichloro 2-hydroxydiphenylether in amounts ranging from 0.001% to 3% by weight, 0.002% to 1% by weight, or 0.01% to 0.6% by weight, all relative to the total weight of the enzyme preparation.

In a preferred embodiment, the enzyme preparations of the invention comprise
component (a): at least one enzyme selected from the group of subtilisin type proteases (EC 3.4.21.62), preferably a protease 80% identical to SEQ ID NO:22 as described in EP 1921147 having R101E optionally in combination with at least one further enzyme, preferably selected from the group of alpha-amylases; and
component (b): an enzyme-stabilizing system comprising at least one compound according to general formula (A)

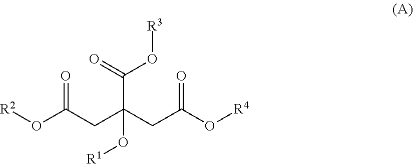

wherein the variables in formula (A) are as follows:
R¹ is selected from H and C₁-C₁₀ alkylcarbonyl, wherein alkyl may be linear or branched and may bear one or more hydroxyl groups,
R², R³, R⁴ are independently from each other selected from H, linear C₁-C₅ alkyl, and branched C₃-C₁₀ alkyl, C₆-C₁₀-aryl, non-substituted or substituted with one or more carboxylate or hydroxyl groups, and C₆-C₁₀-aryl-alkyl, wherein alkyl of the latter is selected from linear C₁-C₈ alkyl or branched C₃-C₈ alkyl, wherein at least one of R², R³, and R⁴ is not H;
and
at least one compound selected from peptide stabilizers selected from compounds according to formula (Db), wherein
R¹ and R² is a group such that NH—CHR¹—CO and NH—CHR²—CO each is an L or D-amino acid residue selected from Ala, Cys, Gly, Pro, Ser, Thr, Val, Nva or Nle, and R³ is a group such that NH—CHR³—CO is an L or D-amino acid residue selected from Tyr, m-tyrosine, 3,4-dihydroxyphe-nylalanine, Phe, Val, Ala, Met, Nva, Leu, Ile or Nle; and the N-terminal protection group Z is selected from benzyloxycarbonyl (Cbz), p-methoxybenzyl carbonyl (MOZ), benzyl (Bn), benzoyl (Bz), p-methoxybenzyl (PMB), p-methoxyphenyl (PMP), formyl, acetyl (Ac), methyloxy, alkoxycarbonyl, methoxycarbonyl, fluorenylmethyloxycarbonyl (Fmoc), or tert-butyloxycarbonyl (Boc).
and
component (c): one or more diols, preferably selected from
   diol having vicinally positioned —OH groups containing 4 to 5 C-atoms, and
   diol having terminal —OH groups containing 4 to 8 C-atoms
and
component (d): at least one compound selected from (i) solvents, and (ii) compounds stabilizing the liquid enzyme preparation as such.

Preferably, component (d) comprises at least one solvent as disclosed above.

In one embodiment, component (d) is free of preservatives.

Process of Making Enzyme Preparation:

The invention relates to a process for making an enzyme preparation, said process comprising the step of mixing in one or more steps at least component (a) as disclosed above, component (b) as disclosed above, and component (c) as disclosed above, and optionally component (d) as disclosed above. Preferably, mixing in one or more steps is made in any order.

In one embodiment, the invention relates to a process for making an enzyme preparation, said process comprising the step of mixing components (a), (b), and (c) as disclosed above, wherein component (a) preferably comprises at least one protease; and optionally at least one enzyme selected from the group of amylases, lipases, cellulases, and mannanases—all as disclosed above.

At least one protease is preferably selected from subtilisin proteases as disclosed above, more preferably from
proteases according to SEQ ID NO:22 as described in EP 1921147 or variants thereof having proteolytic activity, preferably a protease 80% similar and/or identical to SEQ ID NO:22 as described in EP 1921147 having R101E, and
subtilisin 309 as disclosed in Table I a) of WO 89/06279 or variants thereof having proteolytic activity.

At least one amylase is preferably selected from the group of alpha-amylases (EC 3.2.1.1) as disclosed above, more preferably at least one amylase is selected from
amylase from Bacillus sp. 707 or variants thereof having amylolytic activity, preferably selected from amylases having SEQ ID NO:6 as disclosed in WO 99/19467 and variants thereof having amylolytic activity;
amylase selected from those comprising amino acids 1 to 485 of SEQ ID NO:2 as described in WO 00/60060 those having SEQ ID NO: 12 as described in WO 2006/002643, and variants thereof having amylolytic activity;
amylase from Bacillus halmapalus or variants thereof having amylolytic activity, preferably selected from amylases having SEQ ID NO: 1 and 2 as disclosed in WO 2013/001078; having SEQ ID NO:6 as described in WO 2011/098531; and variants thereof having amylolytic activity;
amylase from Bacillus amyloliquefaciens or variants thereof having amylolytic activity, preferably selected from amylases according to SEQ ID NO: 3 of WO 2016/092009;
hybrid amylases according to WO 2014/183920 with A and B domains having at least 90% identity to SEQ ID NO:2 of WO 2014/183920 and a C domain having at least 90% identity to SEQ ID NO:6 of WO 2014/183920, wherein the hybrid amylase has amylolytic activity; preferably the hybrid alpha-amylase is at least 95% identical to SEQ ID NO: 23 of WO 2014/183920 and having amylolytic activity;
hybrid amylase according to WO 2014/183921 with A and B domains having at least 75% identity to SEQ ID NO: 2, SEQ ID NO: 15, SEQ ID NO: 20, SEQ ID NO: 23, SEQ ID NO: 29, SEQ ID NO: 26, SEQ ID NO: 32, and SEQ ID NO: 39 as disclosed in WO 2014/183921 and a C domain having at least 90% identity to SEQ ID NO: 6 of WO 2014/183921, wherein the hybrid amylase has amylolytic activity; preferably, the hybrid alpha-amylase is at least 95% identical to SEQ ID NO: 30 as disclosed in WO 2014/183921 and having amylolytic activity.

In one embodiment, component (a) comprises at least one protease and at least one amylase, both as disclosed above.

Component (b) comprises component (bi) and (bii) as disclosed above.

Component (bi) and (bii) in one embodiment are added to component (a) together or separately from each other.

Component (a) in one embodiment is liquid, wherein at least one enzyme may be comprised in a liquid enzyme concentrate as disclosed above. Liquid component (a) may be supplemented with component (bii) prior or after its supplementation with component (bi).

Liquid component (a) may be supplemented with component (bi), wherein component (bi) dissolves at least partly in liquid component (a). In one embodiment, liquid component (a) is preferably resulting from fermentation. Preferably, component (bi) is dissolved in its entirety after addition of component (c) prior or after addition to component (a).

In one embodiment, the process of making the enzyme preparations of the invention comprises at least the steps of
(1) mixing component (bi) and/or component (bii) with component (c) and
(2) adding component (a).

In one embodiment, the process of making the enzyme preparations of the invention comprise at least the steps of
(1) mixing component (bi) and/or component (bii) with component (d),
(2) adding component (c) and
(3) adding component (a) is added.

Component (bi) and/or (bii) may be solid. Solid component (bi) and/or (bii) may be added to solid component (a) prior to contact with component (c). Contact with component (c) preferably results in solubilization of at least one molecule component (bi) and/or at least one molecule component (bii) and/or at least one molecule of component (a), resulting in stabilization of at least one molecule component (a).

In one embodiment, the enzyme preparations resulting are homogenous and storage-stable fulfilling the criteria as disclosed herein.

In one aspect, the invention relates to the use of at least one diol selected from diols having terminal —OH groups containing 3 to 10 C-atoms to improve
enzyme stability of at least one hydrolase and/or
enzyme preparation stability
   in the presence of a compound according to according to general formula (A)

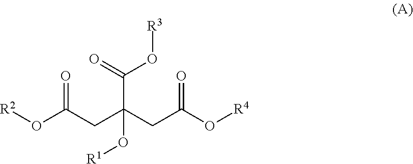

wherein the variables in formula (A) are as follows:
R¹ is selected from H and C₁-C₁₀ alkylcarbonyl, wherein alkyl may be linear or branched and may bear one or more hydroxyl groups,
R², R³, R⁴ are independently from each other selected from H, linear C₁-C₅ alkyl, and branched C₃-C₁₀ alkyl, C₆-C₁₀-aryl, non-substituted or substituted with one or more carboxylate or hydroxyl groups, and C₆-C₁₀-aryl-alkyl, wherein alkyl of the latter is selected from linear C₁-C₈ alkyl or branched C₃-C₈ alkyl, wherein at least one of R², R³, and R⁴ is not H.

Preferably, the hydrolase-stability is improved in the presence of a compound according to formula (A) and an enzyme stabilizer selected from boron-containing compounds and peptide stabilizers. The hydrolase-stability is preferably improved in liquid enzyme preparations and/or liquid detergent formulations. “Improved hydrolase stability” preferably relates to an improvement when compared to a hydrolase in the absence of component (c).

“Enzyme preparation stability” preferably relates to homogenous, storage-stable enzyme preparations fulfilling the criteria as disclosed herein.

“Improved enzyme preparation stability” preferably relates to an improvement when compared to an enzyme preparation lacking component (c).

In one aspect, the invention relates to the use of component (c) to provide homogenous and storage-stable enzyme preparations comprising at least components (a) and (b).

The enzyme preparations of the invention are homogenous at a temperature of about 8° C., about 20° C. or about 37° C., and normal pressure of about 101.3 kPa. Homogenous means that the enzyme preparation does not show visible precipitate formation or turbidity.

The enzyme preparations of the invention are storage-stable at a temperature of about 8° C., about 20° C. or about 37° C. for up to 6 weeks. Storage-stable in this context means that the liquid enzyme preparation does not show visible precipitate formation or turbidity after storage of the liquid enzyme preparation, preferably after up to 6 or 8 weeks of storage at 8° C. or 37° C. Preferably, the liquid enzyme preparation is storage-stable at storage between 8° C. and 37° C. for up to 6 months.

Detergent Formulations

The invention in one aspect relates to the use of the liquid enzyme preparation of the invention to be formulated into detergent formulations such as I&I and homecare formulations for laundry and hard surface cleaning, wherein at least components (a) and (b) are mixed in no specified order in one or more steps with one or more detergent components. In one embodiment, at least components (a), (b) and (c) as disclosed above are mixed in no specified order in one or more steps with one or more detergent components.

In one aspect of the invention relates to detergent formulations comprising the liquid enzyme preparations of the invention and one or more detergent components. The addition of the enzyme preparations of the invention to detergent formulations, preferably liquid detergent formulations, usually occurs in a weight ratio enzyme preparation:detergent formulation of about 1:1000, 1:500, 1:100, 1:50, 1:30, 1:25, 1:20, or 1:10.

Liquid detergent formulations of the invention therefore comprise different amounts of components (a), (b) and (c) of the liquid compositions, for example those listed in the table below (by weight means relative to the total weight of the liquid detergent):

| | Component (b) | | |
|---|---|---|---|
| Component (a) | (bi) | (bii) | Component (c) |
| % by weight | % by weight | % by weight | % by weight |
| 0.004-0.0065 | 0.012-0.030 | 0.0001-0.0005 | 0.01-0.035 |
| 0.008-0.013 | 0.024-0.06 | 0.0002-0.001 | 0.02-0.07 |
| 0.04-0.065 | 0.12-0.30 | 0.001-0.005 | 0.1-0.35 |
| 0.08-0.13 | 0.24-0.6 | 0.002-0.01 | 0.2-0.7 |
| 0.13-0.22 | 0.4-1.0 | 0.003-0.02 | 0.3-1.2 |
| 0.16-0.26 | 0.1-1.2 | 0.004-0.02 | 0.4-1.4 |
| 0.2-0.325 | 0.6-1.5 | 0.005-0.015 | 0.5-1.8 |
| 0.4-0.065 | 1.2-3.0 | 0.01-0.05 | 1-3.5 |

Component (a) in the table above preferably comprises at least one subtilisin protease as disclosed herein. Component (c) in one embodiment comprises a mixture of at least one diol having terminally positioned —OH and at least one diols having vicinally positioned —OH as disclosed above, the latter preferably selected from 1,2-butan diol and 1,2-pentandiol, wherein the weight ratio of one diol having terminally positioned —OH to the diol having vicinally positioned —OH is 10:1, 9:1, 8:1, 7:1, or 6:1, preferably within the range of 6:1 to 8:1, more preferably within the range of 7:1 to 6:1, most preferably 6.75:1.

In one aspect, the invention relates to detergent formulations comprising components (a) and (b) and (c) and optionally (d) as disclosed above and one or more detergent components. In one embodiment, the detergent formulation of the invention comprises at least one enzyme (component (a)) selected from the group of serine proteases (EC 3.4.21), triacylglycerol lipase (EC 3.1.1.3), alpha amylases (EC 3.2.1.1), endoglucanases (EC 3.2.1.4), endo-1,4-β-mannosidase (EC 3.2.1.78), and DNA degrading enzymes.

The invention relates to a method for preparation of detergent formulations according to the invention, wherein components (a) and (b) and (c) and optionally (d) as disclosed above, and at least one detergent component are mixed in one or more steps in any order.

“Detergent formulation” or “cleaning formulation” herein means formulations designated for cleaning soiled material. Cleaning may mean laundering or hard surface cleaning. Soiled material according to the invention includes textiles and/or hard surfaces.

The term “laundering” relates to both household laundering and industrial laundering and means the process of treating textiles with a solution comprising a detergent formulation of the present invention. The laundering process may be carried out by using technical devices such as a household or an industrial washing machine. Alternatively, the laundering process may be done by hand.

The term “textile” means any textile material Including yarns (thread made of natural or synthetic fibers used for knitting or weaving), yarn intermediates, fibers, non-woven materials, natural materials, synthetic materials, as well as fabrics (a textile made by weaving, knitting or felting fibers) made of these materials such as garments (any article of clothing made of textile), cloths and other articles.

The term “fibers” includes natural fibers, synthetic fibers, and mixtures thereof. Examples of natural fibers are of plant (such as flax, jute and cotton) or animal origin, comprising proteins like collagen, keratin and fibroin (e.g. silk, sheeps wool, angora, mohair, cashmere). Examples for fibers of synthetic origin are polyurethane fibers such as Spandex® or Lycra®, polyester fibers, polyolefins such as elastofin, or polyamide fibers such as nylon. Fibers may be single fibers or parts of textiles such as knitwear, wovens, or nonwovens.

The term “hard surface cleaning” Is defined herein as cleaning of hard surfaces wherein hard surfaces may include any hard surfaces in the household, such as floors, furnishing, walls, sanitary ceramics, glass, metallic surfaces including cutlery or dishes. The term “hard surface cleaning” may therefore may mean “dish washing” which refers to all forms of washing dishes, e.g. by hand or automatic dish wash (ADW). Dish washing includes, but is not limited to, the cleaning of all forms of crockery such as plates, cups, glasses, bowls, all forms of cutlery such as spoons, knives, forks and serving utensils as well as ceramics, plastics such as melamine, metals, china, glass and acrylics.

The inventive washing and/or cleaning process is being carried out at temperatures in the range of from 10 to 90° C. In embodiments wherein the inventive cleaning process is carried out as a laundering process, it is preferably carried out at a temperature in the range of from 10 to 60° C., more preferably 20 to 40° C. In embodiments wherein the inventive cleaning process is carried out as an automatic dishwashing process, it is preferably carried out at a temperature in the range of from 45 to 65° C., more preferably 50 to 60° C. Said temperatures refer to the temperature of the water being used in the inventive process.

Detergent components vary in type and/or amount in a detergent formulation depending on the desired application such as laundering white textiles, colored textiles, and wool. The component(s) chosen further depend on physical form of a detergent formulation (liquid, solid, gel, provided in pouches or as a tablet, etc). The component(s) chosen e.g. for laundering formulations further depend on regional conventions which themselves are related to aspects like washing temperatures used, mechanics of laundry machine (vertical vs. horizontal axis machines), water consumption per wash cycle etc. and geographical characteristics like average hardness of water.

Individual detergent components and usage in detergent formulations are known to those skilled in the art. Suitable detergent components comprise inter alia surfactants, builders, polymers, alkaline, bleaching systems, fluorescent whitening agents, suds suppressors and stabilizers, hydrotropes, and corrosion inhibitors. Further examples are described e.g. In “complete Technology Book on Detergents with Formulations (Detergent Cake, Dishwashing Detergents, Liquid & Paste Detergents, Enzyme Detergents. Cleaning Powder & Spray Dried Washing Powder)”.

Engineers India Research Institute (EIRI), 6^{th} edition (2015). Another reference book for those skilled in the art may be “Detergent Formulations Encyclopedia”, Solverchem Publications, 2016.

It is understood that the detergent components are in addition to the components comprised in the enzyme preparations of the invention. If a component comprised in the enzyme preparations of the invention is also a detergent component, it might be the concentrations that need to be adjusted that the component is effective for the purpose desired in the detergent formulation.

The total weight of at least one organic solvent comprised in component (d) as disclosed above, preferably selected from 1,2-propane diol and MPEG in liquid detergent formulations, preferably those comprised in a container made of water-soluble polymeric film, may be added up to a total weight of 35% by weight, relative to the total weight of the detergent formulation. “Added up” in this context means that additionally to the organic solvent that is added to the detergent formulation by adding the enzyme preparation of the invention, the total content of said organic solvent is added up to 30% by weight, up to 25% by weight, up to 20% by weight, up to 15% by weight, up to 10% by weight, up to 8% by weight, up to 7% by weight, or up to 6% by weight. The total amount of said organic solvent in liquid detergent formulations preferably ranges from about 0.05% to 30% by weight, about 0.5% to 20% by weight, about 1% to 10% by weight, from about 2% to 8% by weight, from about 3% to 7% by weight, or from about 4% to 6% by weight, all relative to the total weight of the liquid detergent formulation.

Detergent components may have more than one function in the final application of a detergent formulation, therefore any detergent component mentioned in the context of a specific function herein, may also have another function in the final application of a detergent formulation. The function of a specific detergent component in the final application of a detergent formulation usually depends on its amount within the detergent formulation, i.e. the effective amount of a detergent component.

The term “effective amount” includes amounts of individual components to provide effective stain removal and/or effective cleaning conditions (e.g. pH, quantity of foaming), amounts of certain components to effectively provide optical benefits (e.g. optical brightening, dye transfer inhibition), and/or amounts of certain components to effectively aid the processing (maintain physical characteristics during processing, storage and use; e.g. viscosity modifiers, hydrotropes, desiccants).

In one embodiment, a detergent formulation is a formulation of more than two detergent components, wherein at least one component is effective in stain-removal, at least one component is effective in providing the optimal cleaning conditions, and at least one component is effective in maintaining the physical characteristics of the detergent.

Detergent formulations of the invention comprising component (a) and component (b) and component (c) and optionally component (d), wherein component (a) and component (b) and component (c) and optionally component (d) in one embodiment are part of a liquid formulation which is physically isolated from detergent components.

In an embodiment the physical isolation occurs by using multi-compartment containers, preferably multi-compartment pouches. Such pouches may be formed by water-soluble polymeric films. Pouches can be of any form, shape and material which is suitable for holding a formulation, e.g., without allowing the release of said formulation from the pouch prior to water contact. The pouches may comprise a solid formulation and/or a liquid formulation in different compartments. The compartment for liquid components can be different in formulation than compartments containing solids (see e.g. EP 2014756).

In another embodiment physical isolation occurs by microencapsulation. The aim of microencapsulation is, at the one hand, the isolation of the liquid core formulation from its surrounding, and, on the other hand, release of the core formulation at the time of use (the liquid core formulation must be released timely). Capsule contents may be released by melting the wall, or dissolving it under particular conditions. In other systems, the wall is broken by solvent action, enzyme attack, chemical reaction, hydrolysis, or slow disintegration. Most prominently, the limiting factor for suitability in detergent formulations is a rapid release of the core formulation at the time when a detergent formulation is diluted in water but ensuring non-release of the core formulation during storage in detergent formulations. Microcapsules may be dispersed in liquid formulations with optional stabilization of such dispersions by means such as rheology modification through addition of thickeners. Stabilization of dispersions may be achieved by supplementation with dispersing agents. Formulation may mean that such dispersions are stabilized against microbial growth by the addition of preservatives. Microencapsulated liquid formulations may be part of a solid detergent formulation after drying of the microcapsules.

In one embodiment, the detergent formulations of the invention is liquid at 20C and 101.3 kPa. The liquid detergent formulation may comprise water or may be essentially free of water, the latter meaning that no significant amounts of water are present. Non-significant amounts of water herein means, that the liquid detergent formulation comprises less than 15%, less than 10%, less than 7%, less than 5%, less than 4%, less than 3%, less than 2% by weight water, all relative to the total weight of the liquid detergent formulation, or no water. In one embodiment, liquid detergent formulations free of water means that the liquid detergent formulation does not comprise significant amounts of water but does comprise organic solvents in amounts of 30-80% by weight, relative to the total weight of the detergent formulation. Solvent in this context means any compound as disclosed as solvent according to component (d).

Water-comprising liquid detergent formulations may comprise essentially water as solvent. “Essentially water as solvent” means that organic solvents have only been introduced into the detergent formulation by individual components such as the enzyme preparations according to the invention.

In embodiments, mixtures of water with one or more water-miscible solvents are used as aqueous medium. The term water-miscible solvent refers to organic solvents that are miscible with water at ambient temperature without phase-separation. Examples are ethylene glycol, 1,2-propylene glycol, isopropanol, and diethylene glycol. Preferably, at least 50% by volume of the respective aqueous medium is water, referring to the solvent. In one embodiment, the detergent formulation of the invention comprises about 1-10% by weight or about 5% by weight relative to the total weight of the detergent formulation of an organic solvent selected from glycerol (1,2,3-propanetriol) and 1,2-propane diol.

Detergent formulations of the invention comprise at least one compound selected from surfactants, builders, polymers, fragrances and dyestuffs.

The detergent formulations of the invention comprise at least one surfactant selected from non-ionic surfactants, amphoteric surfactants, anionic surfactants, and cationic surfactants.

The detergent formulations in one embodiment comprise 0.1 to 60% by weight relative to the total weight of the detergent formulation of surfactant. The detergent formulations preferably comprise at least one compound selected from anionic surfactants, non-ionic surfactants, amphoteric surfactants, and amine oxide surfactants as well as combinations of at least two of the foregoing. In one embodiment, the detergent formulations of the invention comprise 5 to 30% by weight of anionic surfactant and at least one non-ionic surfactant, for example in the range of from 3 to 20% by weight, all relative to the total weight of the detergent formulation, wherein the detergent formulation is preferably liquid.

Non-ionic surfactant means a surfactant that contains neither positively nor negatively charged (i.e. ionic) functional groups. In contrast to anionic and cationic surfactants, non-ionic surfactants do not ionize in solution. At least one non-ionic surfactant in one embodiment is selected from alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Non-ionic surfactants may be compounds of the general formulae (Ia) and (Ib):

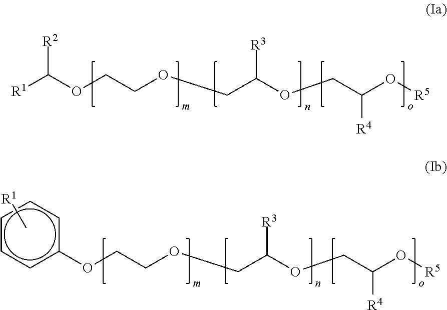

R¹ is selected from C₁-C₂₃ alkyl and C₂-C₂₃ alkenyl, wherein alkyl and/or alkenyl are linear (straight-chain; n-) or branched; examples are n-C₇H₁₅, n-C₉H₁₉, n-C₁₁H₂₃, n-C₁₃H₂₇, n-C₁₅H₃₁, n-C₁₇H₃₅, i-C₉H₁₉, i-C₁₂H₂₅.
R² is selected from H, C₁-C₂₀ alkyl and C₂-C₂₀ alkenyl, wherein alkyl and/or alkenyl are linear (straight-chain; n-) or branched.
R³ and R⁴, each independently selected from C₁-C₁₆ alkyl, wherein alkyl is linear (straight-chain; n-) or branched; examples are methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, isodecyl.
R⁵ is selected from H and C₁-C₁a alkyl, wherein alkyl is linear (straight-chain; n-) or branched.

The integers of the general formulae (Ia) and (Ib) are defined as follows:
m is in the range of zero to 200, preferably 1-80, more preferably 3-20; n and o, each independently in the range of zero to 100; n preferably is in the range of 1 to 10, more preferably 1 to 6; o preferably is in the range of 1 to 50, more preferably 4 to 25. The sum of m, n and o is at least one, preferably the sum of m, n and o is in the range of 5 to 100, more preferably in the range of from 9 to 50.

Compounds according to formula (Ia) may be called alkyl polyethyleneglycol ether (AEO) herein. Compounds according to formula (Ib) may be called alkylphenol polyethyleneglycol ether (APEO) herein.

The detergent formulations in one embodiment comprise at least one non-ionic surfactant selected from compounds of general formula (Ia), wherein said non-ionic surfactant is characterized in R¹ being n-C₁₃H₂₇, R² and R⁵ being H, m being 3-20, n and o=0.

The detergent formulations in one embodiment comprise at least one non-ionic surfactant selected from compounds of general formula (Ia), wherein said non-ionic surfactant is characterized in R¹ being linear or branched C₁₀ alkyl, R² and R⁵ being H, m being 3-14, n and o=0.

The detergent formulations in one embodiment comprise at least two non-ionic surfactants, selected from compounds of general formula (Ia), wherein one of said non-ionic surfactants is characterized in R¹ being n-C₁₅H₃₁, R² and R⁵ being H, m being 11-80, n and o=0, and the other surfactant is characterized in R¹ being n-C₁₇H₃₅, R² and R⁵ being H, m being 11-80, n and o=0.

In one embodiment, the detergent formulation comprises at least one non-ionic surfactant selected from general formula (Ia), wherein m is in the range of 3 to 11, preferably not more than 10, more preferably not more than 7; n and o is 0, R¹ is linear C₉-C₁₇ alkyl, R² and R⁵ is H.

The detergent formulations in one embodiment comprise at least two non-ionic surfactants, selected from compounds of general formula (Ia), wherein one of said non-ionic surfactants is characterized in R¹ being n-C₁₂H₂₅, R² and R⁵ being H, m being 3-30, preferably 7, n and o=0, and the other surfactant is characterized in R¹ being n-C₁₄H₂₉, R² and R⁵ being H, m being 3-30, preferably 7, n and o=0.

The detergent formulations in one embodiment comprise at least two non-ionic surfactants, selected from compounds of general formula (Ia), wherein one of said non-ionic surfactants is characterized in R¹ being n-C₁H₂a, R² and R⁵ being H, m being 4-10, n and o=0, and the other surfactant is characterized in R¹ selected from n-C₁₁H₂₃ and n-C₁₇H₃₅, R² and R⁵ being H, m being 4-10, n and o=0.

The detergent formulations in one embodiment comprise at least two non-ionic surfactants, selected from compounds of general formula (Ia), wherein one of said non-ionic surfactants is characterized in R¹ being n-C₉H₁₉, R² and R⁵ being H, m being 5-7, n and o=0, and the other surfactant is characterized in R¹ being n-C₁₇H₃₅, R² and R⁵ being H, m being 5-7, n and o=0. In one embodiment, the detergent formulation comprises at least two non-ionic surfactants, selected from compounds of general formula (Ia), wherein one of said non-ionic surfactants is characterized in R¹ being n-C₁₁H₂₃, R⁵ being H, m is 7, n and o=0, and the other surfactant is characterized in R¹ being C₁₃H₂₇, R⁵ being H, m being 7, n and o=0.

The non-ionic surfactants of the general formulae (Ia) and (Ib) can be of any structure, is it block or random structure, and is not limited to the displayed sequence of formulae (Ia) and (Ib).

In one embodiment, detergent formulations according to the invention comprises at least one compound according to formula (Ia) or (Ib) in the range of about 0.3% to 30% by weight, in the range of about 0.4% to 20% by weight, or in the range of about 0.5% to 10%, all relative to the total weight of a detergent formulation. At least one non-ionic surfactant is preferably selected from a surfactant according to general formula (Ia), and wherein m is 7; n and o is 0, R¹ is C₁₂-C₁₄, R² and R⁵ is H. In an embodiment, the detergent formulation comprises two non-ionic surfactants, selected from compounds of general formula (Ia), wherein one of said non-ionic surfactants is characterized in R¹ being C₁₂, R² and R⁵ being H, m is 7, n and o=0, and the other surfactant is characterized in R¹ being C₁₄, R² and R⁵ being H, m being 7, n and o=0, wherein preferably the total amount of the non-ionic surfactants is in the range of about 0.3% to 30% by weight, in the range of about 0.4% to 20% by weight, or in the range of about 0.5% to 10%, all relative to the total weight of a detergent formulation.

Non-ionic surfactants may further be compounds of the general formula (II), which might be called alkyl-polyglycosides (APG):

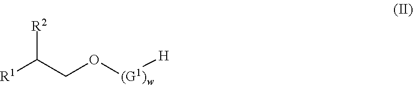

The variables of the general formula (II) are defined as follows:
R¹ is selected from C₁-C₁₇ alkyl and C₂-C₁₇ alkenyl, wherein alkyl and/or alkenyl are linear (straight-chain; n-) or branched; examples are n-C₇H₁₅, n-C₉H₁₉, n-C₁₁H₂₃, n-C₁₃H₂₇, n-C₁₅H₃₁, n-C₁₇H₃₅, i-C₉H₁₉, i-C₁₂H₂₅.
R² is selected from H, C₁-C₁₇ alkyl and C₂-C₁₇ alkenyl, wherein alkyl and/or alkenyl are linear (straight-chain; n-) or branched.
G¹ is selected from monosaccharides with 4 to 6 carbon atoms, such as glucose and xylose.

The integer w of the general formula (II) is in the range of from 1.1 to 4, w being an average number.

Non-ionic surfactants in one embodiment are compounds of general formula (IV):

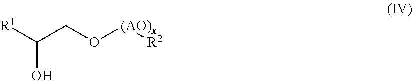

The variables of the general formula (IV) are defined as follows:
AO being identical or different alkylene oxides, selected from CH₂—CH₂—O, (CH₂)₃—O, (CH₂)₄—O, CH₂CH(CH₃)—O, CH(CH₃)—CH₂—O— and CH₂CH(n-C₃H₇)—O.
R¹ is selected from linear (straight-chain; n-) or branched C₄-C₃₀-alkyl, and from straight-chain or branched C₄-C₃₀-alkylene with at least one C—C double bond. R¹ may be straight-chain or branched C₄-C₃₀-alkyl, n-C₄-C₃₀-alkyl, n-C₇-C₁₅ alkyl, or n-C₁₀-C₁₂-alkyl.
R² is selected from linear (straight-chain; n-) or branched C₁-C₃₀-alkyl, and from straight-chain or branched C₂-C₃₀-alkylene with at least one C—C double bond. R² may be straight-chain or branched C₆-C₂₀-alkyl, preferably straight-chain or branched C₈-C₁₂-alkyl, more preferably straight-chain or branched C₁₀-C₁₂-alkyl.

The integer x of the general formula (IV) may be a number in the range of 5 to 70, 10 to 60, 15 to 50, or 20 to 40.

In one embodiment of the present invention, (AO)ₓ is selected from (CH₂CH₂O)ₓ₁, x1 being selected from one to 50.

In one embodiment of the present invention, (AO)ₓ is selected from —(CH₂CH₂O)ₓ₂—(CH₂CH(CH₃)—O)ₓ₃ and —(CH₂CH₂O)ₓ₂—(CH(CH₃)CH₂—O)ₓ₃, x2 and x3 being identical or different and selected from 1 to 30.

In one embodiment of the present invention, (AO)ₓ is selected from —(CH₂CH₂O)ₓ₄, x4=being in the range of from 10 to 50, AO being EO, and R¹ and R² each being independently selected from C₈-C₁₄-alkyl.

In the context of the present invention, x or x1 or x2 and x3 or x4 are to be understood as average values, the number average being preferred. Therefore, each x or x1 or x2 or x3 or x4—if applicable—can refer to a fraction although a specific molecule can only carry a whole number of alkylene oxide units.

In one embodiment, the detergent formulation of the invention comprises at least one non-ionic surfactant according to formula (IV), wherein R¹ is n-C₃-C₁₇ alkyl, R² is linear or branched C₈-C₁₄ alkyl. Preferably AO is selected from —(CH₂CH₂O)ₓ₂—(CH₂CH(CH₃)—O)ₓ₃, —(CH₂CH₂O)ₓ₂—(CH(CH₃)CH₂—O)ₓ₃, and —(CH₂CH₂O)ₓ₄, wherein x2 and x4 is a number in the range of 15-50 and x3 is a number in the range of 1 to 15. At least one non-ionic surfactant in one embodiment is a compound according to formula (IV), wherein R¹ is n-C₈ alkyl, R² is branched C₁₁ alkyl, AO is CH₂—CH₂—O, and x is 22. At least one non-ionic surfactant in one embodiment is a compound according to formula (IV), wherein R¹ is n-C₈ alkyl, R² is n-C₈-C₁₀ alkyl, AO is CH₂—CH₂—O, and x is 40. At least one non-ionic surfactant in one embodiment is a compound according to formula (IV), wherein R¹ is n-C₈ alkyl, R² is n-C₁₀ alkyl, AO is selected from —(CH₂CH₂O)ₓ₂—(CH₂CH(CH₃)—O)ₓ₃, —(CH₂CH₂O)ₓ₂—(CH(CH₃)CH₂—O)ₓ₃, wherein x2=22 and x3=1.

In one embodiment, the detergent formulation, preferably a liquid detergent formulation according to the invention, comprises at least one compound according to formula (IV) in the range of about 0.3% to 10% by weight, in the range of about 0.5% to 5% by weight, or in the range of about 1% to 3%, all relative to the total weight of a detergent formulation. At least one non-ionic surfactant preferably is a compound according to formula (IV), wherein R¹ is n-C₈ alkyl, R² is branched C₁₁ alkyl, AO is CH₂—CH₂—O, and x is 22.

Non-ionic surfactants in one embodiment are selected from sorbitan esters and/or ethoxylated or propoxylated sorbitan esters. Non-limiting examples are products sold under the trade names SPAN and TWEEN.

Non-ionic surfactants in one embodiment are selected from alkoxylated mono- or dialkylamines, fatty acid monoethanolamides (FAMA), fatty acid diethanolamides (FADA), ethoxylated fatty acid monoethanolamides (EFAM), propoxylated fatty acid monoethanolamides (PFAM), polyhydroxy alkyl fatty acid amides, or N-acyl N-alkyl derivatives of glucosamine (glucamides, GA, or fatty acid glucamide, FAGA), and combinations thereof.

Surfactants in one embodiment are compounds comprising amphoteric structures of general formula (V), which might be called modified amino acids (proteinogenic as well as nonproteinogenic):

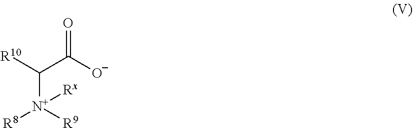

The variables in general formula (V) are defined as follows:
R⁸ is selected from H, C₁-C₄ alkyl, C₂-C₄ alkenyl, wherein alkyl and/or are linear (straight-chain; n-) or branched.
R⁹ is selected from C₁-C₂₂-alkyl, C₂-C₂₂-alkenyl, C₁₀-C₂₂ alkylcarbonyl, and C₁₀-C₂₂ alkenylcarbonyl.
R¹⁰ is selected from H, methyl, —(CH₂)₃NHC(NH)NH₂, —CH₂C(O)NH₂, —CH₂C(O)OH, —(CH₂)₂C(O)NH₂, —(CH₂)₂C(O)OH, (imidazole-4-yl)-methyl, —CH(CH₃)C₂H₅, —CH₂CH(CH₃)₂, —CH₂)₄NH₂, benzyl, hydroxymethyl, —CH(OH)CH₃, (indole-3-yl)-methyl, (4-hydroxy-phenyl)methyl, isopropyl, —(CH₂)₂SCH₃, and —CH₂SH.

R^{x} is selected from H and C₁-C₄-alkyl.

Surfactants in one embodiment are compounds comprising amphoteric structures of general formulae (VIa), (VIb), or (VIc). which might be called betaines and/or sulfobetaines:

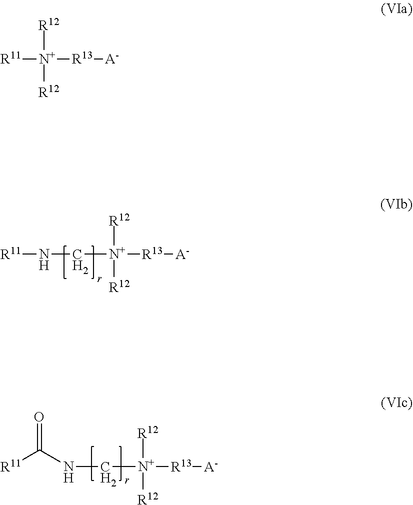

The variables in general formulae (VIa), (VIb) and (VIc) are defined as follows:
R¹¹ is selected from linear (straight-chain; n-) or branched C₇-C₂₂ alkyl and linear (straight-chain; n-) or branched C₇-C₂₂ alkenyl.
R¹² are each independently selected from linear (straight-chain; n-) C₁-C₄ alkyl.
R¹³ is selected from C₁-C₅ alkyl and hydroxy C₁-C₅ alkyl; for example 2-hydroxypropyl.
A⁻ is selected from carboxylate and sulfonate.

The integer r in general formulae (VIa), (VIb), and (VIc) is in the range of 2 to 6.

Surfactants in one embodiment are compounds comprising amphoteric structures of general formula (VII), which might be called alkyl-amphocarboxylates:

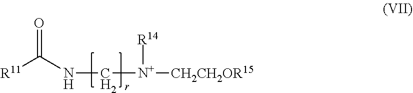

The variables in general formula (VII) are defined as follows:
R¹¹ is selected from C₇-C₂₂ alkyl and C₇-C₂₂ alkenyl, wherein alkyl and/or alkenyl are linear (straight-chain; n-) or branched, preferably linear.
R¹⁴ is selected from —CH₂C(O)O⁻M⁺, —CH₂CH₂C(O)O⁻M⁺ and —CH₂CH(OH)CH₂SO₃⁻M⁺.
R¹⁵ is selected from H and —CH₂C(O)O⁻

The integer r in general formula (VII) is in the range of 2 to 6.

Non-limiting examples of further suitable alkyl-amphocarboxylates include sodium cocoamphoacetate, sodium lauroamphoacetate, sodium capryloamphoacetate, disodium cocoamphodiacetate, disodium lauroamphodiacetate, disodium caprylamphodiacetate, disodium capryloamphodiacetate, disodium cocoamphodipropionate, disodium lauroamphodipropionate, disodium caprylamphodipropionate, and disodium capryloamphodipropionate.

Surfactants in one embodiment are compounds comprising amphoteric structures of general formula (VIII), which might be called amine oxides (AO):

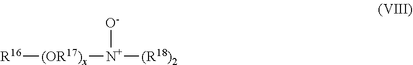

The variables in general formula (VIII) are defined as follows:
R¹⁶ is selected from C₈-C₁₈ alkyl, hydroxy C₈-C₁₈ alkyl, acylamidopropoyl and C₈-C₁₈ alkyl phenyl group; wherein alkyl and/or alkenyl are linear (straight-chain; n-) or branched.
R¹⁷ is selected from C₂-C₃ alkylene, hydroxy C₂-C₃ alkylene, and mixtures thereof.
R¹⁸: each residue can be independently selected from C₁-C₃ alkyl and hydroxy C₁-C₃; R¹⁵ groups can be attached to each other, e.g., through an oxygen or nitrogen atom, to form a ring structure.

The integer x in general formula (VIII) is in the range of 0 to 5, preferably from 0 to 3, most preferably 0.

Non-limiting examples of further suitable amine oxides include C₁₀-C₁₈ alkyl dimethyl amine oxides and C₈-C₁₈ alkoxy ethyl dihydroxyethyl amine oxides. Examples of such materials include dimethyloctyl amine oxide, diethyldecyl amine oxide, bis-(2-hydroxyethyl)dodecyl amine oxide, dimethyldodecylamine oxide, dipropyltetradecyl amine oxide, methylethylhexadecyl amine oxide, dodecylamidopropyl dimethyl amine oxide, cetyl dimethyl amine oxide, stearyl dimethyl amine oxide, tallow dimethyl amine oxide and dimethyl-2-hydroxyoctadecyl amine oxide.

A further example of a suitable amine oxide is cocamidylpropyl dimethylaminoxide, sometimes also called cocamidopropylamine oxide.

Mixtures of two or more different amphoteric surfactants may be present in detergent formulations according to the present invention.

In one embodiment, detergent formulations according to the invention comprises at least one amphoteric surfactant, wherein the total amount of amphoteric surfactant may be in the range from 0.01% to 10%, in the range from 0.1 to 5%, or in the range from 0.5 to 1% by weight, all relative to the total weight of the detergent formulation.

At least one anionic surfactant is selected from alkali metal and ammonium salts of C₈-C₁₈-alkyl sulfates, of C₈-C₁₈-fatty alcohol polyether sulfates, of sulfuric acid half-esters of ethoxylated C₄-C₁₂-alkylphenols (ethoxylation: 1 to 50 mol of ethylene oxide/mol), C₁₂-C₁₈ sulfo fatty acid alkyl esters, for example of C₁₂-C₁₈ sulfo fatty acid methyl esters, furthermore of C₁₂-C₁₈-alkylsulfonic acids and of C₁₀-C₁₈-alkylarylsulfonic acids. Preference is given to the alkali metal salts of the aforementioned compounds, particularly preferably the sodium salts.

Anionic surfactant means a surfactant with a negatively charged ionic group. Anionic surfactants include, but are not limited to, surface-active compounds that contain a hydrophobic group and at least one water-solubilizing anionic group, usually selected from sulfates, sulfonate, and carboxylates to form a water-soluble compound.

Anionic surfactants in one embodiment are compounds of general formula (IXa) or (IXb):

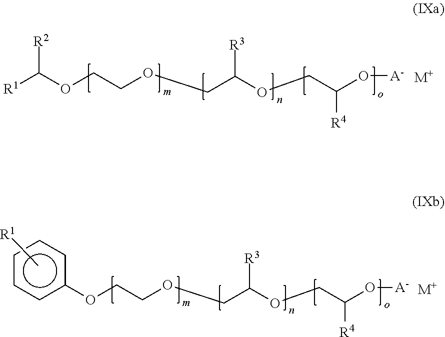

The variables in general formulae (IXa and IXb) are defined as follows:
R¹ is selected from C₁-C₂₃-alkyl (such as 1-, 2-, 3-, 4-C₁-C₂₃-alkyl) and C₂-C₂₃-alkenyl, wherein alkyl and/or alkenyl are linear (straight-chain; n-) or branched, and wherein 2-, 3-, or 4-alkyl; examples are n-C₇H₁₅, n-C₉H₁₉, n-C₁₁H₂₃, n-C₁₃H₂₇, n-C₁₅H₃₁, n-C₁₇H₃₅, i-C₉H₁₉, i-C₁₂H₂₅.
R² is selected from H, C₁-C₂₀-alkyl and C₂-C₂₀-alkenyl, wherein alkyl and/or alkenyl are linear (straight-chain; n-) or branched.
R³ and R⁴, each independently selected from C₁-C₁₆-alkyl, wherein alkyl is linear (straight-chain; n-) or branched; examples are methyl, ethyl, n-propyl, isopropyl, n-butyl, isobutyl, secbutyl, tert-butyl, n-pentyl, isopentyl, seo-pentyl, neopentyl, 1,2-dimethylpropyl, isoamyl, n-hexyl, isohexyl, seo-hexyl, n-heptyl, n-octyl, 2-ethylhexyl, n-nonyl, n-decyl, isodecyl.
A⁻ is selected from —RCOO⁻, —SO₃⁻ and RSO₃⁻, wherein R is selected from linear (straight-chain; n-) or branched C₁-C₈-alkyl, and C₁-C₄ hydroxyalkyl, wherein alkyl is. Compounds might be called (fatty) alcohol/alkyl (ethoxy/ether) sulfates [(F)A(E)S] when A⁻ is SO₃⁻, (fatty) alcohol/alkyl (ethoxy/ether) carboxylat [(F)A(E)C] when A⁻ is —RCOO⁻.
M⁺ is selected from H and salt forming cations. Salt forming cations may be monovalent or multivalent; hence M⁺ equals 1/v M^{v+}. Examples include but are not limited to sodium, potassium, magnesium, calcium, ammonium, and the ammonium salt of mono-, di, and triethanolamine.

The integers of the general formulae (IXa) and (IXb) are defined as follows: m is in the range of zero to 200, preferably 1-80, more preferably 3-20; n and o, each independently in the range of zero to 100; n preferably is in the range of 1 to 10, more preferably 1 to 6; o preferably is in the range of 1 to 50, more preferably 4 to 25. The sum of m, n and o is at least one, preferably the sum of m, n and o is in the range of 5 to 100, more preferably in the range of from 9 to 50.

Anionic surfactants of the general formulae (IXa) and (IXb) can be of any structure, block copolymers or random copolymers.

In one embodiment, the detergent formulations of the invention comprises at least one anionic surfactant according to formula (IXa), wherein R¹ is n-C₁₁H₂₃, R² is H, A⁻ is SO₃⁻, m, n and o being 0. M⁺ preferably is NH₄⁺. Such compounds may be called ammonium lauryl sulfate (ALS) herein.

In one embodiment, the detergent formulations of the invention comprises at least one anionic surfactant according to formula (IXa), wherein R¹ is n-C₁₁H₂₃, R² is selected from H, A⁻ is SO₃⁻, m being 2-5, preferably 3, and n and o being 0. M⁺ preferably is Na⁺. Such compounds may be called laurylethersulfates (LES) herein, preferably sodium laurylethersulfates (SLES).

Further suitable anionic surfactants include salts (M⁺) of C₁₂-C₁₈ sulfo fatty acid alkyl esters (such as C₁₂-C₁₈ sulfo fatty acid methyl esters), C₁₀-C₁₈-alkylarylsulfonic acids (such as n-C₁₀-C₁₈-alkylbenzene sulfonic acids) and C₁₀-C₁₈ alkyl alkoxy carboxylates.

M⁺ in all cases is selected from salt forming cations. Salt forming cations may be monovalent or multivalent; hence M⁺ equals 1/v M^{v+}. Examples include but are not limited to sodium, potassium, magnesium, calcium, ammonium, and the ammonium salt of mono-, di, and triethanolamine.

The detergent formulations in one embodiment comprise at least two anionic surfactants, selected from compounds of general formula (IXa), wherein one of said anionic surfactants is characterized in R¹ being C₁₁, R² being H, m being 2, n and o=0, A⁻ being SO₃⁻, M⁺ being Na⁺ and the other surfactant is characterized in R¹ being C₁₃, R² being H, m being 2, n and o=0, A⁻ being SO₃⁻, M⁺ being Na⁺.

Non-limiting examples of further suitable anionic surfactants include branched alkylbenzenesulfonates (BABS), phenylalkanesulfonates, alpha-olefinsulfonates (AOS), olefin sulfonates, alkene sulfonates, alkane-2,3-diylbis(sulfates), hydroxyalkanesulfonates and disulfonates, secondary alkanesulfonates (SAS), paraffin sulfonates (PS), sulfonated fatty acid glycerol esters, alkyl- or alkenylsuccinic acid, fatty acid derivatives of amino acids, diesters and monoesters of sulfo-succinic acid.

In one embodiment, detergent formulations comprise at least one anionic surfactant selected from compounds of general formula (X):

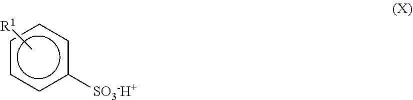

wherein R¹ in formula (X) is C₁₀-C₁₃ alkyl. Detergent formulations of the invention may comprise salts of compounds according to formula (X), preferably sodium salts. The detergent formulation may comprise at least two anionic surfactants, selected from compounds of general formula (X), wherein one of said anionic surfactants is characterized in R¹ being C₁₀, and the other surfactant is characterized in R¹ being C₁₃. The detergent formulation may comprise at least two anionic surfactants, selected from sodium salts of compounds of general formula (X), wherein one of said anionic surfactants is characterized in R¹ being C₁₀, and the other surfactant is characterized in R¹ being C₁₃.Compounds like this may be called LAS (linear alkybenzene sulfonates) herein.

Anionic surfactants in one embodiment are compounds of general formula (XI), which might be called N-acyl amino acid surfactants:

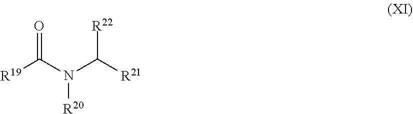

The variables in general formula (XI) are defined as follows:
R¹ is selected from linear (straight-chain; n-) or branched C₆-C₂₂-alkyl and linear (straight-chain; n-) or branched C₆-C₂₂-alkenyl such as oleyl.
R²⁰ is selected from H and C₁-C₄-alkyl.
R²¹ is selected from H, methyl, —(CH₂)₃NHC(NH)NH₂, —CH₂C(O)NH₂, —CH₂C(O)OH, —(CH₂)₂C(O)NH₂, —(CH₂)₂C(O)OH, (imidazole-4-yl)-methyl, —CH(CH₃)C₂H₅, —CH₂CH(CH₃)₂, —CH₂)₄NH₂, benzyl, hydroxymethyl, —CH(OH)CH₃, (indole-3-yl)-methyl, (4-hydroxy-phenyl)methyl, isopropyl, —(CH₂)₂SCH₃, and —CH₂SH.
R²² is selected from —COOX and —CH₂SO₃X, wherein X is selected from Li⁺, Na⁺ and K⁺.

Non-limiting examples of suitable N-acyl amino acid surfactants are the mono- and dicarboxylate salts (e.g., sodium, potassium, ammonium and ammonium salt of mono-, di, and triethanolamine) of N-acylated glutamic acid, for example, sodium cocoyl glutamate, sodium lauroyl glutamate, sodium myristoyl glutamate, sodium palmitoyl glutamate, sodium stearoyl glutamate, disodium cocoyl glutamate, disodium stearoyl glutamate, potassium cocoyl glutamate, potassium lauroyl glutamate, and potassium myristoyl glutamate; the carboxylate salts (e.g., sodium, potassium, ammonium and ammonium salt of mono-, di, and triethanolamine) of N-acylated alanine, for example, sodium cocoyl alaninate, and triethanolamine lauroyl alaninate; the carboxylate salts (e.g., sodium, potassium, ammonium and ammonium salt of mono-, di, and triethanolamine) of N-acylated glycine, for example, sodium cocoyl glycinate, and potassium cocoyl glycinate; the carboxylate salts (e.g., sodium, potassium, ammonium and ammonium salt of mono-, di, and triethanolamine) of N-acylated sarcosine, for example, sodium lauroyl sarcosinate, sodium cocoyl sarcosinate, sodium myristoyl sarcosinate, sodium oleoyl sarcosinate, and ammonium lauroyl sarcosinate.

Anionic surfactants in one embodiment are selected from the group of soaps. Suitable are salts (M⁺) of saturated and unsaturated C₁₂-C₁₈ fatty acids, such as lauric acid, myristic acid, palmitic acid, stearic acid, behenic acid, oleic acid, (hydrated) erucic acid. M is selected from salt forming cations. Salt forming cations may be monovalent or multivalent; hence M⁺ equals 1/v M^{v+}. Examples include but are not limited to sodium, potassium, magnesium, calcium, ammonium, and the ammonium salt of mono-, di, and triethanolamine.

Further non-limiting examples of suitable soaps include soap mixtures derived from natural fatty acids such as tallow, coconut oil, palm kernel oil, laurel oil, olive oil, or canola oil. Such soap mixtures comprise soaps of lauric acid and/or myristic acid and/or palmitic acid and/or stearic acid and/or oleic acid and/or linoleic acid in different amounts, depending on the natural fatty acids from which the soaps are derived.

Further non-limiting examples of suitable anionic surfactants include salts (M⁺) of sulfates, sulfonates or carboxylates derived from natural fatty acids such as tallow, coconut oil, palm kernel oil, laurel oil, olive oil, or canola oil. Such anionic surfactants comprise sulfates, sulfonates or carboxylates of lauric acid and/or myristic acid and/or palmitic acid and/or stearic acid and/or oleic acid and/or linoleic acid in different amounts, depending on the natural fatty acids from which the soaps are derived.

In one embodiment, detergent formulations according to the invention comprise at least one anionic surfactant, wherein the total amount of anionic surfactant may be in the range from 0.5 to 80%, preferably in the range from 1 to 70% by weight, all relative to the total weight of the detergent formulation.

Detergent formulations according to the invention in one embodiment comprise anionic surfactants in total amounts in the range of about 0.5-25% by weight, in the range of about 1-20% by weight, or in the range of about 1.5-15%, all relative to the total weight of a detergent formulation.

In an embodiment, detergent formulations comprises two anionic surfactants selected from compounds of general formula (IXa), and wherein one of said anionic surfactants is characterized in R¹ being C₁₁, R² being H, m being 2, n and o=0, A⁻ being SO₃⁻, M⁺ being Na⁺, and the other surfactant is characterized in R¹ being C₁₃, R² being H, m being 2, n and o=0, A⁻ being SO₃⁻, M⁺ being Na⁺. In an embodiment, the detergent formulation comprises two anionic surfactants selected from compounds of general formula (X), wherein one of said anionic surfactants is characterized in R¹ being C₁₀, and the other surfactant is characterized in R¹ being C₁₃. In an embodiment, the detergent formulation comprises two anionic surfactants selected from sodium salts of compounds of general formula (X), wherein one of said anionic surfactants is characterized in R¹ being C₁₀, and the other surfactant is characterized in R¹ being C₁₃.

Mixtures of two or more different anionic surfactants may also be present in detergent formulations according to the present invention.

In one embodiment, mixtures of non-ionic and/or amphoteric and/or anionic surfactants are present in detergent formulations according to the present invention.

Detergent formulations of the invention comprise one or more compounds selected from complexing agents (chelating agents, sequestrating agents), precipitating agents, and ion exchange compounds, which may form water-soluble complexes with calcium and magnesium. Such compounds may be called “builders” or “building agents” herein, without meaning to limit such compounds to this function in the final application of a detergent formulation.

Non-phosphate based builders according to the invention include sodium gluconate, citrate(s), silicate(s), carbonate(s), phosphonate(s), amino carboxylate(s), polycarboxylate(s), polysulfonate(s), and polyphosphonate(s).

Detergent formulations of the invention in one embodiment comprise one or more citrates. The term “citrate(s)” includes the mono- and the dialkali metal salts and in particular the mono- and preferably the trisodium salt of citric acid, ammonium or substituted ammonium salts of citric acid as well as citric acid as such. Citrate can be used as the anhydrous compound or as the hydrate, for example as sodium citrate dihydrate. In one embodiment, the detergent formulations of the invention comprise citric acid in amounts in the range of 0.5% to 30.0% by weight, in the range of 1.0% to 25.0% by weight, or in the range of 5.0% to 20.0% by weight, all relative to the total weight of the detergent formulation. The citric acid may be provided as a mixture with formiate, e.g. Na-citrate:Na-formiate=9:1.

Detergent formulations of the invention in one embodiment comprise one or more silicates. “Silicate(s)” In the context of the present invention include in particular sodium disilicate and sodium metasilicate, aluminosilicates such as sodium aluminosilicates like zeolith A (i.e. Na₁₂(AlO₂)₁₂(SiO₂)₁₂*27H₂O), and sheet silicates, in particular those of the formula alpha-Na₂Si₂O₅, beta-Na₂Si₂O₅, and delta-Na₂Si₂O₅.

Detergent formulations of the invention in one embodiment comprise one or more carbonates. The term “carbonate(s)” includes alkali metal carbonates and alkali metal hydrogen carbonates, preferred are the sodium salts. Particularly suitable is sodium carbonate (Na₂CO₃).

Detergent formulations of the invention in one embodiment comprise one or more phosphonates. “Phosphonates” include, but are not limited to 2-phosphinobutane-1,2,4-tricarboxylic acid (PBTC); ethylenediaminetetra(methylenephosphonic acid) (EDTMPA); 1-hydroxyethane-1,1-diphosphonic acid (HEDP), CH₂C(OH)[PO(OH)₂]₂; aminotris(methylenephosphonic acid) (ATMP), N[CH₂PO(OH)₂]₃; aminotris(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid) (DTPMP), (HO)₂POCH₂N[CH₂CH₂N[CH₂PO(OH)₂]₂]₂; diethylenetriaminepenta(methylenephosphonate), sodium salt, C₉H₍₂₈₋ₓ₎N₃NaₓO₁₅P₅ (x=7); hexamethylenediamine(tetramethylenephosphonate), potassium salt, C₁₀H₍₂₈₋ₓ₎N₂KₓO₁₂P₄(x=6); and bis(hexamethylene)triamine(pentamethylene-phosphonic acid), (HO₂)POCH₂N[(CH₂)₂N[CH₂PO(OH)₂]₂]₂. Salts thereof may be suitable, too.

The detergent formulations of the invention in one embodiment comprise at least one phosphonate, preferably selected from derivatives polyphosphonic acids such as of diphosphonic acid such as sodium salt of HEDP, derivatives of aminopolyphosphonic acid such as aminoalkylene phosphonic acids such as DTPMP in amounts in the range of 0.1% to 5.0% by weight, in the range of 0.5% to 3.0% by weight, or in the range of 1.0% to 2.0% by weight, all relative to the total weight of the detergent formulation.

Detergent formulations of the invention in one embodiment comprise one or more aminocarboxylates. Non-limiting examples of suitable “amino carboxylates” include, but are not limited to: diethanol glycine (DEG), dimethylglycine (DMG), nitrilitriacetic acid (NTA), N-hydroxyethylaminodiacetic acid, ethylenediaminetetraacetic acid (EDTA), N-(2hydroxyethyl)iminodiacetic acid (HEIDA), hydroxyethylenediaminetriacetic acid, N-hydroxyethyl-ethylenediaminetriacetic acid (HEDTA), hydroxyethylenediaminetetraacetic acid, diethylenetriaminepentaacetic acid (DTPA), and methylglycinediacetic acid (MGDA), glutamic acid-diacetic acid (GLDA), iminodisuccinic acid (IDS), hydroxyiminodisuccinic acid, ethylenediaminedisuccinic acid (EDDS), aspartic acid-diacetic acid, and alkali metal salts or ammonium salts thereof. Further suitable are aspartic acid-N-mono-acetic acid (ASMA), aspartic acid-N,N-diacetic acid (ASDA), aspartic acid-N-monopropionic acid (ASMP), N-(2-sulfomethyl) aspartic acid (SMAS), N-(2-sulfoethyl) aspartic acid (SEAS), N-(2-sulfomethyl) glutamic acid (SMGL), N-(2-sulfoethyl) glutamic acid (SEGL), N-methylimino-diacetic acid (MIDA), alpha-alanine-N,N-diacetic acid (alpha-ALDA), serne-N,N-diacetic acid (SEDA), isoserne-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurne-N,N-diacetic acid (TUDA) and sulfomethyl-N,N-diacetic acid (SMDA) and alkali metal salts or ammonium salts thereof. The term “ammonium salts” as used in in this context refers to salts with at least one cation that bears a nitrogen atom that is permanently or temporarily quaternized. Examples of cations that bear at least one nitrogen atom that is permanently quaternized include tetramethylammonium, tetraethylammonium, dimethyldiethyl ammonium, and n-C₁₀-C₂₀-alkyl trimethyl ammonium. Examples of cations that bear at least one nitrogen atom that is temporarily quaternized include protonated amines and ammonia, such as monomethyl ammonium, dimethyl ammonium, trimethyl ammonium, monoethyl ammonium, diethyl ammonium, triethyl ammonium, n-C₁₀-C₂₀-alkyl dimethyl ammonium 2-hydroxyethylammonium, bis(2-hydroxyethyl) ammonium, tis(2-hydroxyethyl)ammonium, N-methyl 2-hydroxyethyl ammonium, N,N-dimethyl-2-hydroxyethylammonium, and especially NH₄⁺.

In one embodiment, detergent formulations of the invention comprise more than one builder. Preferably, inventive detergent formulations contain less than 0.2% by weight of nitrilotriacetic acid (NTA), or 0.01 to 0.1% NTA by weight relative to the total weight of the detergent formulation.

In one embodiment, the detergent formulations of the invention comprise at least one aminocarboxylate selected from ethylenediaminetetraacetic acid (EDTA), diethylenetriaminepentaacetic acid (DTPA), methylglycine diacetate (MGDA), and glutamic acid diacetate (GLDA), which all may be (partially) neutralized with alkali, in amounts in the range of 0% to 30.0% by weight, in the range of 0.1% to 25.0% by weight, in the range of 1.0% to 20.0% by weight, in the range of 2.5% to 25.0% by weight, in the range of 5.0 to 20% by weight, or in the range of 2.5 to 10% by weight, all relative to the total weight of the detergent formulation. Preferably, detergent formulations of the invention comprise amounts of MGDA and/or GLDA in the range of 1% to 20% by weight, in the range of 2.5 to 15% by weight, or in the range of 2.5 to 12.5% by weight, all relative to the total weight of the detergent formulation.

The term alkali refers to alkali metal cations, same or different, for example cations of lithium, sodium, potassium, rubidium, cesium, and combinations of at least two of the foregoing. Preferred examples of alkali metal cations are sodium and potassium and combinations of sodium and potassium.

In an embodiment, the detergent formulations of the invention comprises at least:
one alkali metal salt of methyl glycine diacetic acid (MGDA), with an average of more than two and less than three of the carboxyl groups being neutralized with alkali, and/or
one alkali metal salt of L- and D-enantiomers of glutamic acid diacetic acid (GLDA) or of enantiomerically pure L-GLDA, with an average of more than three of the carboxyl groups being neutralized with alkali, preferably an average of more than three and less than four of the carboxyl groups are neutralized with alkali.

In one embodiment of the present invention, alkali metal salts of MGDA are selected from compounds of the general formula (XII):

[CH₃—CH(COO)—N(CH₂—COO)₂]M_{3-x1-y1}(NH₄)_{z1}Hₓ₁ (XII)

The variables of formula (XII) are defined as follows:
M is selected from alkali metal cations, same or different, for example cations of lithium, sodium, potassium, rubidium, cesium, and combinations of at least two of the foregoing. Preferred examples of alkali metal cations are sodium and potassium and combinations of sodium and potassium.
x1 is selected from 0.0 to 1.0, preferably 0.1 to 0.5, more preferably up to 0.1 to 0.3;
z1 is selected from 0.0 to 1.0, preferably 0.0005 to 0.5;
however, the sum of x1+z1 in formula (XII) is greater than zero, for example 0.05 to 0.6.

Examples of M_{3-x1-z1}(NH₄)_{z1}Hₓ₁ are Na₃₋ₓ₁Hₓ₁, [Na_{0.7}(NH₄)_{0.3}]₃₋ₓ₁Hₓ₁, [(NH₄)_{0.7}Na_{0.3}]₃₋ₓ₁Hₓ₁, [(NH₄)_{0.7}Na_{0.3}]₃₋ₓ₁Hₓ₁.

In one embodiment of the present invention, MGDA is selected from at least one alkali metal salt of racemic MGDA and from alkali metal salts of mixtures of L- and D-enantiomers according to formula (XII), said mixture containing predominantly the respective L-isomer with an enantiomeric excess (ee) in the range of from 5 to 99%, preferably 5 to 95%, more preferably from 10 to 75% and even more preferably from 10 to 66%. Preferably, MGDA and its respective alkali metal salts are selected from the racemic mixture and from mixtures containing in the range of from 55 to 85 mole-% of the L-isomer, the balance being D-isomer. Particularly preferred are mixtures containing in the range of from 60 to 80 mole-% of the L-isomer, the balance being D-isomer. Other particularly preferred embodiments are racemic mixtures.

In one embodiment of the present invention, the total degree of alkali neutralization of MGDA is in the range of from 0.80 to 0.98 mol-%, preferred are 0.90 to 0.97%. The total degree of alkali neutralization does not take into account any neutralization with ammonium.

In one embodiment of the present invention, alkali metal salts of GLDA are selected from compounds of the general formula (XIII)

[OOC—(CH₂)₂—CH(COO)—N(CH₂—COO)₂]M_{4-x2-z2}(NH₄)_{z2}Hₓ₂ (XIII)

The variables of formula (XIII) are defined as follows:
M is selected from alkali metal cations, same or different, as defined above for compounds of general formula (XIII)
x2 is selected from 0.0 to 2.0, preferably 0.02 to 0.5, more preferably up to 0.1 to 0.3;
z2 is selected from 0.0 to 1.0, preferably 0.0005 to 0.5;
however, the sum of x2+z2 in formula (XIII) is greater than zero, for example 0.05 to 0.6.

Examples of M_{3-x2-z2}(NH₄)_{z2}Hₓ₁ are Na₃₋ₓ₂Hₓ₂, [Na_{0.7}(NH₄)_{0.3}]₃₋ₓ₂Hₓ₂, [(NH₄)_{0.7}Na_{0.3}]₃₋ₓ₂Hₓ₂.

In one embodiment of the present invention, alkali metal salts of GLDA may be selected from alkali metal salts of the L- and D-enantiomers according to formula (XIII), said mixture containing the racemic mixture or preferably predominantly the respective L-isomer, for example with an enantiomeric excess (ee) in the range of from 5 to 99%, preferably 5 to 95%. Preferably, GLDA and its respective alkali metal salts are selected from the racemic mixture and from mixtures containing in the range of from 55 to 99 mole-% of the L-isomer, the balance being D-isomer. Particularly preferred are mixtures containing in the range of from 60 to 98.5 mole-% of the L-isomer, the balance being D-isomer. Other particularly preferred embodiments are racemic mixtures.

The enantiomeric excess can be determined, e.g., by measuring the polarization (polarimetry) or preferably by chromatography, for example by HPLC with a chiral column, for example with one or more cyclodextrins as immobilized phase or with a ligand exchange (Pirkle-brush) concept chiral stationary phase. Preferred is determination of the enantiomeric excess by HPLC with an immobilized optically active ammonium salt such as D-penicillamine.

Generally, in the context of the present invention, small amounts of MGDA and/or GLDA may also bear a cation other than alkali metal. It is thus possible that small amounts of builder, such as 0.01% to 5 mol-% of total builder may bear alkali earth metal cations such as, e.g., Mg²⁺ or Ca²⁺, or a transition metal cation such as, e.g., a Fe²⁺ or Fe³⁺ cation. “Small amounts” of MGDA and/or GLDA herein refer to a total of 0.1% to 1 w/w %, relative to the respective builder.

In one embodiment of the present invention, MGDA and/or GLDA comprised in detergent formulations may contain in the range of 0.1% to 10% by weight relative to the respective builder of one or more optically inactive impurities, at least one of the impurities being at least one of the impurities being selected from iminodiacetic acid, formic acid, glycolic acid, propionic acid, acetic acid and their respective alkali metal or mono-, di- or triammonium salts.

In one embodiment of the present invention, the detergent formulations comprise at least one polycarboxylate, for example alkali metal salts of (meth)acrylic acid homopolymers or (meth)acrylic acid copolymers.

Examples of suitable comonomers are monoethylenically unsaturated dicarboxylic acids such as maleic acid, fumaric acid, maleic anhydride, itaconic acid and citraconic acid. A suitable polymer is in particular polyacrylic acid, which preferably has an average molecular weight Mw in the range from 2000 to 40 000 g/mol, preferably 2000 to 10 000 g/mol, in particular 3000 to 8000 g/mol. Also of suitability are copolymeric polycarboxylates, in particular those of acrylic acid with methacrylic acid and of acrylic acid or methacrylic acid with maleic acid and/or fumaric acid, and in the same range of molecular weight.

It is also possible to use copolymers of at least one monomer from the group consisting of monoethylenically unsaturated C3-C10-mono- or C4-C10-dicarboxylic acids or anhydrides thereof, such as maleic acid, maleic anhydride, acrylic acid, methacrylic acid, fumaric acid, itaconic acid and citraconic acid, with at least one hydrophilic or hydrophobic monomer as listed below.

Suitable hydrophobic monomers are, for example, isobutene, diisobutene, butene, pentene, hexene and styrene, olefins with 10 or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C22-α-olefin, a mixture of C20-C24-α-olefins and polyisobutene having on average 12 to 100 carbon atoms per molecule.

Suitable hydrophilic monomers are monomers with sulfonate or phosphonate groups, and also nonionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoypolybutylene glycol (meth)acrylate and ethoxypoly(propylene oxide-co-ethylene oxide) (meth)acrylate. Polyalkylene glycols here may comprise 3 to 50, in particular 5 to 40 and especially 10 to 30 alkylene oxide units per molecule.

Particularly preferred sulfonio-acid-group-containing monomers here are 1-acrylamido-1-propanesulfonic acid, 2-acrylamido-2-propanesulfonic acid, 2-acrylamido-2-methylpropane-1-sulfonic acid (AMPS), 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

In one embodiment, the detergent formulations of the invention comprise polyacrylic acid having a molecular weight in the range of 4000-6000 g/mol, preferably having a molecular weight of 5000 g/mol, in amounts of 1-10% by weight, in amounts of 2-8% by weight, or in the range of 2-2.5% by weight, all relative to the total weight of the detergent formulation.

In one embodiment, the detergent formulations comprise carboxymethyl inulin.

In one embodiment, detergent formulations of the invention comprise at least one polymer with complexing groups like, for example, polyethylenimine in which 20 to 90 mole-% of the N-atoms bear at least one CH₂COO— group, and the respective alkali metal salts of the above sequestrants, especially their sodium salts.

Further examples of suitable polymers are polyalkylenimines, for example polyethylenimines and polypropylene imines. Polyalkylenimines may be used as such or as polyalkoxylated derivatives, for examples ethoxylated or propoxylated. Polyalkylenimines comprise at least three alkylenimine units per molecule.

In one embodiment of the present invention, said alkylenimine unit is a C₂-C₁₀-alkylendiamine unit, for example a 1,2-propylendiamine, preferably an α,ω-C₂-C₁₀-alkylendiamine, for example 1,2-ethylendiamine, 1,3-propylendiamine, 1,4-butylendiamine, 1,5-pentylendiaminne, 1,6-hexandiamine (also being referred to as 1,6-hexylendiamine), 1,8-diamine or 1,10-decandiamine, even more preferred are 1,2-ethylendiamine, 1,3-propylendiamine, 1,4-butylendiamine, and 1,6-hexandiamine.

In another embodiment of the present invention, said polyalkylenimine is selected from polyalkylenimine unit, preferably a polyethylenimine or polypropylenimine unit.

The term “polyethylenimine” in the context of the present invention does not only refer to polyethylenimine homopolymers but also to polyalkylenimines comprising NH—CH₂—CH₂—NH structural elements together with other alkylene diamine structural elements, for example NH—CH₂—CH₂—CH₂—NH structural elements, NH—CH₂—CH(CH₃)—NH structural elements, NH—(CH₂)₄—NH structural elements, NH—(CH₂)₆—NH structural elements or (NH—(CH₂)₈—NH structural elements but the NH—CH₂—CH₂— NH structural elements being in the majority with respect to the molar share. Preferred polyethylenimines comprise NH—CH₂—CH₂—NH structural elements being in the majority with respect to the molar share, for example amounting to 60 mol-% or more, more preferably amounting to at least 70 mol-%, referring to all alkylenimine structural elements. In a special embodiment, the term polyethylenimine refers to those polyalkylenimines that bear only one or zero alkylenimine structural element per polyethylenimine unit that is different from NH—CH₂—CH₂—NH.

The term “polypropylenlmine” In the context of the present invention does not only refer to polypropylenimine homopolymers but also to polyalkylenimines comprising NH—CH₂—CH(CH₃)—NH structural elements together with other alkylene diamine structural elements, for example NH—CH₂—CH₂—CH₂—NH structural elements, NH—CH₂—CH₂—NH structural elements, NH—(CH₂)₄—NH structural elements, NH—(CH₂)₆—NH structural elements or (NH—(CH₂)₆—NH structural elements but the NH—CH₂—CH(CH₃)—NH structural elements being in the majority with respect to the molar share. Preferred polypropylenimines comprise NH—CH₂—CH(CH₃)—NH structural elements being in the majority with respect to the molar share, for example amounting to 60 mol-% or more, more preferably amounting to at least 70 mol-%, referring to all alkylenimine structural elements. In a special embodiment, the term polypropylenimine refers to those polyalkylenimines that bear only one or zero alkylenimine structural element per polypropylenimine unit that is different from NH—CH₂—CH(CH₃)—NH.

Branches may be alkylenamino groups such as, but not limited to —CH₂—CH₂—NH₂ groups or (CH₂)₃—NH₂-groups. Longer branches may be, for examples, —(CH₂)₃—N(CH₂CH₂CH₂NH₂)₂ or —(CH₂)₂—N(CH₂CH₂NH₂)₂ groups. Highly branched polyethylenimines are, e.g., polyethylenimine dendrimers or related molecules with a degree of branching in the range from 0.25 to 0.95, preferably in the range from 0.30 to 0.80 and particularly preferably at least 0.5. The degree of branching can be determined for example by ¹³C-NMR or ¹⁵N-NMR spectroscopy, preferably in D₂O, and is defined as follows: DB=D+T/D+T+L, with D (dendritic) corresponding to the fraction of tertiary amino groups, L (linear) corresponding to the fraction of secondary amino groups and T (terminal) corresponding to the fraction of primary amino groups.

Within the context of the present invention, branched polyethylenimine units are polyethylenimine units with DB in the range from 0.25 to 0.95, particularly preferably in the range from 0.30 to 0.90% and very particularly preferably at least 0.5. Preferred polyethylenimine units are those that exhibit little or no branching, thus predominantly linear or linear polyethylenimine units.

In the context of the present invention, CH₃-groups are not being considered as branches.

In one embodiment of the present invention polyalkylenimine may have a primary amine value in the range of from 1 to 1000 mg KOH/g, preferably from 10 to 500 mg KOH/g, most preferred from 50 to 300 mg KOH/g. The primary amine value can be determined according to ASTM D2074-07.

In one embodiment of the present invention polyalkylenimine may have a secondary amine value in the range of from 10 to 1000 mg KOH/g, preferably from 50 to 500 mg KOH/g, most preferred from 50 to 500 mg KOH/g. The secondary amine value can be determined according to ASTM D2074-07.

In one embodiment of the present invention polyalkylenimine may have a tertiary amine value in the range of from 1 to 300 mg KOH/g, preferably from 5 to 200 mg KOH/g, most preferred from 10 to 100 mg KOH/g. The tertiary amine value can be determined according to ASTM D2074-07.

In one embodiment of the present invention, the molar share of tertiary N atoms is determined by ¹⁵N-NMR spectroscopy. In cases that tertiary amine value and result according to ¹³C-NMR spectroscopy are inconsistent, the results obtained by ¹³C-NMR spectroscopy will be given preference.

In one embodiment of the present invention, the average molecular weight M_{w} of said polyalkylenimine is in the range of from 250 to 100,000 g/mol, preferably up to 50,000 g/mol and more preferably from 800 up to 25,000 g/mol. The average molecular weight M_{w} of polyalkylenimine may be determined by gel permeation chromatography (GPC) of the intermediate respective polyalkylenimine, with 1.5% by weight aqueous formic acid as eluent and cross-linked polyhydroxyethyl methacrylate as stationary phase.

Said polyalkylenimine may be free or alkoxylated, said alkoxylation being selected from ethoxylation, propoxylation, butoxylation and combinations of at least two of the foregoing. Preference is given to ethylene oxide, 1,2-propylene oxide and mixtures of ethylene oxide and 1,2-propylene oxide. If mixtures of at least two alkylene oxides are applied, they can be reacted stepwise or simultaneously.

In one embodiment of the present invention, an alkoxylated polyalkylenimine bears at least 6 nitrogen atoms per unit.

In one embodiment of the present invention, polyalkylenimine is alkoxylated with 2 to 50 moles of alkylene oxide per NH group, preferably 5 to 30 moles of alkylene oxide per NH group, even more preferred 5 to 25 moles of ethylene oxide or 1,2-propylene oxide or combinations therefrom per NH group. In the context of the present invention, an NH₂ unit is counted as two NH groups. Preferably, all—or almost all—NH groups are alkoxylated, and there are no detectable amounts of NH groups left.

Depending on the manufacture of such alkoxylated polyalkylenimine, the molecular weight distribution may be narrow or broad. For example, the polydispersity Q=M_{w}/Mₙ in the range of from 1 to 3, preferably at least 2, or it may be greater than 3 and up to 20, for example 3.5 to 15 and even more preferred in the range of from 4 to 5.5.

In one embodiment of the present invention, the polydispersity Q of alkoxylated polyalkylenimine is in the range of from 2 to 10.

In one embodiment of the present invention alkoxylated polyalkylenimine is selected from polyethoxylated polyethylenimine, ethoxylated polypropylenimine, ethoxylated α,ω-hexandiamines, ethoxylated and propoxylated polyethylenimine, ethoxylated and propoxylated polypropylenimine, and ethoxylated and poly-propoxylated α,ω-hexandiamines.

In one embodiment of the present invention the average molecular weight Mₙ (number average) of alkoxylated polyethylenimine is in the range of from 2,500 to 1,500,000 g/mol, determined by GPC, preferably up to 500,000 g/mol.

In one embodiment of the present invention, the average alkoxylated polyalkylenimine are selected from ethoxylated α,ω-hexanediamines and ethoxylated and poly-propoxylated α,ω-hexanediamines, each with an average molecular weight Mₙ (number average) in the range of from 800 to 500,000 g/mol, preferably 1,000 to 30,000 g/mol.

Detergent formulations of the invention in one embodiment comprise one or more complexing agent other than EDTA, DTPA, MGDA and GLDA, e.g. citrate, phosphonic acid derivatives, for example the disodium salt of hydroxyethane-1,1-diphosphonic acid (“HEDP”), for example trisodium citrate, and phosphates such as STPP (sodium tripolyphosphate).

In one embodiment, the detergent formulation of the invention comprises a builder system comprising
ethylenediaminetetraacetic acid (EDTA) and/or diethylenetriaminepentaacetic acid (DTPA) and/or methylglycine diacetate (MGDA) and/or glutamic acid diacetate (GLDA), as disclosed above in amounts in the range of 0.1% to 25.0% by weight, in the range of 1.0% to 15.0% by weight, in the range of 3.0% to 10.0% by weight, or in the range of 2.5 to 10% by weight all relative to the total weight of the detergent formulation;
optionally citric acid in amounts in the range of 0.1% to 10.0% by weight, in the range of 0.5% to 8.0% by weight, in the range of 1.0% to 5.0% by weight, or in the range of 2.0% to 4% by weight, all relative to the total weight of the detergent formulation; the citric acid may be provided as a mixture with formiate, e.g. Na-citrate:Na-formiate=9:1;
optionally at least one phosphonate, preferably selected from derivatives polyphosphonic acids such as of diphosphonic acid such as sodium salt of HEDP, and derivatives of aminopolyphosphonic acid such as aminoalkylene phosphonic acids such as DTPMP in amounts in the range of 0.1% to 5.0% by weight, in the range of 0.5% to 3.0% by weight, or in the range of 1.0% to 2.0% by weight, all relative to the total weight of the detergent formulation;
optionally at least one polycarboxylate selected from homopolymers with the repeating monomer being the same unsaturated carboxylic acid, such as polyacrylic acid (PAA) and copolymers with the repeating monomers being at least two different unsaturated carboxylic acids, such as copolymers of acrylic acid with methacrylic acid, copolymers of acrylic acid or methacrylic acid and maleic acid and/or fumaric acid, in amounts in the range of 0% to 10% by weight, 0.5% to 7% by weight, 1.0% to 5% by weight, or 2.5% to 5.0% by weight, all relative to the total weight of the detergent formulation;

In one embodiment, detergent formulations of the invention comprise
methylglycine diacetate (MGDA) and/or glutamic acid diacetate (GLDA), as disclosed above in amounts in the range of 1% to 20% by weight, in the range of 2.5 to 15% by weight, or in the range of 2.5 to 12.5% by weight, all relative to the total weight of the detergent formulation;
preferably additionally citric acid and/or at least one phosphonate and/or at least one polycarboxylate;

In one embodiment of the present invention, the formulation according to the invention is free from phosphates and polyphosphates, with hydrogenphosphates being subsumed, for example free from trisodiumphosphate, pentasodiumtripolyphosphate and hexasodiummetaphosphate. In connection with phosphates and polyphosphates, in the context of the present invention, “free from” Is to be understood as meaning that the content of phosphate and polyphosphate is in total in the range from 10 ppm to 0.2% by weight, determined by gravimetry and relative to the total weight of the detergent formulation.

Liquid detergent formulations of the invention may comprise one or more corrosion inhibitors. In the present case, this is to be understood as including those compounds that inhibit the corrosion of metal. Non-limiting examples of suitable corrosion inhibitors include sodium silicate, triazoles such as benzotriazoles, bisbenzotriazoles, aminotriazoles, alkylaminotriazoles, phenol derivatives such as hydroquinone, pyrocatechol, hydroxyhydroquinone, gallic acid, phloroglucinol and pyrogallol, further polyethylenimine and salts of bismuth or zinc. Corrosion inhibitors may be formulated into liquid detergent formulations of the invention in amounts of 0.05 to 1.5% w/w relative to the overall weight of the liquid detergent formulation.

In one embodiment, detergent formulations comprising the components of the liquid compositions of the invention are liquid automated dishwashing detergents. The liquid compositions of the invention are preferably comprised in liquid automated dishwashing detergents in a weight ratio liquid composition:detergent of about 1:1000, 1:500, 1:100, 1:50, 1:30, 1.25, 1:20, or 1:10.

Usually, automated dishwashing detergents do not comprise anionic surfactants. Preferably, liquid automated dishwashing detergents of the invention comprise at least one non-ionic surfactant according to formula (IV), more preferably wherein R¹ is n-C₈ alkyl, R² is branched C₁₁ alkyl, AO is CH₂—CH₂—O, and x is 22. The automated dishwashing detergents preferably comprise such compounds in amounts in the range of about 0.3% to 10% by weight, in the range of about 0.5% to 5% by weight, or in the range of about 1% to 3%, all relative to the total weight of the liquid automated dishwashing detergent.

Preferably, automated dishwashing detergents comprises a builder system comprising
methylglycine diacetate (MGDA) and/or glutamic acid diacetate (GLDA), as disclosed above in amounts in the range of 1% to 20% by weight, in the range of 2.5 to 15% by weight, or in the range of 2.5 to 12.5% by weight, all relative to the total weight of the detergent formulation;
preferably additionally citric acid in amounts in the range of 0.1% to 10.0% by weight, in the range of 0.5% to 8.0% by weight, in the range of 1.0% to 5.0% by weight, or in the range of 2.0% to 4% by weight, all relative to the total weight of the detergent formulation; the citric acid may be provided as a mixture with formiate, e.g. Na-citrate:Na-formiate=9:1;
preferably additionally at least one phosphonate, preferably selected from derivatives polyphosphonic acids such as of diphosphonic acid such as sodium salt of HEDP, and derivatives of aminopolyphosphonic acid such as aminoalkylene phosphonic acids such as DTPMP in amounts in the range of 0.1% to 5.0% by weight, in the range of 0.5% to 3.0% by weight, or in the range of 1.0% to 2.0% by weight, all relative to the total weight of the detergent formulation;
preferably additionally at least one polycarboxylate selected from homopolymers with the repeating monomer being the same unsaturated carboxylic acid, such as polyacrylic acid (PAA) and copolymers with the repeating monomers being at least two different unsaturated carboxylic acids, such as copolymers of acrylic acid with methacrylic acid, copolymers of acrylic acid or methacrylic acid and maleic acid and/or fumaric acid, in amounts in the range of 0% to 10% by weight, 0.5% to 7% by weight, 1.0% to 5% by weight, or 2.5% to 5.0% by weight, all relative to the total weight of the detergent formulation;

In one embodiment, liquid automated dishwashing detergents of the invention, comprise at least one hydrolase as disclosed herein, preferably selected from at least one subtilisin protease and at least one alpha-amylase, both as disclosed herein. Preferably, at least one protease is comprised in amounts of about 0.10% to 0.25% by weight, relative to the total weight of the detergent formulation. At least one alpha-amylase preferably is comprised in amounts of about 0.002% to 0.015% by weight relative to the total weight of the detergent formulation.

In one embodiment of the present invention, detergent formulations, especially when used as automatic dishwashing detergents, may comprise at least one zinc salt. Zinc salts may be selected from water-soluble and water-insoluble zinc salts. In this connection, within the context of 20 the present invention, water-insoluble is used to refer to those zinc salts which, in distilled water at 25° C., have a solubility of 0.1 g/l or less. Zinc salts which have a higher solubility in water are accordingly referred to within the context of the present invention as water-soluble zinc salts.

The zinc salt may be selected from zinc benzoate, zinc gluconate, zinc lactate, zinc formate, ZnCl2, ZnSO4, zinc acetate, zinc citrate, Zn(NO3)2, Zn(CH3SO3)2 and zinc gallate, preferably ZnCl2, ZnSO4, zinc acetate, zinc citrate, Zn(NO3)2, Zn(CH3SO3)2 and zinc gallate.

In another embodiment of the present invention, zinc salt is selected from ZnO, ZnO·aq, Zn(OH)2 and ZnCO3. Preference is given to ZnO-aq.

In one embodiment of the present invention, zinc salt is selected from zinc oxides with an average particle diameter (weight-average) in the range from 10 nm to 100 μm.

The cation in zinc salt can be present in complexed form, for example complexed with ammonia ligands or water ligands, and in particular be present in hydrated form. To simplify the notation, within the context of the present invention, ligands are generally omitted if they are water ligands.

Depending on how the pH of mixture according to the invention is adjusted, zinc salt can change. Thus, it is for example possible to use zinc acetate or ZnCl2 for preparing formulation according to the invention, but this converts at a pH of 8 or 9 in an aqueous environment to ZnO, Zn(OH)2 or ZnO-aq, which can be present in non-complexed or in complexed form.

Zinc salt may be present in those inventive automatic dishwashing formulations which are solid at room temperature are preferably present in the form of particles which have for example a 10 average diameter (number-average) in the range from 10 nm to 100 μm, preferably 100 nm to 5 pm, determined for example by X-ray scattering.

Zinc salt may be present in those detergent formulation for home care applications that are liquid at room temperature in dissolved or in solid or in colloidal form.

In one embodiment of the present invention, inventive automatic dishwashing formulations comprise in total in the range from 0.05 to 0.4% by weight of zinc salt, based in each case on the solids content of the formulation in question. Herein, the fraction of zinc salt is given as zinc or zinc ions. From this, it is possible to calculate the counterion fraction.

Liquid detergent formulations of the invention may comprise at least one graft copolymer composed of
at least one graft base selected from nonionic monosaccharides, disaccharides, oligosaccharides and polysaccharides, and side chains obtained by grafting on of at least one ethylenically unsaturated mono- or dicarboxylic acid and
at least one compound of the general formula (XIV),

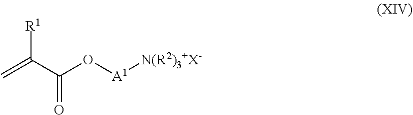

wherein the variables are defined as follows:
R¹ is selected from methyl and hydrogen,
A¹ is selected from C₂-C₄-alkylene,
R² are identical or different and selected from C₁-C₄-alkyl,
X⁻ is selected from halide, mono-C₁-C₄-alkyl sulfate and sulfate.

Liquid detergent formulations of the invention may comprise one or more buffers such as monoethanolamine and N,N,N-triethanolamine.

Liquid detergent formulations of the invention may be adapted in sudsing characteristics for satisfying various purposes. Hand dishwashing detergents usually request stable suds. Automatic dishwasher detergents are usually requested to be low-sudsing. Laundry detergents may range from high sudsing through a moderate or intermediate range to low. Low-sudsing laundry detergents are usually recommended for front-loading, tumbler-type washers and washer-dryer combinations. Those skilled in the art are familiar with using suds stabilizers or suds suppressors as detergent components in detergent formulations which are suitable for specific applications. Examples of suds stabilizers include but are not limited to alkanolamides and alkylamine oxides. Examples of suds suppressors include but are not limited to alkyl phosphates, silicones, paraffine oils, and soaps. Automatic dishwashing detergents may comprise suds suppressors in amounts in the range from 0.05% to 0.5% by weight relative to the total weight of the detergent.

In one embodiment, the detergent formulation, preferably a liquid detergent formulation of the invention comprises at least one low-sudsing surfactant selected from the group of nonionic surfactants which are modified either by degree of alkoxylation or by modified alkyl chain. Especially the low-sudsing and foam suppressing surfactants are used as an additional additive in ware washing or automatic dish washing formulations (ADW) and further I&I applications like bottle cleaning and dairy cleaning. In one embodiment, a low-sudsing surfactant according to the invention is selected from non-ionic surfactants according to formula (IV), wherein R¹ is n-C₃-C₁₇ alkyl, R² is linear or branched C₈-C₁₄ alkyl. Preferably AO is selected from —(CH₂CH₂O)ₓ₂—(CH₂CH(CH₃)—O)ₓ₃, —(CH₂CH₂O)ₓ₂—(CH(CH₃)CH₂—O)ₓ₃, and —(CH₂CH₂O)ₓ₄, wherein x2 and x4 is a number in the range of 15-50 and x3 is a number in the range of 1 to 15.

Liquid detergent formulations may comprise at least one compound selected from organic solvents, preservatives, viscosity modifiers, hydrotropes, fragrances, dyestuffs, buffers, disintegrants for tabs, and/or acids such as methylsulfonic acid.

Liquid detergent formulations of the invention may comprise one or more fragrances such as benzyl salicylate, 2-(4-tert.-butylphenyl) 2-methylpropional, commercially available as Lilial®, and hexyl cinnamaldehyde.

Liquid detergent formulations of the invention may comprise one or more dyestuffs such as Acid Blue 9, Acid Yellow 3, Acid Yellow 23, Acid Yellow 73, Pigment Yellow 101, Acid Green 1, Solvent Green 7, and Acid Green 25.

In one embodiment of the present invention, liquid detergent formulations comprise amounts of organic solvents are 0.5 to 25% by weight, relative to the total weight of the liquid detergent formulation. Especially when inventive liquid detergent formulations are provided in pouches or the like, 8 to 25% by weight of organic solvent(s) relative to the total weight of the liquid detergent formulation may be comprised. Organic solvents are those disclosed above in the context of component (d).

In one embodiment of the present invention, liquid detergent formulations comprise one or more hydrotropes which may be organic solvents such as ethanol, isopropanol, ethylene glycol, 1,2-propylene glycol, and further organic solvents that are water-miscible under normal conditions without limitation. Further examples of suitable hydrotropes are the sodium salts of toluene sulfonic acid, of xylene sulfonic acid, and of cumene sulfonic acid. Hydrotropes may be comprised in amounts that facilitate or enables the dissolution of compounds that exhibit limited solubility in water.

Inventive liquid detergent formulations may comprise one or more preservatives selected from those disclosed above (see component (d)) in amounts effective in avoiding microbial contamination of the liquid detergent formulation.

In one embodiment, a liquid detergent formulation of the invention comprises at least one preservative selected from the group consisting of 2-phenoxyethanol, glutaraldehyde, 2-bromo-2-nitropropane-1,3-diol, and formic acid in acid form or as its salt, and 4,4′-dichloro 2-hydroxydiphenylether. The liquid detergent formulation may comprise at least one preservative in amounts ranging from 2 ppm to 5% by weight relative to the total weight of the detergent formulation. The liquid detergent formulation of the invention may comprise phenoxyethanol in amounts ranging from 0.1% to 2% by weight relative to the total weight of the detergent formulation. The liquid detergent formulation of the invention may comprise 2-bromo-2-nitropropane-1,3-diol in amounts ranging from 20 ppm to 1000 ppm. The liquid detergent formulation of the invention may comprise glutaraldehyde in amounts ranging from 10 ppm to 2000 ppm. The liquid detergent formulation of the invention may comprise formic acid and/or formic acid salt in amounts ranging from 0.05% to 0.5% by weight relative to the total weight of the detergent formulation. The liquid detergent formulation of the invention may comprise 4,4′-dichloro 2-hydroxydiphenylether in amounts ranging from 0.001% to 3% by weight, 0.002% to 1% by weight, or 0.01% to 0.6% by weight, all relative to the total weight of the detergent formulation.

In one embodiment of the present invention, liquid detergent formulations comprise one or more viscosity modifiers. Depending on the physical form, detergent formulations of the invention may comprise one or more rheology modifiers, which may be called thickener herein. “Thickener(s)” according to the invention are selected from the following:

Polymeric Structuring Agents:

Non-limiting examples of naturally derived polymeric structurants include hydroxyethyl cellulose, hydrophobically modified hydroxyethyl cellulose, carboxymethyl cellulose, polysaccharide derivatives, and mixtures thereof. Suitable polysaccharide derivatives include but are not limited to pectine, alginate, arabinogalactan (gum Arabic), carrageenan, gellan gum, xanthan gum, guar gum and mixtures thereof.

Non-limiting examples of synthetic polymeric structurants include: polycarboxylates, polyacrylates, hydrophobically modified ethoxylated urethanes, hydrophobically modified non-ionic polyols and mixtures thereof. A polycarboxylate polymer may for example be polyacrylate, polymethacrylate or mixtures thereof. The polyacrylate may be for example a copolymer of unsaturated mono- or di-carbonic acid and C₁-C₃₀ alkyl ester of the (meth)acrylic acid.

Di-Benzylidene Polyol Acetal Derivative

A formulation according to the invention may comprise one or more dibenzylidene polyol acetal derivatives (DBPA). The DBPA derivative may comprise a dibenzylidene sorbitol acetal derivative (DBS). Said DBS derivative may be selected from the group consisting of: 1,3:2,4-dibenzylidene sorbitol; 1,3:2,4-di(p-methylbenzylidene) sorbitol; 1,3:2,4-di(p-chlorobenzylidene) sorbitol; 1,3:2,4-di(2,4-dimethyldibenzylidene) sorbitol; 1,3:2,4-di (p-ethyl-benzylidene) sorbitol; 1,3:2,4-di(3,4-dimethyldibenzylidene) sorbitol; and mixtures thereof.

Di-Amido-Gellants

In one aspect, the external structuring system may comprise a di-amido gellant having a molecular weight from about 150 g/mol to about 1,500 g/mol, or even from about 500 g/mol to about 900 g/mol. Such di-amido gellants may comprise at least two nitrogen atoms, wherein at least two of said nitrogen atoms form amido functional substitution groups. In one aspect, the amido groups are different. In another aspect, the amido functional groups are the same. The di-amido gellant has the following formula (XV):

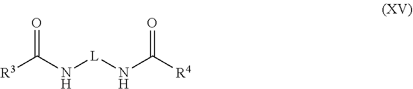

wherein the variables of the di-amido gellant in formula (XV) are defined as follows:
R³ and R⁴ is an amino functional end-group, or even amido functional end-group, in one aspect R³ and R⁴ may comprise a pH-tunable group, wherein the pH-tunable amido-gellant may have a pKa of from about 1 to about 30, or even from about 2 to about 10. In one aspect, the pH tunable group may comprise a pyridine. In one aspect, R³ and R⁴ may be different. In another aspect, R³ and R⁴ may be the same.
L is a linking moiety of molecular weight from 14 to 500 g/mol. In one aspect, L may comprise a carbon chain comprising between 2 and 20 carbon atoms. In another aspect, L may comprise a pH-tunable group. In one aspect, the pH-tunable group is a secondary amine. In one aspect, at least one of R³, R⁴ or L may comprise a pH-tunable group.

Bacterial Cellulose

The term “bacterial cellulose” encompasses any type of cellulose produced via fermentation of a bacteria of the genus Acetobacter such as CELLULON® by CPKelco U.S. and includes materials referred to popularly as microfibrillated cellulose, reticulated bacterial cellulose, and the like. In one aspect, said fibres may have cross sectional dimensions of 1.6 nm to 3.2 nm by 5.8 nm to 133 nm. Additionally, the bacterial cellulose fibres may have an average microfibre length of at least about 100 nm, or from about 100 to about 1,500 nm. In one aspect, the bacterial cellulose microfibres may have an aspect ratio, meaning the average microfibre length divided by the widest cross sectional microfibre width, of from about 100:1 to about 400:1, or even from about 200:1 to about 300:1.

In one aspect of the invention, the bacterial cellulose is at least partially coated with a polymeric structuring agents (see i. above). In one aspect the at least partially coated bacterial cellulose comprises from about 0.1% to about 5% w/w, or even from about 0.5% to about 3% w/w of bacterial cellulose relative to the total weight of the detergent formulation. Suitable bacterial cellulose may include the bacterial cellulose described above and suitable polymeric structuring agents include carboxymethylcellulose, cationic hydroxymethylcellulose, and mixtures thereof.

Cellulose Fibers Non-Bacterial Cellulose Derived

Cellulosic fibers may be extracted from vegetables, fruits or wood. Commercially available examples are Avicel® from FMC, Citri-Fi from Fiberstar or Betafib from Cosun.

Non-Polymeric Crystalline Hydroxyl-Functional Materials

In one aspect of the invention, the formulation may comprise non-polymeric crystalline, hydroxyl functional structurants. Said non-polymeric crystalline, hydroxyl functional structurants may comprise a crystallizable glyceride which can be pre-emulsified to aid dispersion into the final liquid detergent formulation. In one aspect, crystalizable glycerides may include hydrogenated castor oil or “HCO” or derivatives thereof, provided that it is capable of crystallizing in the liquid detergent formulation.

In one embodiment, the detergent formulation of the invention comprises at least one naturally derived polymeric structurant, preferably selected from polysaccharide derivatives such as xanthan gum in amounts in the range of 0.1% to about 1% by weight, or even from about 0.2% to about 0.5% by weight, relative to the total weight of the detergent formulation.

In one embodiment of the present invention, the formulation according to the invention is free from those heavy metal compounds apart from zinc compounds. Within the context of the present, this may be understood as meaning that inventive compositions are free from those heavy metal compounds which do not act as bleach catalysts, in particular from compounds of iron. In connection with heavy metal compounds in the context of the present invention, “free from” is to be understood as meaning that the content of heavy metal compounds which do not act as bleach catalysts is in total in the range from 0 to 100 ppm, preferably 1 to 30 ppm, determined by the Leach method. Preferably, detergent formulations according to the invention have, apart from zinc, a heavy metal content below 0.05 ppm, based on the solids content of the formulation in question. In the context of the present Invention, “heavy metals” are all metals with a specific density of at least 6 g/cm³, with the exception of zinc and bismuth. In particular, the heavy metals are metals such as bismuth, iron, copper, lead, tin, nickel, cadmium and chromium. Preferably, inventive automatic dishwashing formulations comprise no measurable fractions of bismuth compounds, i.e. for example less than 1 ppm.

When inventive liquid detergent formulations are provided in compartmented pouches or the like, the compartment comprising the liquid enzyme preparation of the invention is provided separated from the compartment comprising bleaches, such as inorganic peroxide compounds or chlorine bleaches such as sodium hypochlorite. In one embodiment, the compartment comprising the liquid enzyme preparation also comprises at least one complexing agent such as EDTA and/or DTPA and/or MGDA and/or GLDA, wherein MGDA and GLDA are as disclosed above.

In one embodiment, liquid detergent formulations of the invention are free from bleaches, for example free from inorganic peroxide compounds or chlorine bleaches such as sodium hypochlorite, meaning that liquid detergent formulations according to the invention comprise in total 0.8%, 0.5%, 0.1% or 0.01% by weight or less of inorganic peroxide compound and chlorine bleach, relative in each case on total weight of the liquid detergent formulation.

Enzyme Stabilization

The invention relates to a method of stabilizing at least one hydrolase comprised in component (a) by the step of adding an enzyme stabilizing system [component (b)] and optionally at least one diol (component (c)), wherein components (a) and (b) and (c) are those disclosed above. In one embodiment, component (a) is liquid. In one embodiment, the invention relates to a method of stabilizing component (a) by the step of adding component (b) and optionally component (c), wherein component (a) comprises at least one protease and/or at least one amylase and/or at least one lipase and/or at least one cellulase and/or at least one mannanase. In one embodiment, the enzyme stabilization is improved by adding component (c) to components (a) and (b), when compared to enzyme stabilization in the absence of component (c). The enzyme stability is improved when compared to a mixture lacking component (c).

In one embodiment, the enzyme stabilization is improved by adding a mixture of component (c) and component (d) to components (a) and (b), when compared to enzyme stabilization in the absence of component (c). The enzyme stability is improved when compared to a mixture lacking components (c) and (d).

In one embodiment, component (c) comprises at least one diol selected from diols having terminal —OH groups containing 3 to 10 C-atoms, preferably 4 to 8 C-atoms; said diol may be selected from 1,4-butanediol, 1,6-hexanediol and 1,8-octanediol. In one embodiment, component (c) comprises a mixture of 1,6-hexanediol and at least one diols having vicinally positioned —OH as disclosed above, preferably selected from 1,2-butan diol and 1,2-pentandiol, wherein the weight ratio of 1,6-hexane diol to the diol having vicinally positioned —OH is 10:1, 9:1, 8:1, 7:1, or 6:1, preferably within the range of 6:1 to 8:1, more preferably within the range of 7:1 to 6:1, most preferably 6.75:1

In one embodiment, component (d) comprises at least one organic solvent, preferably selected from 1,2-propane diol and polyethylene glycol methyl ether.

In a preferred embodiment, component (d) and component (c) are present in a weight ratio of about 1:2 to about 1:3.3, wherein component (c) comprises at least 1,6-hexanediol.

In one embodiment, at least one protease comprised in component (a) is stabilized, wherein the protease is selected from the group of subtilisin proteases (EC 3.4.21.62), preferably from
a protease according to SEQ ID NO:22 as described in EP 1921147 or variants thereof having proteolytic activity, preferably a protease 80% similar and/or identical to SEQ ID NO:22 as described in EP 1921147 having R101E, and
a protease selected from subtilisin 309 as disclosed in Table I a) of WO 89/06279 or variants thereof having proteolytic activity.

In one embodiment, at least one amylase comprised in component (a) is stabilized wherein at least one amylase is selected from alpha-amylases (EC 3.2.1.1) as disclosed above, more preferably at least one amylase is selected from
amylase from Bacillus sp. 707 or variants thereof having amylolytic activity, preferably selected from amylases having SEQ ID NO:6 as disclosed in WO 99/19467 and variants thereof having amylolytic activity;
amylase selected from those comprising amino acids 1 to 485 of SEQ ID NO:2 as described in WO 00/60060 those having SEQ ID NO: 12 as described in WO 2006/002643, and variants thereof having amylolytic activity;
amylase from Bacillus halmapalus or variants thereof having amylolytic activity, preferably selected from amylases having SEQ ID NO: 1 and 2 as disclosed in WO 2013/001078; having SEQ ID NO:6 as described in WO 2011/098531; and variants thereof having amylolytic activity;
amylase from Bacillus amyloliquefaciens or variants thereof having amylolytic activity, preferably selected from amylases according to SEQ ID NO: 3 of WO 2016/092009;
hybrid amylases according to WO 2014/183920 with A and B domains having at least 90% similarity and/or identity to SEQ ID NO:2 of WO 2014/183920 and a C domain having at least 90% similarity and/or identity to SEQ ID NO:6 of WO 2014/183920, wherein the hybrid amylase has amylolytic activity; preferably the hybrid alpha-amylase is at least 95% similar and/or identical to SEQ ID NO: 23 of WO 2014/183920 and having amylolytic activity;
hybrid amylase according to WO 2014/183921 with A and B domains having at least 75% similarity and/or identity to SEQ ID NO: 2, SEQ ID NO: 15, SEQ ID NO: 20, SEQ ID NO: 23, SEQ ID NO: 29, SEQ ID NO: 26, SEQ ID NO: 32, and SEQ ID NO: 39 as disclosed in WO 2014/183921 and a C domain having at least 90% similarity and/or identity to SEQ ID NO: 6 of WO 2014/183921, wherein the hybrid amylase has amylolytic activity; preferably, the hybrid alpha-amylase is at least 95% similar and/or identical to SEQ ID NO: 30 as disclosed in WO 2014/183921 and having amylolytic activity.

In one embodiment, at least one lipase comprised in component (a) is stabilized wherein at least one lipase may be Thermomyces lanuginosus lipase selected from variants having lipolytic activity which are at least 90%, at least 91%, at least 92%, at least 93%, at least 94%, at least 95%, at least 96%, at least 97%, at least 98% or at least 99% similar and/or identical when compared to the full-length polypeptide sequence of amino acids 1-269 of SEQ ID NO:2 of U.S. Pat. No. 5,869,438. Preferably, said Thermomyces lanuginosus lipase comprises conservative mutations only, which do however not pertain the functional domain of amino acids 1-269 of SEQ ID NO:2 of U.S. Pat. No. 5,869,438. Said Thermomyces lanuginosus lipase may be characterized by having at least amino acid substitutions T231R and N233R within SEQ ID NO:2 of U.S. Pat. No. 5,869,438.

In one embodiment, at least one enzyme comprised in component (a) is stabilized in the presence of at least one surfactant by adding the enzyme preparation of the invention or at least component (b), preferably additionally component (c), preferably additionally component (d) is added to at least one surfactant, wherein at least one surfactant is selected from non-ionic surfactants, amphoteric surfactants, anionic surfactants, and cationic surfactants, all as described herein. In one embodiment, the surfactant is part of a liquid formulation, preferably a liquid detergent formulation. The components of the enzyme preparations of the invention in one embodiment are added separately to the surfactant or the detergent formulation.

Stabilization of an enzyme preferably relate to stability in the course of time (e.g. storage stability), thermal stability, pH stability, and chemical stability. The term “enzyme stability” herein preferably relates to the retention of enzymatic activity as a function of time e.g. during storage or operation. The term “storage” herein means to indicate the fact of products or compositions or formulations being stored from the time of being manufactured to the point in time of being used in final application. Retention of enzymatic activity as a function of time during storage is called “storage stability”. In one embodiment, storage means storage for at least 20 days at 37° C. Storage may mean storage for 21, 28, or 42 days at 37° C.

To determine changes in enzymatic activity over time, the “initial enzymatic activity” of an enzyme may be measured under defined conditions at time zero (i.e. before storage) and the “enzymatic activity after storage” may be measured at a certain point in time later (i.e. after storage).

The enzymatic activity after storage divided by the initial enzymatic activity multiplied by 100 gives the “residual enzymatic activity” (a %).

An enzyme is stable according to the invention, when its residual enzymatic activity is at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, at least 99.5% or 100% when compared to the initial enzymatic activity before storage.

Subtracting a % from 100% gives the “loss of enzymatic activity during storage” when compared to the initial enzymatic activity before storage. In one embodiment, an enzyme is stable according to the invention when essentially no loss of enzymatic activity occurs during storage, i.e. loss in enzymatic activity equals 0% when compared to the initial enzymatic activity before storage. Essentially no loss of enzymatic activity within this invention may mean that the loss of enzymatic activity is less than 30%, less than 25%, less than 20%, less than 15%, less than 10%, less than 9%, less than 8%, less than 7%, less than 6%, less than 5%, less than 4%, less than 3%, less than 2%, or less than 1% when compared to the initial enzymatic activity before storage.

In one aspect of the invention at least one enzyme comprised in component (a) shows reduced loss of enzymatic activity during storage in the presence of components (b) and (c) and optionally (d) when compared to the same enzyme in the presence of component (b) only. In one embodiment, at least one enzyme comprised in component (a) shows reduced loss of enzymatic activity during storage in the presence of components (b) and (c) and optionally (d) when compared to the same enzyme in the presence of component (bi) only. In one embodiment, at least one enzyme comprised in component (a) shows reduced loss of enzymatic activity during storage in the presence of components (b) and (c) and optionally (d) when compared to the same enzyme in the absence of component (c) and optionally (d).

In one embodiment, component (c) comprises at least one diol selected from diols having terminal —OH groups containing 3 to 10 C-atoms, preferably 4 to 8 C-atoms; said diol may be selected from 1,4-butanediol, 1,6-hexanediol and 1,8-octanediol. In one embodiment, component (c) comprises a mixture of 1,6-hexanediol and at least one diols having vicinally positioned —OH as disclosed above, preferably selected from 1,2-butan diol and 1,2-pentandiol, wherein the weight ratio of 1,6-hexane diol to the diol having vicinally positioned —OH is 10:1, 9:1, 8:1, 7:1, or 6:1, preferably within the range of 6:1 to 8:1, more preferably within the range of 7:1 to 6:1, most preferably 6.75:1.

In one embodiment, component (d) comprises at least one organic solvent, preferably selected from 1,2-propane diol and polyethylene glycol methyl ether.

In a preferred embodiment, component (d) and component (c) are present in a weight ratio of about 1:2 to about 1:3.3, wherein component (c) comprises at least 1,6-hexanediol.

Calculation of % reduced loss of enzymatic activity is done as follows: (% loss of enzymatic activity of stabilized enzyme)−(% loss of enzymatic activity of non-stabilized enzyme).

Reduced loss of enzymatic activity within this invention may mean that the loss of enzymatic activity is reduced in the presence of component (a) by at least 5%, by at least 10%, by at least 15%, by at least 20%, by at least 25%, by at least 30%, by at least 40%, by at least 50%, by least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or at least 99.5%, when compared to the loss of enzymatic activity in the absence of component (a).

Enzyme stabilization occurs in one aspect within a liquid formulation comprising at least one surfactant, preferably within a liquid detergent formulation. Stabilization in this context may mean stabilization during storage at 37° C. for 21, 28 and/or 42 days.

In one aspect of the invention, at least one subtilisin protease is stabilized in the presence of components (b) and (c) when compared to the protease in the presence of component (b) only, In one embodiment, at least one subtilisin protease is stabilized in the presence of components (b) and (c) when compared to the protease in the presence of component (bii) only. Preferably the subtilisin protease shows residual proteolytic activity after storage of ≥72%, ≥75%, or ≥80%, when compared to the initial proteolytic activity before storage at 37° C. for up to 42 days. In one embodiment, the subtilisin protease is selected from subtilisin 147 and/or 309 as disclosed in WO 89/06279 or variants thereof having proteolytic activity, subtilisin from Bacillus lentus as disclosed in WO 91/02792 or variants thereof having proteolytic activity, and subtilisin according to SEQ ID NO:22 as described in EP 1921147 or variants thereof having proteolytic activity.

In one aspect of the invention, at least one alpha amylase is stabilized in the presence of components (b) and (c) when compared to the protease in the presence of component (b) only. In one embodiment, at least one subtilisin protease is stabilized in the presence of components (b) and (c) when compared to the protease in the presence of component (bii) only. Preferably the alpha amylase shows residual amylolytic activity after storage of ≥60%, ≥70%, or ≥80%, when compared to the initial proteolytic activity before storage at 37° C. for up to 42 days. In one embodiment said alpha amylase is selected from
a amylase from Bacillus sp. 707 or variants thereof having amylolytic activity, preferably selected from amylases having SEQ ID NO:6 as disclosed in WO 99/19467 and variants thereof having amylolytic activity;
a amylase selected from those comprising amino acids 1 to 485 of SEQ ID NO:2 as described in WO 00/60060 those having SEQ ID NO: 12 as described in WO 2006/002643, and variants thereof having amylolytic activity;
a amylase from Bacillus halmapalus or variants thereof having amylolytic activity, preferably selected from amylases having SEQ ID NO: 1 and 2 as disclosed in WO 2013/001078; having SEQ ID NO:6 as described in WO 2011/098531; and variants thereof having amylolytic activity;
a amylase from Bacillus amyloliquefaciens or variants thereof having amylolytic activity, preferably selected from amylases according to SEQ ID NO: 3 of WO 2016/092009;
hybrid amylases according to WO 2014/183920 with A and B domains having at least 90% identity to SEQ ID NO:2 of WO 2014/183920 and a C domain having at least 90% identity to SEQ ID NO:6 of WO 2014/183920, wherein the hybrid amylase has amylolytic activity; preferably the hybrid alpha-amylase is at least 95% identical to SEQ ID NO: 23 of WO 2014/183920 and having amylolytic activity;
a hybrid amylase according to WO 2014/183921 with A and B domains having at least 75% identity to SEQ ID NO: 2, SEQ ID NO: 15, SEQ ID NO: 20, SEQ ID NO: 23, SEQ ID NO: 29, SEQ ID NO: 26, SEQ ID NO: 32, and SEQ ID NO: 39 as disclosed in WO 2014/183921 and a C domain having at least 90% identity to SEQ ID NO: 6 of WO 2014/183921, wherein the hybrid amylase has amylolytic activity; preferably, the hybrid alpha-amylase is at least 95% identical to SEQ ID NO: 30 as disclosed in WO 2014/183921 and having amylolytic activity.

The stabilization of at least one enzyme as disclosed above preferably occurs in the presence of components (b) and (c), wherein
component (bi) is selected from triethylcitrate, tributylcitrate, and acetoxytriethylcitrate; preferably triethlcitrate;
component (bii) is selected from 4-FPBA and a peptide stabilizer according to formula (Db) characterized in R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Leu; and the N-terminal protection group Z is benzyloxycarbonyl (Cbz);
component (c) comprises at least one diol selected from
diols having terminal —OH groups containing 3 to 10 C-atoms, preferably 4 to 8 C-atoms, preferably selected from 1,4 butanediol, 1,6 hexanediol and 1,8 octanediol; and a combination of at least two diols, wherein the first diol is selected from diols having terminal —OH groups containing 3 to 10 C-atoms, preferably 4 to 8 C-atoms, more preferably selected from 1,4 butanediol, 1,6 hexanediol and 1,8 octanediol; and a second diol is selected from diols having vicinally positioned —OH groups containing 4 to 10 C-atoms, preferably 4 to 8 C-atoms, more preferably 4 to 6 C-atoms, most preferably 4 to 5 C-atoms; especially preferably selected from 1,2 butandiol and 1,2 pentandiol.

In one embodiment, component (c) comprises at least one diol selected from diols having terminal —OH groups containing 3 to 10 C-atoms, preferably 4 to 8 C-atoms; said diol may be selected from 1,4-butanediol, 1,6-hexanediol and 1,8-octanediol. In one embodiment, component (c) comprises a mixture of 1,6-hexanediol and at least one diols having vicinally positioned —OH as disclosed above, preferably selected from 1,2-butan diol and 1,2-pentandiol, wherein the weight ratio of 1,6-hexane diol to the diol having vicinally positioned —OH is 10:1, 9:1, 8:1, 7:1, or 6:1, preferably within the range of 6:1 to 8:1, more preferably within the range of 7:1 to 6:1, most preferably 6.75:1.

In one embodiment, the stabilization of at least one enzyme as disclosed above preferably occurs in the presence of components (b) and (c) and (d). Preferably, component (d) comprises at least one organic solvent, preferably selected from 1,2-propane diol and polyethylene glycol methyl ether. In a preferred embodiment, component (d) and component (c) are present in a weight ratio of about 1:2 to about 1:3.3, wherein component (c) comprises at least 1,6-hexanediol.

### EXAMPLES

The invention will be further illustrated by working examples.

General remarks: percentages are weight percent unless specifically noted otherwise.

Tested Compounds

Compounds according to formula (A)—(component (b) as disclosed above):
a.1 Triethylcitrate—purchased from Sigma Aldrich
a.2 Tributylcitrate—purchased from Sigma Aldrich
a.3 Acetoxytriethylcitrate—purchased from Sigma Aldrich

Storage Stability of Enzyme Preparation

Enzyme preparations have been produced by mixing of the ingredients according to Table 1 below.

TABLE 1
liquid enzyme preparation (EP)

| | EP | | | | | |
|---|---|---|---|---|---|---|
| | EP-I. | EP-II. | EP-III. | EP-IV. | EP-V. | EP-VI. |
| Ingredients | wt % in formulation | | | | | |
| protease | 4.8 | 4.8 | 4.8 | 4.8 | 4.8 | 4.8 |
| MPEG | 41 | 29 | 29 | 29 | 29 | 14 |
| Triethylcitrate | 25 | 25 | 25 | 25 | 25 | 25 |
| Peptidealdehyde | 0.3 | 0.3 | 0.3 | 0.3 | 0.3 | 0.3 |
| 1,2 Pentandiol | — | 12 | — | — | — | — |
| 1,4 Butanediol | — | — | 12 | — | — | 27 |
| 1,6 Hexanediol | — | — | — | 12 | — | — |
| 1,8 Octanediol | — | — | — | — | 12 | — |

| | |
|---|---|
| balance | Water to 100 after adjust pH 5.8 with citric acid |

| | EP | | | | | |
|---|---|---|---|---|---|---|
| | EP-VII. | EP-VIII. | EP-IX. | EP-X. | EP-XI. | EP-XII. |
| Ingredients | wt % in formulation | | | | | |
| protease | 4.8 | 4.8 | 4.8 | 4.8 | 4.8 | 4.8 |
| MPEG | 14 | 14 | 29 | 10 | 10 | 14 |
| Triethylcitrate* | 25 | 25 | 25 | 25 | 25 | 25 |
| Peptidealdehyde | 0.3 | 0.3 | 0.3 | 0.3 | 0.3 | — |
| 1,2 Pentandiol | — | — | — | 4 | — | — |
| 1,6 Hexanediol | 27 | — | — | 27 | 27 | 27 |
| 1,8 Octanediol | — | 27 | — | — | — | — |
| 1,2 Butandiol | — | | 12 | — | 4 | — |
| 4-FPBA | | | | | | 0.3 |

| | |
|---|---|
| balance | Water to 100 after adjust pH 7.5 with citric acid |

| | EP | | |
|---|---|---|---|
| | EP-XIII. | EP-XIV. | EP-XV. |
| Ingredients | wt % in formulation | | |
| protease | 4.8 | 4.8 | 4.8 |
| MPEG | 14 | 14 | 29 |
| Tributylcitrate* | 25 | 25 | 25 |
| Peptidealdehyde | 0.3 | 0.3 | 0.3 |
| 1,2 Pentandiol | — | — | 12 |
| 1,6 Hexanediol | 27 | — | — |
| 1,8 Octanediol | — | 27 | — |

| | |
|---|---|
| balance | Water to 100 after adjust pH 7.5 with citric acid |

| | EP | | |
|---|---|---|---|
| | EP-XVI | EP-XVII | EP-XVIII |
| Ingredients | wt % in formulation | | |
| protease | 4.8 | 4.8 | 4.8 |
| MPEG | 10 | 10 | 14 |
| Acetoxytriethylcitrate* | 25 | 25 | 25 |
| Peptidealdehyde | 0.3 | 0.3 | — |
| 1,2 Pentandiol | 12 | — | — |
| 1,6 Hexanediol | — | 27 | 27 |
| 1,2 Butandiol | — | 4 | — |
| 4-FPBA | | | 0.3 |

| | |
|---|---|
| balance | Water to 100 after adjust pH 7.5 with citric acid |

Protease used: SEQ ID NO: 22 as described in EP 1921147 having the mutation R101E (according to BPN′ numbering).
Peptidealdehyde used: Cbz-Val-Ala-Leu-H (formula (Db): Z═Cbz, R¹ is a group such that NH—CHR¹—CO is an L or D-amino acid residue of Val, R² is a group such that NH—CHR²—CO is an L or D-amino acid residue of Ala, and R³ is a group such that NH—CHR³—CO is an L or D-amino acid residue of Leu).
The formulations EP - . . . according to Table 1 were stored at 8° C., 20° C. and 37° C. for 6 weeks and evaluated qualitatively for turbidity and phase separation (see Table 2).
*Compound according to formula (A) as disclosed above

TABLE 2
optical evaluation of enzyme preparations A

| | EP-I. | EP-II. | EP-III. | EP-IV | EP-V | EP-VI. |
|---|---|---|---|---|---|---|
| Optical evaluation | −− | − | 0 | + | + | + |
| | EP-VII. | EP-VIII. | EP-IX. | EP-X. | EP-XI. | EP-XII. |
| Optical evaluation | ++ | ++ | 0 | ++ | ++ | ++ |
| | EP-XIII. | EP-XIV. | EP-XV. | EP-XVI. | EP-XVII. | EP-XVIII. |
| Optical evaluation | ++ | ++ | 0 | − | ++ | ++ |

−− immediate turbidity; phase separation within 12 h;
− turbidity and minor phase separation within 72 h;
0 slight turbidity, no phase separation between 8° C. and 37° C.
+ opalescence or slight turbidity
++ remains clear, no phase separation at storage between 8° C. and 37° C. for more than 6 months

Enzyme Stability in Liquid Detergent Formulations

The enzyme preparations of 11. Have been formulated into detergent formulations (DF) according to Table 3.

TABLE 3
liquid detergent formulation

| | Detergent formulation: | | | |
|---|---|---|---|---|
| | DF-I. | DF-II. | DF-III. | DF-IV |
| Ingredients | wt % in formulation | | | |
| (Comp. 1) | 20 | 15 | 10 | — |
| (Comp. 2) | — | 5 | — | 20 |
| (Comp. 3) | — | — | 15 | 10 |
| (Comp. 4) | 5 | 2.5 | 5 | 5 |
| (Comp. 5) | 5 G | 5 P | 5 G | 5 P |
| (Comp. 6) | 2.5 | 2.0 | 2.5 | 2.5 |
| (Comp. 7) | — | 1 | — | 2 |
| (Comp. 8) | 0.3 | 0.3 | 0.3 | 0.3 |
| Additives: | | | | |
| Amylase * | 0.5 Amy1 | 0.5 Amy3 | 0.5 Amy1 | 0.5 Amy2 |
| Enzyme preparation | 3.5 | 3.5 | 3.5 | 3.5 |
| EP- . . . | | | | |

| | |
|---|---|
| balance | Water to 100 after adjust pH 8.0 with citric acid |

(Comp. 1): MGDA 50% solution (Trilon M Max Liquid)
(Comp. 2): Citric acid
(Comp. 3): GLDA 50% solution
(Comp. 4): PAA, Polyacrylic acid Mw 5.000 g/mol (homo-polyacrylic acid)
(Comp. 5): Glycerol (G) or Propanediol (P)
(Comp. 6): non-ionic surfactant according to formula (IV), wherein R¹ is n-C₈ alkyl, R² is branched C₁₁ alkyl, AO is CH₂—CH₂—O, and x is 22.
(Comp. 7): Na₄HEDP
(Comp. 8): Thickener xanthan gum
Amy1 = Stainzyme,
Amy2 = Amplify,
Amy3 = Stainzyme Plus L (12L)

The liquid detergent formulations were stored at a temperature of 37° for 8 weeks (42 days). This corresponds to a storage of approximately 9 months at room temperature or >15 month at 8° C.

The amylase activity after storage was measured quantitatively by the release of the chromophore para-nitrophenol (pNP) from the substrate (Ethyliden-blocked-pNPG7, Roche Applied Science 10880078103). The alpha-amylase degrades the substrate into smaller molecules and α-glucosidase (Roche Applied Science 11626329103), which is present in excess compared to the α-amylase, process these smaller products until pNP is released; the release of pNP, measured via an increase of absorption at 405 nm, is directly proportional to the α-amylase activity of the sample. Amylase standard: Termamyl 120 L (Sigma 3403).

The protease activity after storage was analyzed by measuring the reactivity towards the peptidic substrate Suc-AAPF-pNA. Here pNA is cleaved from the substrate molecule at 30° C., pH 8.6 using 100 mM TRIS buffer. The rate of cleavage, directly proportional to the protease activity, can be determined by the increase of the yellow color of free pNA in the solution by measuring OD₄₀₅, the optical density at 405 nm.

Table 4 displays amylase and protease activity measured in liquid formulations before and after storage for 42 days at 37° C. The amylolytic and proteolytic activity values provided were calculated referring to the value determined in the reference formulation at the time 0, in which the compound according to formula (A) (part of component(b)) and diol (component (c)) are missing.

TABLE 4
protease and amylase activity before and after 42 d storage
at 37° C.; Enz: enzyme solution containing 4.8% protease
stabilized with 0.3% peptide aldehyde in aqueous solution.

| Formulation identifier | | | |
|---|---|---|---|
| Detergent | Enzyme | amylase | protease |

| formulation | preparation | T0 | 42 d | T0 | 42 d |
|---|---|---|---|---|---|
| DF-I. | Enz | 100 | 38 | 100 | 71 |
| DF-I. | EP-I. | 92 | 24 | 98 | 64 |
| DF-I. | EP-II. | 94 | 32 | 98 | 69 |
| DF-I. | EP-III. | 97 | 41 | 98 | 70 |
| DF-I. | EP-IV. | 97 | 59 | 99 | 78 |
| DF-I. | EP-V. | 98 | 69 | 100 | 82 |
| DF-I. | EP-VI. | 97 | 63 | 99 | 81 |
| DF-I. | EP-VII. | 98 | 78 | 100 | 88 |
| DF-I. | EP-VIII. | 98 | 75 | 100 | 84 |
| DF-I. | EP-IX. | 92 | 38 | 97 | 69 |
| DF-I. | EP-X. | 96 | 77 | 98 | 88 |
| DF-I. | EP-XI. | 97 | 73 | 99 | 85 |
| DF-I. | EP-XII. | 98 | 74 | 100 | 86 |
| DF-I. | EP-XIII. | 98 | 69 | 100 | 79 |
| DF-I. | EP-XIV. | 97 | 66 | 97 | 72 |
| DF-I. | EP-XV. | 96 | 51 | 98 | 69 |
| DF-I. | EP-XVII. | 97 | 72 | 99 | 83 |
| DF-II. | Enz | 100 | 38 | 100 | 70 |
| DF-II. | EP-I. | 93 | 22 | 96 | 62 |
| DF-II. | EP-II. | 93 | 31 | 97 | 66 |
| DF-II. | EP-III. | 96 | 42 | 98 | 68 |
| DF-II. | EP-IV. | 96 | 60 | 97 | 78 |
| DF-II. | EP-V. | 98 | 68 | 99 | 86 |
| DF-II. | EP-VI. | 96 | 64 | 97 | 80 |
| DF-II. | EP-VII. | 98 | 76 | 100 | 85 |
| DF-II. | EP-VIII. | 97 | 74 | 99 | 87 |
| DF-II. | EP-IX. | 92 | 39 | 97 | 69 |
| DF-II. | EP-X. | 97 | 73 | 100 | 88 |
| DF-II. | EP-XI. | 97 | 75 | 100 | 86 |
| DF-II. | EP-XII. | 98 | 72 | 98 | 82 |
| DF-II. | EP-XIII. | 98 | 65 | 98 | 74 |
| DF-II. | EP-XIV. | 97 | 66 | 98 | 69 |
| DF-II. | EP-XV. | 98 | 46 | 97 | 61 |
| DF-II. | EP-XVI. | 97 | 43 | 98 | 62 |
| DF-II. | EP-XVII. | 97 | 70 | 99 | 78 |
| DF-III. | Enz | 100 | 35 | 100 | 69 |
| DF-III. | EP-I. | 100 | 34 | 100 | 67 |
| DF-III. | EP-II. | 90 | 20 | 94 | 61 |
| DF-III. | EP-III. | 92 | 32 | 97 | 67 |
| DF-III. | EP-IV. | 96 | 44 | 98 | 68 |
| DF-III. | EP-V. | 96 | 62 | 97 | 78 |
| DF-III. | EP-VI. | 98 | 67 | 99 | 82 |
| DF-III. | EP-VII. | 98 | 79 | 100 | 85 |
| DF-III. | EP-VIII. | 98 | 75 | 100 | 82 |
| DF-III. | EP-IX. | 92 | 36 | 97 | 67 |
| DF-III. | EP-X. | 96 | 72 | 98 | 84 |
| DF-III. | EP-XI. | 96 | 73 | 98 | 84 |
| DF-III. | EP-XII. | 97 | 72 | 98 | 82 |
| DF-III. | EP-XIII. | 98 | 65 | 98 | 74 |
| DF-III. | EP-XIV. | 98 | 66 | 98 | 69 |
| DF-III. | EP-XV. | 96 | 39 | 97 | 57 |
| DF-III. | EP-XVI. | 97 | 40 | 98 | 60 |
| DF-III. | EP-XVIII. | 99 | 72 | 99 | 74 |
| DF-IV. | Enz | 100 | 36 | 100 | 71 |
| DF-IV. | EP-I. | 93 | 22 | 96 | 62 |
| DF-IV. | EP-II. | 93 | 31 | 97 | 66 |
| DF-IV. | EP-III. | 96 | 42 | 98 | 68 |
| DF-IV. | EP-IV. | 96 | 60 | 97 | 78 |
| DF-IV. | EP-V. | 98 | 68 | 99 | 81 |
| DF-IV. | EP-VI. | 96 | 64 | 97 | 80 |
| DF-IV. | EP-VII. | 97 | 77 | 99 | 86 |
| DF-IV. | EP-VIII. | 95 | 70 | 98 | 79 |
| DF-IV. | EP-IX. | 92 | 39 | 97 | 69 |
| DF-IV. | EP-X. | 96 | 74 | 98 | 88 |
| DF-IV. | EP-XI. | 97 | 70 | 99 | 85 |
| DF-IV. | EP-XII. | 99 | 70 | 98 | 81 |
| DF-IV. | EP-XIII. | 98 | 68 | 98 | 78 |
| DF-IV. | EP-XIV. | 97 | 68 | 99 | 72 |
| DF-IV. | EP-XV. | 98 | 46 | 98 | 60 |
| DF-IV. | EP-XVI. | 97 | 40 | 96 | 56 |

1. A homogenous, storage-stable liquid enzyme preparation, comprising
component (a): at least one enzyme selected from the group of hydrolases (EC 3);
component (b): an enzyme-stabilizing system comprising
(bi) at least one compound according to general formula (A) 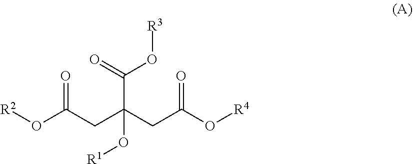
wherein the variables in formula (A) are as follows:
R¹ is selected from the group consisting of H and C₁-C₁₀ alkylcarbonyl, wherein alkyl may be linear or branched and may bear one or more hydroxyl groups,
R², R³, R⁴ are independently from each other selected from the group consisting of H, linear C₁-C₅ alkyl, branched C₃-C₁₀ alkyl, C6-C₁₀-aryl, non-substituted or substituted with one or more carboxylate or hydroxyl groups, and C₆-C₁₀-aryl-alkyl, wherein alkyl of the latter is selected from linear C₁-C₈ alkyl or branched C₃-C₈ alkyl, wherein at least one of R², R³, and R⁴ is not H;
and
(bii) at least one compound selected from the group consisting of boron containing compound and peptide stabilizer,
and
component (c): at least one diol having terminal —OH groups containing 4 to 8 C-atoms.

2. The enzyme preparation according to claim 1, wherein R², R³, R⁴ are independently from each other selected from linear C₂-C₄ alkyl.

3. The enzyme preparation according to claim 1, additionally comprising
component (d): 10-30% by weight of at least one compound selected from the group consisting of organic solvents, wherein % by weight is relative to a total weight of the enzyme preparation.

4. The enzyme preparation according to claim 1, wherein at least one diol in component (c) is comprised in amounts in A range of 10% to 30% by weight relative to A total weight of the enzyme preparation.

5. The enzyme preparation according to claim 1, wherein component (c) further comprises at least one second diol selected from the group consisting of diols having vicinally positioned —OH groups containing 4 to 10 C-atoms.

6. The enzyme preparation according to claim 1, wherein component (c) further comprises a mixture of diols having vicinally positioned —OH groups containing 4 to 10 C-atoms and the diols are selected from the group consisting of diols having terminal —OH groups containing 3 to 10 C-atoms in a mixing ratio of 1:10.

7. The enzyme preparation according to claim 1, wherein component (bii) comprises at least one peptide stabilizer selected from the group consisting of compounds according to formula (Db), 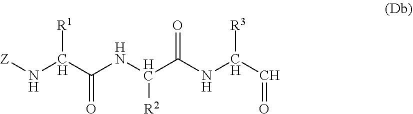
wherein
R¹ and R² is a group such that NH—CHR¹—CO and NH—CHR²—CO each is an L or D-amino acid residue selected from the group consisting of Ala, Cys, Gly, Pro, Ser, Thr, Val, Nva an Me, and R³ is a group such that NH—CHR³—CO is an L or D-amino acid residue selected from the group consisting of Tyr, m-tyrosine, 3,4-dihydroxyphenylalanine, Phe, Val, Ala, Met, Nva, Leu, Ile an Me,
and
the N-terminal protection group Z is selected from the group consisting of benzyloxycarbonyl (Cbz), p-me-thoxybenzyl carbonyl (MOZ), benzyl (Bn), benzoyl (Bz), p-methoxybenzyl (PMB), p-methoxyphenyl (PMP), formyl, acetyl (Ac), methyloxy, alkoxycarbonyl, methoxycarbonyl, fluorenylmethyloxycarbonyl (Fmoc), and tert-butyloxycarbonyl (Boc).

8. A liquid detergent formulation comprising at least component (a): at least one enzyme selected from the group of hydrolases (EC 3);
component (b): an enzyme-stabilizing system comprising
(bi) at least one compound according to general formula (A) 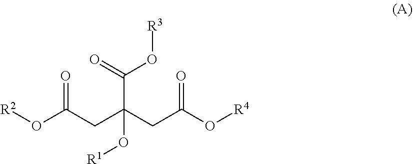
wherein the variables in formula (A) are as follows:
R¹ is selected from the group consisting of H and C₁-C₁₀ alkylcarbonyl, wherein alkyl may be linear or branched and may bear one or more hydroxyl groups,
R², R³, R⁴ are independently from each other selected from the group consisting of H, linear C₁-C₅ alkyl, branched C₃-C₁₀ alkyl, C₆-C₁₀-aryl, non-substituted or substituted with one or more carboxylate or hydroxyl groups, and C₆-C₁₀-aryl-alkyl, wherein alkyl of the latter is selected from the group consisting of linear C₁-C₈ alkyl and branched C₃-C₈ alkyl, wherein at least one of R², R³, and R⁴ is not H;
and
(bii) at least one compound selected from the group consisting of boron containing compound and peptide stabilizer,
and
component (c): at least one diol having terminal —OH groups containing 4 to 8 C-atoms and at least one detergent component.

9. The detergent formulation according to claim 8, wherein the detergent formulation further comprises at least one complexing agent selected from k group consisting of citrates, silicates, carbonates, phosphonates, and aminocarboxylates.

10. The detergent formulation according to claim 8, wherein the detergent formulation further comprises one or more complexing agents in a total amount of complexing agents in A range from about 15% to 30% by weight relative to A total weight of the detergent formulation.

11. The detergent formulation according to claim 8, wherein the detergent formulation further comprises at least one surfactant.

12. The detergent formulation according to claim 8, wherein the detergent formulation is free from bleaches.

13. A method of using at least one diol having terminal —OH groups containing 4 to 8 C-atoms, the method comprising using the at least one diol to provide homogenous and storage-stable enzyme preparations comprising at least
component (a): at least one enzyme selected from the group of hydrolases (EC 3); and
component (b): an enzyme-stabilizing system comprising
(bi) at least one compound according to general formula (A) 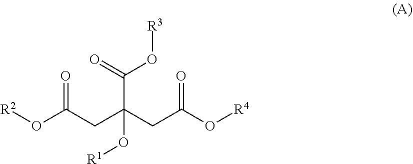
wherein the variables in formula (A) are as follows:
R¹ is selected from the group consisting of H and C₁-C₁₀ alkylcarbonyl, wherein alkyl may be linear or branched and may bear one or more hydroxyl groups,
R², R³, R⁴ are independently from each other selected from the group consisting of H, linear C₁-C₅ alkyl, branched C₃-C₁₀ alkyl, C₆-C₁₀-aryl, non-substituted or substituted with one or more carboxylate or hydroxyl groups, and C₆-C₁₀-aryl-alkyl, wherein alkyl of the latter is selected from the group consisting of linear C₁-C₈ alkyl and branched C₃-C₈ alkyl, wherein at least one of R², R³, and R⁴ is not H;
and
(bii) at least one compound selected from the group consisting of boron containing compound and peptide stabilizer.

14. A method of using at least one diol selected from the group consisting of diols having terminal —OH groups containing 3 to 10 C-atoms, the method comprising using the at least one diol to improve
enzyme stability of at least one hydrolase and/or
enzyme preparation stability
in the presence of a compound according to according to general formula (A) 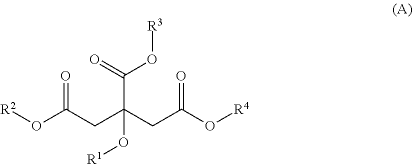
wherein the variables in formula (A) are as follows:
R¹ is selected from the group consisting of H and C₁-C₁₀ alkylcarbonyl, wherein alkyl may be linear or branched and may bear one or more hydroxyl groups,
R², R³, R⁴ are independently from each other selected from the group consisting of H, linear C₁-C₅ alkyl, branched C₃-C₁₀ alkyl, C₆-C₁₀-aryl, non-substituted or substituted with one or more carboxylate or hydroxyl groups, and C₆-C₁₀-aryl-alkyl, wherein alkyl of the latter is selected from the group consisting of linear C₁-C₈ alkyl and branched C₃-C₈ alkyl, wherein at least one of R², R³, and R⁴ is not H.

15. The method of use according to claim 14, wherein the hydrolase-stability is improved in the presence of a compound according to formula (A) and an enzyme stabilizer selected from the group consisting of boron-containing compounds and peptide stabilizers.

16. The enzyme preparation according to claim 1, wherein component (c) further comprises at least one second diol selected from diols having vicinally positioned —OH groups containing 4 to 10 C-atoms in amounts of 2% to 5% by weight relative to a total weight of the enzyme preparation.

17. The detergent formulation according to claim 8, wherein the detergent formulation further comprises at least one surfactant selected from the group consisting of non-ionic surfactants.
